(19) United States
(12) Patent Application Publication
(10) Pub. No.: US 2006/0068308 A1
(43) Pub. Date: Mar. 30, 2006

(54) Image forming process, image forming apparatus, and process cartridge

(76) Inventors: Kohichi Ohshima, Mishima-shi (JP); Yasuo Suzuki, Fuji-shi (JP); Tetsuro Suzuki, Fuji-shi (JP); Michitaka Sasaki, Chiba-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/229,749

(22) Filed: Sep. 20, 2005

(30) Foreign Application Priority Data
Sep. 21, 2004 (JP) 2004-273498

(51) Int. Cl. G03G 5/047

(52) U.S. Cl. 430/59.6; 430/58.7

(57) ABSTRACT

An image forming process is provided, which is consisting of forming step for forming a latent electrostatic image on a photoconductor, developing step, transferring step, and fixing step, wherein the photoconductor contains the crosslinked charge transporting layer containing a cured product formed from at least a radical polymerizable compound having three or more functionalities and no charge transport structure, and a radical polymerizable compound having one functionality and a charge transport structure, wherein the developer includes a toner and a carrier, the carrier has core particles and a coating layer for coating the core particles, the content of the core particles having a particle diameter of smaller than 44 μm in the carrier is 70% by mass or more, and the content of the core particles having a particle diameter of smaller than 22 μm in the carrier is 7% by mass or less, a mass average particle diameter of the carrier (Dw) is 25 μm to 45 μm, and a ratio (Dw/Dp) of Dw to a number average particle diameter (Dp) is 1 to 1.30.

### BACKGROUND OF THE INVENTION

1. Field of the Invention

The present invention relates to image forming processes and image forming apparatuses by electrostatic copying processes such as copiers, facsimiles, printers, etc., and process cartridges.

2. Description of the Related Art

Recently, image forming technologies in copiers, facsimiles, printers have been remarkably developed. Among them, an image forming process by an electrophotographic process has been widely used. Specific grounds thereof are thought as follows: the image forming process by the electrophotographic process can have a high quality images in high speed, color images not only monochrome can be formed, and they can be used in long period of time and has stability.

Recently, organic photoconductors containing organic photoconductive substances have been more generally used as the conductors in the electrophotographic process (may be referred to as “an electrophotographic conductor” or “a latent electrostatic image carrier”). Such conductors are usually produced by coating a coating liquid in which a solvent was mixed with an organic charge generating substance and a binder of an organic polymer on a conductive support of aluminum or aluminum alloy to form a charge generating layer, and then a coating liquid in which a solvent was mixed with an organic charge transport substances and a binder of an organic polymer to form a charge transporting layer.

There are advantages when compared from other inorganic conductors that in the organic conductors, the substances corresponding to various exposing sources from a visible light to an infrared light are easily developed, the substances without environmental pollution can be selected, and manufacturing costs are cheap, etc. The disadvantages are that chemical and mechanical strengths are weak and there may be a case that the conductors are deteriorated and scratches are occurred when many pages are copied or printed.

In the electrophotographic process which is a so-called Carlson process, after the whole surface of the conductor is charged, images are formed by exposing imagewise to form a latent electrostatic image, and then the latent electrostatic image is developed by a toner to visualize. However, there are many problems on such processes. For example, the toner on the conductor is not wholly transferred, a part thereof remains in the photoconductor. When the images are formed at this state, it is not possible to obtain a high quality copy without smear or blot due to the residual toner. Therefore, it is necessary to remove the residual toner.

Examples of cleaning units to remove such residual toner include a fur brush, a magnetic brush or a blade, etc. In terms of performance or composition, the blade has been used mainly and a plate-like rubber elastic substance is used for the blade member.

On the surface of the electrophotographic photoconductor, because external forces of electrical and mechanical are directly added by a charger, a developing device, a transferring units, a cleaner, etc., a demand for durability to such forces have been existing. Particularly, a mechanical durability is required for occurrence of wear and scratches on the surface of the photoconductor due to friction, and film peeling due to impacts when foreign matters are included or when treating paper jam. Among them, the durability to the scratches and film peeling by the impacts has been more highly demanded.

To satisfy the demands mentioned above, various discussions have been made. With respect to the mechanical durability, it has been reported that wear property on the surface and a toner filming property are improved by using a binder resin of BPZ polycarbonate on the surface of the organic photoconductor. Further, in Japanese Patent Application Laid-Open (JP-A) No. 06-118681, it is disclosed that a curable silicone resin containing colloidal silica is used as a surface protective layer of the photoconductor.

However, the photoconductor in which the BPZ polycarbonate is used as a binder resin has still insufficient with wear resistance and durability. On the other hand, the wear resistance is improved on the surface layer of the photoconductor of the curable silicone resin containing colloidal silica, but in repeated usages electrophotographic properties are insufficient thereby occurred a fog and image blur. Such case also is insufficient durability.

In improving these problems, for example, it is proposed in Japanese Patent Application Laid Open (JP-A) Nos. 09-124943 and 09-190004 that disclosed a photoconductor having a resin layer, as a surface layer, in which an organic silicone modified hole transport compound is bonded in a curable organic silicon polymer. However, since the surface layer is cured, the surface of the photoconductor is not polished. As a result, there are problems that an image blur is easily occurred by influence of water absorbed under high temperature and high humidity environment, paper dusts and toner filming easily occur and image failures such as streak or dot shaped are easily generated.

Recently, because the image forming apparatuses have been small-sized, and the photoconductors, in addition, have been small-sized, and higher processing rate as well as maintenance free have been required for the image processing apparatuses, consequently, the photoconductors are demanded for higher durability still more. The organic photoconductors are typically less chemically stabile, and is soft due to their components of charge transport substances of lower molecular mass and organic polymer; therefore, the surface layers tend to wear significantly due to mechanical stress caused by developing systems and cleaning systems under repeated usages in electrophotographic processes. The improvements to such properties are demanded more than ever.

Further, rubber hardness of cleaning blades has been raised and pressure onto photoconductors applied from the cleaning blades has been increased so as to improve cleaning ability in order to enhance image quality by using toner particles having smaller particle diameters, which inevitably leading to higher wear rate of photoconductors. The wear of photoconductors certainly degrades sensitivity, electric properties such as charging ability etc., which resulting in deteriorated images such as lower image density and background smear. Further, scratches due to local wear often bring about streak on images due to insufficient cleaning. Such wear and scratches typically dominate photoconductors in terms of lifetime to be exchanged, currently. As such, the wear rate in the photoconductive layer should be decreased in order to enhance durability of organic photoconductors, which is one of the most important objects to be solved.

Various proposals have been provided in order to enhance wear resistance of photoconductive layers, for example, (1) incorporation of curable binders into the crosslinked charge transporting layer (see Japanese Patent Application Laid-Open (JP-A) No. 56-48637), (2) employment of polymers for charge transport substances (see JP-A No. 64-1728), (3) dispersing inorganic fillers into crosslinked charge transporting layers (see JP-A No. 4-281461), and the like.

However, in the (1) incorporation of curable binders described above, residual voltage tends to increase owing to impurities such as polymerization initiators and/or unreacted residual groups due to insufficient compatibility with charge transport substances, thus image density tents to decrease; in the (2) employment of polymers for charge transport substances described above, the durability cannot be sufficiently improved for satisfying the requirements for organic photoconductors; moreover, electric properties of organic photoconductors are likely to be unstable since polymers for charge transport substances are difficult to be polymerized and purified, and also coating liquids of them are typically excessively viscous to be processed. The inorganic fillers dispersed in inactive polymers (3) described above may exhibit higher wear resistance, compared to that of conventional photoconductors comprising charge transport substances having a lower molecular mass. However, traps on the surface of the inorganic fillers tend to increase residual potential, thereby causing decrease in the image density. Also, when unevenness of the photoconductor surface is significant due to the inorganic filler and the binder resin, cleaning may be insufficient, resulting in toner filming and image deletion.

As such, based on these proposals (1), (2), and (3), the durability of organic photoconductors is not satisfactory on the whole, including electrical durability and mechanical durability.

Further, photoconductors containing cured product of a multi-functional acrylate monomer are proposed in order to improve the wear resistance and scratch resistance such as of 1) (see Japanese Patent (JP-B) No. 3262488). In the patent literature, it is disclosed that cured substance of the multi-functional acrylate monomer is included into a protective layer on photoconductive layers. However, there exist no more than simple descriptions that a charge transport substance may be contained in the protective layer and there exist no specific examples. Further, when a charge transport substance having a low molecular mass is simply added to the crosslinked charge transporting layer, it may cause problems related with the compatibility to the cured product, thereby crystallization of charge transport substance having a lower molecular mass and clouding may occur, resulting in not only deterioration of image density by the increase of electrical potential in the exposure portion, but also reduction in mechanical properties. In addition, a photoconductor is produced by way of causing reaction of monomers in a condition that a polymer binder is incorporated; therefore, there will be some problems that a three-dimensional network structure cannot sufficiently proceed, and a crosslink density becomes low; resulting in not to dramatically exhibit the wear resistance.

Further, another proposal is disclosed for reducing wear resistance of photoconductive layers, in which a charge transporting layer is provided using a coating liquid that comprises a monomer having a carbon-carbon double bond, a charge transport substance having a carbon-carbon double bond, and a binder resin (see Japanese Patent (JP-B)No. 3194392). The binder resin is considered to improve adhesion of the charge generating layer and a curing charge transporting layer, and further to have a role to ease the internal stress of a film when a thick film is cured. The binder resin is broadly classified into a binder reactive with the charge transport substance having a carbon-carbon double bond and another binder non-reactive with the charge transport substance without having the double bond.

The proposed photoconductor represents both higher wear resistance as well as proper electrical properties. However, the non-reactive resin as the binder is used, since the non-reactive resins are not well compatible with reaction products between the monomer and the charge transport substance, thus phase separation is likely to occur in the crosslinked charge transporting layer. This may result in scratches, fixation of an external additive in the toner and paper dusts. Further, the three-dimensional network structure cannot proceed sufficiently and the crosslink density becomes low, thus the wear resistance has not been exhibited dramatically. Further, the patent literature discloses monomers having two functionalities as specific examples, which cannot bring about sufficient crosslink density and satisfactory wear resistance due to the lower functionalities. Provided that reactive resins are employed as the binder resin, the bonding density and the crosslink density are possibly not sufficiently high, as the number of crosslinking between molecules is small though molecular mass in the cured product increases, thus electric properties and wear resistance will not be satisfactory.

Further, another proposal is disclosed, in which photoconductive layers comprise reaction products that are produced by curing hole transport compounds having two or more functional groups capable of undergoing chain polymerization in a molecule (see JP-A No. 2000-66425). However, the photoconductive layer tends to cause higher internal stress in the cured product, and thus to yield higher surface roughness and cracks in the crosslinked charge transporting layer using for a long time, since the bulky hole transport compound have two or more chain polymerizable functional groups.

Therefore, conventional photoconductors having the crosslinking photoconductive layer in which the charge transporting structure is chemically bonded are not to have sufficient overall properties at present.

On the other hand, viewing from the developing unit in terms of high quality images and durable use for long time in forming electrophotographic images, the developing process of the electrophotography includes a so-called single component developing process in which a toner is a main component, and two components developing process in which a toner is mixed with glass beads, a magnetic carrier or a coat carrier coating the surfaces thereof by a resin, and the like.

The two-components process uses a carrier, thus friction charging area to the toner is wide, resulting in having stability in the charging property compared to the single component developing process. Thus, it is advantageous to maintaining the high quality images for long period of time. In addition, as a toner supply capacity to the developing area is high, it is used particularly for high-speed machines. In a digital electrophotographic system for forming a latent electrostatic image on the photoconductor by a laser beam, etc. to develop the latent image, the two-components developing process is widely used utilizing the properties.

To obtain the high quality images more than ever, there are problems to be solved in improving resolution, high-light reproducibility, colorization, etc. To solve the above problems, it is necessary to minimize dots which are a minimum unit of a pixel and density growth. Particularly, that a developing system for capable of developing dot latent images truly on the conductor has become important problems. Thus, various proposals have been made for both process conditions and a developer (a toner, a carrier). As from the process issues, making developing gap closer, thin-filming of electrophotographic photoconductors, small-sizing of beam diameter written by a laser beam in which a semiconductor laser (LD) is a light source. However, there are still problems in costs being higher and reliability.

When a toner having a smaller particle diameter as a developer is used, dot reproducibility will be improved greatly. However, there still remains problems to be solved such that a background smear and image intensity is poor in the developer including the toner having a small particle diameter. Further, in a full-color toner having a small particle diameter, resins having a low curing point is used to obtain a full color tone. However, a carrier spent amount becomes higher than the black toner, the developer is deteriorated, thereby easily to cause the toner distribution and the background smear.

Many proposals for uses of a carrier having small particle diameter have been made. Advantages of using such carrier having small particle diameter are as follows:

(1) As the carrier having small particle diameter has a wide surface area, the toner individually can be given a sufficient frictional charge, thereby occurrences of a toner of a low charge amount and a toner of a reverse charge amount are less. As a result, the background smear will hardly be generated. And, a scatter and bleeding of the toner around the dots are less, thereby a reproducibility of the dots become good.

(2) Because of the wide surface area and the background smear is hardly generated, an average charge amount of the toner can become low. Thereby, sufficient image intensity can be obtained. Thus, the carrier having small particle diameter can supplement the problem when the toner having small particle diameter is used, and it is effective to bring out the advantage of the toner having small particle diameter.

(3) The carrier having small particle diameter forms a dense magnetic brush and a nap (bristle) thereof has a good flowability, thereby not likely to generate marks of the nap on the image.

However, conventionally, there is a disadvantage that the carrier having small particle diameter tends to adhere on the surface of the photoconductor. Once the carrier is adhered, there is a utility problem that generates causes of scratches of the photoconductor and a fixing roller. Namely, a carrier particle will accidentally be entered into a contact portion between a cleaning blade made of an elastic body and the photoconductor. As a result, a deep scratch will be generated on the photoconductor and this gives a great damage to the image quality.

### SUMMARY OF THE INVENTION

A first object of the present invention is to provide image forming processes, image forming apparatuses, and process cartridges that utilize the electrophotographic photoconductors that can provide higher image quality, durability for prolonged period, and less occurrence of the carrier adhesion.

A second object of the present invention is to provide image forming processes, image forming apparatuses, and process cartridges that can provide images with high image intensity and less background smear, together with less variations of dots and with good reproducibility of high-light, and with less generation of the bristle marks in the image.

The image forming processes according to the present invention comprise forming a latent electrostatic image on a photoconductor, developing the latent electrostatic image by using a developer to form a visible image, transferring the visible image on a recording medium, and fixing the transferred image on the recording medium, wherein the photoconductor comprises a support, and a charge generating layer, a charge transporting layer and a crosslinked charge transporting layer disposed on the support in this order, and the crosslinked charge transporting layer comprises a cured product formed from a radical polymerizable compound having three or more functionalities and no charge transport structure, and a radical polymerizable compound having one functionality and a charge transport structure.

The developer includes a toner and a carrier, wherein the carrier has core particles and a coating layer for coating the core particles. The content of the core particles having a particle diameter of smaller than 44 μm in the carrier is 70% by mass or more, and the content of the core particles having a particle diameter of smaller than 22 μm in the carrier is 7% by mass or less. A mass average particle diameter of the carrier (Dw) is 25 to 45 μm, and a ratio (Dw/Dp) of Dw to a number average particle diameter (Dp) is 1 to 1.30.

The image forming apparatuses according to the present invention comprise a photoconductor, a latent electrostatic image forming unit configured to form a latent electrostatic image on the photoconductor, a developing unit configured to develop the latent electrostatic image by using a developer to form a visible image, a transferring unit configured to transfer the visible image on a recording medium, and a fixing unit configured to fix the transferred image on the recording medium, wherein the photoconductor comprises a support; a charge generating layer, a charge transporting layer and a crosslinked charge transporting layer disposed on the support in this order, and wherein the crosslinked charge transporting layer comprises a cured product formed from a radical polymerizable compound having three or more functionalities and no charge transport structure, and a radical polymerizable compound having one functionality and a charge transport structure. The developer comprises a toner and a carrier, wherein the carrier has core particles and a coating layer for coating the core particles. The content of the core particles having a particle diameter of smaller than 44 μm in the carrier is 70% by mass or more, and the content of the core particles having a particle diameter of smaller than 22 μm in the carrier is 7% by mass or less. A mass average particle diameter in the carrier (Dw) is 25 to 45 μm, and a ratio (Dw/Dp) of Dw to a number average particle diameter (Dp) is 1 to 1.30.

The process cartridges according to the present invention comprise the photoconductor, and at least one selected from the group consisting of a charging unit, an exposing unit, a developing unit, a transferring unit, and a cleaning unit, are integrally configured and the process cartridge is mounted detachably to a body of an image forming apparatus. The photoconductor comprises a support; and a charge generating layer, a charge transporting layer and a crosslinked charge transporting layer disposed on the support in this order, wherein the crosslinked charge transporting layer comprises a cured product formed from a radical polymerizable compound having three or more functionalities and no charge transporting structure, and a radical polymerizable compound having one functionality and a charge transporting structure. The developer used in the process cartridge includes a toner and a carrier, wherein the carrier has core particles and a coating layer for coating the core particles.

The content of the core particles having a particle diameter of smaller than 44 μm in the carrier is 70% by mass or more, and the content of the core particles having a particle diameter of smaller than 22 μm in the carrier is 7% by mass or less. A mass average particle diameter in the carrier (Dw) is 25 to 45 μm, and a ratio (Dw/Dp) of Dw to a number average particle diameter (Dp) of the carrier is 1 to 1.30.

The image forming processes according to the present invention utilize the photoconductor which can attain images with higher quality for prolonged period by increasing durability for repeated uses. When the developer used the carrier having small particle diameter is mounted, a toner phenomenon can be maintained with stability. Namely, when the crosslinked charge transporting layer having wear property controlled properly in order to achieve the high quality image is laminated on the photoconductive layer, a dielectric property of the photoconductive layer lessened, thereby realizing the stability of the toner developing for long period of time.

Usually, a surface protective layer has different components from the photoconductive layer in order to increase a mechanical durability. Particularly, when a filler is added, a dielectric constant becomes greatly different when compared to the ordinary photoconductor. Generally, in organic substances used for a photoconductor, its dielectric constant is 2 to 10. For example, a rutile titanium dioxide is 110. When this is contained on the surface protective layer (depending on a thickness and a content amount), the dielectric constant between the photoconductive layer and the surface protective layer may differ in one digit or more in a number. Accordingly, when a thickness of the surface protective layer changes due to mechanical wear with repeated uses for a long period of time, the dielectric constant of the photoconductor changes greatly and a property of the electrophotographic photoconductor, particularly, a developing state of the toner changes, there may be a case that the images are not obtained with stability. In addition, when the carrier having small particle diameter is used for high quality images, it is found that the carrier in the side of the small particle diameter easily adheres preferentially against an original distribution of the particle diameter. But, due to the changes of the dielectric constant of the photoconductor, it is recognized that the carrier easily adheres further.

The grounds thereof are not yet clear, but it is thought that if there is the surface protective layer containing a filler in the image forming, a charge distribution state where accumulated on the surface protective layer in response to changes of the thickness or a charge amount changes, thus, when developing, in relation to charging of the bristle of the carrier particles, the more the carrier is smaller particle diameter, the carrier easily adheres loosing a binding force. In an extreme case, it was expected that the carrier in the side of the small particle diameter units with the toner and move to the photoconductor. The carrier adhesion in many cases induces deep scratches on a developing sleeve or the surface of the photoconductor. Further, by forming images repeatedly for long period of time, when the dielectric constant of the photoconductive layer changes due to the wear of the photoconductor, it was difficult to maintain the stability of the developing in such degree. Thus, in the image forming process using the surface protective layer containing the filler, basically, the changes of the dielectric constant of the photoconductive layer are expected. Thus, the surface protective layer not using the filler is preferable. The photoconductive layer has another problem when it is not abraded at all. Namely, an ozone and NOx generated during the image forming process become causative agents, and the image deletion in the high temperature and high humidity environment easily occurs, thus a certain degree of wear in the photoconductive layer is needed. In other words, the surface protective layer needs the stability of the dielectric constant and the controlled wear property.

As mentioned above, the present invention uses the photoconductor including the excellent crosslinked charge transporting layer with an electric property and a mechanical durability without containing the photoconductive layer and the filler, and the image forming process of the present invention in which the developer containing the carrier having a specific small particle diameter is used, thereby the present invention can realize a desired object which is to obtain high quality images for long lasting period of time by bringing these properties fully.

### BRIEF DESCRIPTION OF THE DRAWINGS

FIG. 1A shows a sectional view of an exemplary layered structure of the electrophotographic photoconductor according to the present invention.

FIG. 1B shows a sectional view of another exemplary layered structure of the electrophotographic photoconductor according to the present invention.

FIG. 1C shows a sectional view of still another exemplary layered structure of the electrophotographic photoconductor of the present invention.

FIG. 2 shows an exemplary cleaning mechanism used in the image forming processes of the present invention.

FIG. 3 shows an exemplary schematic view explaining a full-color image forming apparatus in tandem system in the image forming process according to the present invention.

FIG. 4 shows an exemplary schematic view explaining a process cartridge for electrophotography according to the present invention.

FIG. 5 shows an example of a structure of a vibrating sieve device with an ultrasonic oscillator.

FIG. 6 is an exemplary perspective view of a resistivity measurement cell for measuring an electric resistivity of a carrier.

### DESCRIPTION OF THE PREFERRED EMBODIMENTS

(Image Forming Process and Image Forming Apparatus)

The image forming apparatus according to the present invention comprises at least an electrophotographic photoconductor, a latent electrostatic image forming unit, a developing unit, a transferring unit, a fixing unit, and a cleaning unit, and may further comprise other units, for example, a charge eliminating unit, a recycling unit, and a controlling unit, depending on requirements.

The image forming process according to the present invention comprises a latent electrostatic image forming step, a developing step, a transferring step, a fixing step, and a cleaning step, and may further comprise other steps, for example, a charge-eliminating step, a recycling step and a controlling step, depending on requirements.

The image forming process according to the present invention may be advantageously applied to the image forming apparatus according to the present invention. The latent electrostatic image forming step may be performed by the latent electrostatic image forming unit, the developing step may be performed by the developing unit, the transferring step may be performed by the transferring unit, and the fixing step may be performed by the fixing unit. The other units may perform the other steps.

Latent Electrostatic Image Forming Step and Latent Electrostatic Image Forming Unit

The latent electrostatic image forming step is one that forms a latent electrostatic image on the photoconductor.

<Photoconductor (Electrophotographic Photoconductor)>

The photoconductor comprises a support, and a charge generating layer, a charge transporting layer and a crosslinked charge transporting layer disposed on the support in this order, and other optional layers depending on requirements.

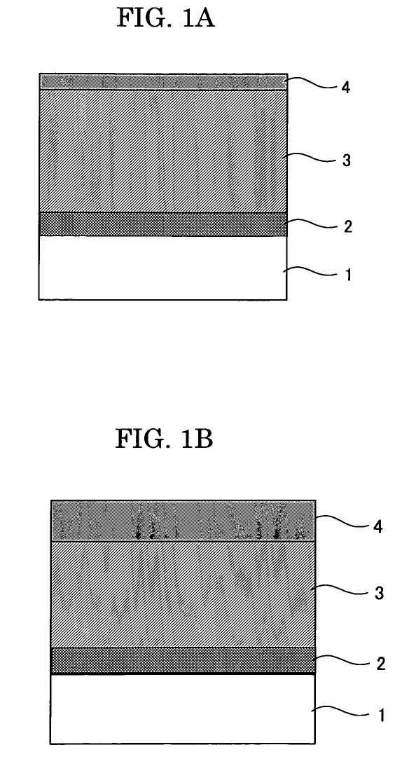

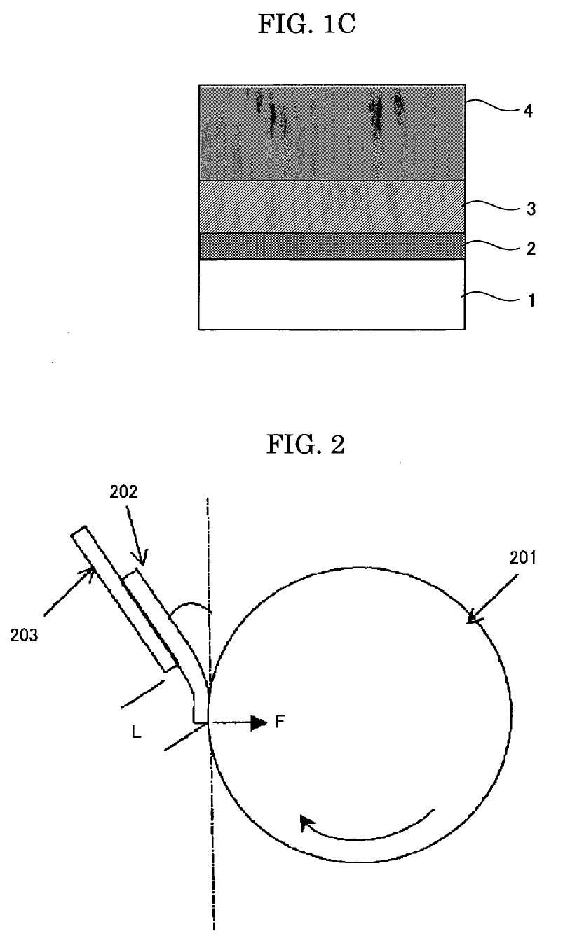

FIGS. 1A to 1C show a sectional view illustrating an exemplary electrophotographic photoconductor used in the image forming process according to the present invention. The photoconductor is a layered structure wherein on support 1, charge generating layer 2 having a charge generating function, charge transporting layer 3 having a charge transporting function, and crosslinked charge transporting layer 4 are layered sequentially. In FIGS. 1A to 1C, a thickness of the crosslinked charge transporting layer 4 and a thickness of the charge transporting layer 3 differ.

<Support>

The support may be the one showing a conductivity of a volume resistivity of 10¹¹ Ω·cm or less, for example, a film- or cylindrically-shaped plastic or paper coated with metals such as aluminum, nickel, chromium, nichrome, copper, gold, silver, and platinum; metal oxides such as tin oxide and indium oxide, by vapor deposition or sputtering; or a plate of aluminum, aluminum alloy, nickel and stainless steel or they may be formed into a tube by extrusion or drawing, followed by cut, polished and surface-treated. The endless nickel belt and endless stainless steel belt such as those illustrated in JP-A No. 52-36016 may also be employed as the support. In addition, conductive particles are dispersed on an appropriate binder resin and coated on the support may be employed as the support.

Examples of the conductive fine particles include carbon black, acetylene black, or metal powder such as of aluminum, nickel, iron, nichrome, copper, zinc and silver, and metal oxide fine particles such as of conductive tin oxide and ITO, etc. As for the binder resin which is used together with the conductive fine particles, the following thermoplastic resins, thermosetting polymerization resin and photopolymerization resin may be utilized: polystyrene, styrene-acrylonitrile copolymer, styrene-butadiene copolymer, styrene-maleic anhydride copolymer, polyester, polyvinyl chloride, vinyl chloride-vinyl acetate copolymer, polyvinyl acetate, polyvinylidene chloride, polyarylate resin, phenoxy resin, polycarbonate, cellulose acetate resin, ethyl-cellulose resin, polyvinyl butyral, polyvinylformal, polyvinyl toluene, poly-N-vinylcarbazole, acrylate resin, silicone resin, epoxy resin, melamine resin, urethane resin, phenol resin, alkyd resin, etc.

The conductive layer can be prepared by dispersing and coating the conductive fine particles and the binder resin to a suitable solvent, for example, tetrahydrofuran, dichloromethane, methylethylketone, toluene, and the like.

Further, the conductive support which is prepared by forming the conductive layer on a suitable cylinder base with a thermal-contraction tube which is made of a suitable substance such as polyvinyl chloride, polypropylene, polyester, polystyrene, polyvinylidene chloride, polyethylene, chlorinated rubber, Teflon™ etc. and contain the conductive fine particles may also be utilized as the support of the present invention.

Charge Generating Layer

The charge generating layer is a layer comprising mainly a charge generating substance having charge generating function and may be used in combination with a binder resin as needed. Inorganic materials and organic materials are used as the charge generating substances.

Examples of inorganic materials include crystalline selenium, amorphous selenium, selenium-tellurium, selenium-tellurium-halogen, selenium-arsenic compound, and amorphous silicon. The amorphous silicon may have dangling bonds terminated with a hydrogen atom or halogen atom, or it may be doped with boron atom or phosphorus atom.

The organic materials may be selected from conventional materials, examples thereof include phthalocyanine pigments such as metal phthalocyanine, non-metal phthalocyanine and the like, azulenium salt pigment, squaric acid methine pigment, azo pigments having a carbazole skeleton, azo pigments having a triphenylamine skeleton, azo pigments having a diphenylamine skeleton, azo pigments having a dibenzothiophene skeleton, azo pigments having a fluorenone skeleton, azo pigments having an oxadiazole skeleton, azo pigments having a bisstylbene skeleton, azo pigments having a distyryoxide azole skeleton, azo pigments having a distyrylcarbazole skeleton, pherylene pigments, anthraquinone or polycyclic quinone pigments, quinone imine pigments, diphenylmethane and triphenylmethane pigments, benzoquinone and naphthoquinone pigments, cyanine and azomethine pigments, indigoido pigments, bisbenzimidazole pigments and the like. These charge generating substances may be used alone or in combination. Among them, the oxytitaniumphtalocyanine expressed by the following Structural Formula (1) is preferred.

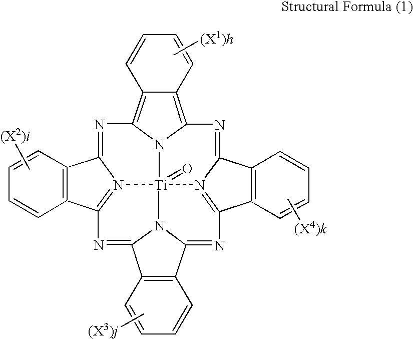

In the Structural Formula (1), X¹, X², X³ and X⁴ represent Cl or Br, and “h”, “i”, “j”, and “k” are integers of 0 to 4.

A crystal form oxytitaniumphtalocyanine is not particularly limited, but it is preferable in any one of the following as from a point of sensitivity property; in an X ray diffraction due to a property of CuKα (2θ±0.2°) the oxytitaniumphtalocyanine having a strong peak at Bragg angle of 9.0°, 14.2°, 23.9° and 27.1°, or the oxytitaniumphtalocyanine having a strong peak at Bragg angle of 9.6° and 27.3°.

Examples of the binder resins appropriate for the charge generating layer include polyamides, polyurethanes, epoxy resins, polyketone, polycarbonate, silicone resins, acrylic resin, polyvinyl butyral, polyvinyl formal, polyvinyl ketone, polystyrene, poly-N-vinyl carbazole, and polyacrylamide, and the like. These binder resins may be used alone or in combination. In addition to the binder resin as described above, the binder resins utilized as the charge generating layer may be selected from charge transport polymers having the charge transporting function, for example, polycarbonates, polyesters, polyurethanes, polyethers, polysiloxanes, and acrylic resins which have an arylamine skeleton, benzidine skeleton, hydrazone skeleton, carbazole skeleton, stylbene skeleton, pyrazoline skeleton and the like, or polymers having a polysilane skeleton, and the like.

Specific examples of the charge transport polymer are disclosed in JP-A No. 01-001728, JP-A No. 01-009964, JP-A No. 01-013061, JP-A No. 01-019049, JP-A No. 01-241559, JP-A No. 04-011627, JP-A No. 04-175337, JP-A No. 04-183719, JP-A No. 04-225014, JP-A No. 04-230767, JP-A No. 04-320420, JP-A No. 05-232727, JP-A No. 05-310904, JP-A No. 06-234836, JP-A No. 06-234837, JP-A No. 06-234838, JP-A No. 06-234839, JP-A No. 06-234840, JP-A No. 06-234841, JP-A No. 06-239049, JP-A No. 06-236050, JP-A No. 06-236051, JP-A No. 06-295077, JP-A No. 07-056374, JP-A No. 08-176293, JP-A No. 08-208820, JP-A No. 08-211640, and JP-A No. 08-253568, JP-A No. 08-269183, JP-A No. 09-062019, JP-A No. 09-043883, JP-A No. 09-71642, JP-A No. 09-87376, JP-A No. 09-104746, JP-A No. 09-110974, JP-A No. 09-110976, JP-A No. 09-157378, JP-A No. 09-221544, JP-A No. 09-227669, JP-A No. 09-235367, JP-A No. 09-241369, JP-A No. 09-268226, JP-A No. 09-272735, JP-A No. 09-302084, JP-A No. 09-302085, JP-A No. 09-328539 and the like.

Specific examples of the polymers having a polysilane skeleton described above are polysilylene polymers disclosed in JP-A No. 63-285552, JP-A No. 05-19497, JP-A No. 05-70595 and JP-A No. 10-73944.

Further, a charge transport substance having a lower molecular mass may be incorporated into the charge generating layer.

The charge transport substances are classified into hole transport substances and electron transport substances. Examples of the electron transport substance include chloranil, bromanil, tetracyanoethylene, tetracyanoquinodimethane, 2,4,7-trinitro-9-fluorenone, 2,4,5,7-tetranitro-9-fluorenone, 2,4,5,7-tetranitroxanthone, 2,4,8-trinitrothioxanthone, 2,6,8-trinitro-4H-indino[1,2-b]thiophene-4-on, 1,3,7-trinitro-dibenzothiophene-5,5-dioxide, and diphenoquinone derivatives. These electron transport substances may be used alone or in combination.

Examples of the hole transport substance include oxazole derivatives, oxadiazole derivatives, imidazole derivatives, monoarylamines, diarylamines, triarylamines, stilbene derivatives, α-phenyl stilbene derivatives, benzidine derivatives, diarylmethane derivatives, triarylmethane derivatives, 9-styrylanthracene derivatives, pyrazoline derivatives, divinyl benzene derivatives, hydrazone derivatives, indene derivatives, butadiene derivatives, pyrene derivatives, bisstilbene derivatives, enamine derivatives, and other known substances. These hole transport substances may be used alone or in combination.

Mainly, the charge generating layer may be formed by way of film forming processes under a vacuum atmosphere or casting processes by use of a solution or dispersion.

The former processes include the vacuum deposition, glow discharge electrolysis, ion plating, sputtering, reactive-sputtering, and CVD processes, which may form satisfactory the inorganic substances or organic substances.

In order to provide the charge generating layer by the casting process, an inorganic or organic charge-generating substance is dispersed, together with a binder resin as required, by a ball mill, an atritor, a sand mill, or a bead mill using a solvent such as tetrahydrofuran, dioxane, dioxolane, toluene, dichloromethane, monochlorobenzene, dichloroethane, cyclohexanone, cyclopentanone, anisole, xylene, methylethylketone, acetone, ethyl acetate, or butyl acetate, thereby properly diluting the dispersion liquid, and applying the dispersion liquid as a coating. A leveling agent such as dimethyl silicone oil, methylphenyl silicone oil and the like may be added to the dispersion liquid as required. The dispersion liquid may be applied by way of dip coating, spray coating, bead coating, ring coating and the like.

Preferably, the thickness of the charge generating layer is 0.01 μm to 5 μm, more preferably is 0.05 μm to 2 μm.

Charge Transporting Layer

The charge transporting layer exhibits charge transport property, and is formed by charge transport substances having a charge transporting property and a binder resin are dissolved or dispersed in a proper solvent and coated on the charge generating layer to dry.

Examples of the charge transport substances are charge transport substances, the hole charging substances and the charge transport polymers as described in the charge generating layer. As mentioned above, the use of charge transport polymer can reduce solubility of the under layer when coating the crosslinked charge transporting layer and is very useful.

Examples of the binder resin include thermoplastic resin and thermosetting resin such as polystyrene, styrene-acrylonitrile copolymer, styrene-butadiene copolymer, styrene-maleic anhydride copolymer, polyester, polyvinyl chloride, vinylchloride-vinylacetate copolymer, polyvinyl acetate, polyvinylidene chloride, polyallylate resin, phenoxy resin, polycarbonate, celluloseacetate resin, ethyl-cellulose resin, polyvinyl butyral, polyvinyl formal, polyvinyl toluene, poly-N-vinylcarbazole, acrylate resin, silicone resin, epoxy resin, melamine resin, urethane resin, phenol resin, alkyd resin, and the like.

The content of the charge transport substance is preferably 20 parts by mass to 300 parts by mass, more preferably is 40 parts by mass to 150 parts by mass based on 100 parts by mass of the binder resin. When the charge transport substance is a polymer, the charge transport substance may be employed alone or in combination with the binder resin.

The solvents used for coating the charge transporting layer may be the same as those in terms of the charge generating layer described above. Preferably, the solvents can dissolve the charge transport substance and the binder resin. These solvents may be used alone or mixed with two or more kinds. Further, The charge transporting layer may be coated in the similar way as of the charge generating layer.

The charge transporting layer may include plasticizers and leveling agents depending on requirements. Specific examples of the plasticizers include known ones, which are used for plasticizing resins, such as dibutyl phthalate, dioctyl phthalate and the like. The amount of the plasticizer is 0 part by mass to 30 parts by mass based on 100 parts by mass of the binder resin.

Specific examples of the leveling agents include silicone oils such as dimethyl silicone oil, and methyl phenyl silicone oil; polymers or oligomers including a perfluoroalkyl group in their side chain, and the like. The amount of the leveling agents is 0 part by mass to 1 part by mass based on 100 parts by mass of the binder resin.

The thickness of the charge transporting layer is preferably 5 μm to 40 μm, more preferably is 10 μm to 30 μm. Thus formed charge transporting layer is coated with the coating liquid for the crosslinked charge transporting layer, dried upon required, thereby to form a crosslinked charge transporting layer by initiating a curing reaction by use of external energy such as thermal or optical irradiation.

Crosslinked Charge Transporting Layer

The crosslinked charge transporting layer is a layer having a crosslinked structure exhibiting charge transport property, and a coating liquid for the crosslinked charge transporting layer is prepared containing at least the radical polymerizable monomer having three or more functionalities and no charge transport structure and the radical polymerizable compound having one functionality and a charge transport structure are dissolved or dispersed in a proper solvent to coat on the charge transporting layer 3, followed by drying to form the crosslinked charge transporting layer.

The radical polymerizable monomers having three or more functionalities and no charge transport structure refer to monomers that do not have the hole transport structure such as triarylamine, hydrazone, pyrazoline, carbazole and do no have the electron transport structure such as fused polycyclic quinone, diphenoquinone, or electron pulling aromatic rings having cyano group or nitro group, instead have three or more radical polymerizable functional groups. The radical polymerizable functional group may be one of carbon-carbon double bond and being radically polymerizable. Examples of the radical polymerizable functional group include 1-substituted ethylene functional groups, 1,1-substituted ethylene functional groups as shown below, and the like.

(1) Examples of the 1-substituted ethylene functional groups include functional groups represented by the following formula:
CH₂═CH—X₁— Formula (10)
where X₁ represents an arylene group such as phenylene group, naphthylene group and the like, which may be substituted, alkynylene group which may be substituted, —CO— group, —COO— group, —CON(R₁₀)— group (R₁₀ represents a hydrogen atom, alkyl group such as methyl group and ethyl group, aralkyl group such as benzyl group, naphthylmethyl group and phenethyl group, aryl group such as phenyl group and naphthyl group), or —S— group.

Specific examples of the substituents include vinyl group, styryl group, 2-methyl-1,3-butadienyl group, vinylcarbonyl group, acryloyloxy group, acryloylamino group, vinylthioether group, and the like.

(2) Examples of the 1,1-substituted ethylene functional groups include those represented by the following formula:
CH₂═C(Y)—X₂— Formula (11)
where Y represents an alkyl group which may be substituted, aralkyl group which may be substituted, aryl group such as phenyl group, naphthyl group which may be substituted, halogen atom, cyano group, nitro group, alkoxy group such as methoxy group and ethoxy group, —COOR₁₁ group (R₁₁ represents a hydrogen atom, alkyl group such as methyl group and ethyl group which may be substituted, aralkyl group such as benzyl and phenethyl groups which may be substituted, aryl groups such as phenyl group and naphthyl group which may be substituted), or —CONR₁₂R₁₃ (R₁₂ and R₁₃ represent a hydrogen atom, alkyl groups such as methyl group and ethyl group which may be substituted, aralkyl group such as benzyl group, naphthylmethyl group, and phenethyl group which may be substituted, aryl group such as phenyl group and naphthyl group which may be substituted, these may be identical or different), X₂ represents a substituent as defined for X₁ of the Formula (10) and a single bond, an alkylene group, provided that at least any one of Y and X₂ is an oxycarbonyl group, cyano group, alkenylene group, and aromatic ring).

Specific examples of these substituents include alpha-chloro acryloyloxy group, methacryloyloxy group, alpha-cyanoethylene group, alpha-cyanoacryloyloxy group, alpha-cyanophenylene group, methacryloylamino group and the like.

Examples of the substituent which is additionally substituted to the subsituents of X and Y include halogen atom, nitro group, cyano group, alkyl groups such as methyl group, ethyl group and the like; alkoxy groups such as methoxy group and ethoxy group; aryloxy groups such as phenoxy group; aryl groups such as phenyl group and naphthyl group; and aralkyl groups such as benzyl group and phenethyl group.

Among these radical polymerizable functional groups, acryloyloxy group and methacryloyloxy group are particularly useful. Compounds having three or more of acryloyloxy groups may be prepared, for example, by esterification or transesterification reaction of compounds having three or more hydroxy groups in the molecule with acrylic acid (salt), acrylic acid halide, acrylic acid ester. Also, compounds having three or more methacryloyloxy groups may be similarly prepared. The radical polymerizable functional groups in a monomer having three or more functionalities may be identical or different.

Specific examples of radical polymerizable monomers having three or more functionalities and no charge transport structure are listed below, but not limited to.

The radical polymerizable monomers, available in the present invention, include trimethylolpropanetriacrylate (TMPTA), trimethylolpropanetrimethacrylate, HPA-modified trimethylolpropanetriacrylate, EO-modified trimethylolpropane triacrylate, PO-modified trimethylolpropane triacrylate, caprolactone-modified trimethylolpropane triacrylate, HPA-modified trimethylolpropane trimethacrylate, pentaerythritol triacrylate, pentaerythritol tetraacrylate (PETTA), glycerol triacrylate, ECH-modified glycerol triacrylate, EO-modified glycerol triacrylate, PO-modified glycerol triacrylate, tris(acryloxyethyl)isocyanurate, dipentaerythritol hexacrylate (DPHA), caprolactone-modified dipentaerythritol hexacrylate, dipentaerythritolhydroxy pentaacrylate, alkyl-modified dipentaerythritol pentaacrylate, alkyl-modified dipentaerythritol tetraacrylate, alkyl-modified dipentaerythritol triacrylate, dimethylolpropane tetraacrylate (DTMPTA), pentaerythritolethoxy tetraacrylate, EO-modified phosphonic acid triacrylate, 2,2,5,5,-tetrahydroxymethylcyclopentanone tetraacrylate and the like. These may be used alone or in combination.

The radical polymerizable monomer having three or more functionalities and no charge transport structure employed in the present invention has a ratio that molecular mass to functionalities (molecular mass/number of functional groups) in the monomer is 250 or less in order to attain higher crosslink density within the crosslinked charge transporting layer. When the ratio is greater than 250, the crosslinked charge transporting layer tends to be soft and the wear resistance may be somewhat poor; therefore, when a monomer is employed that has a modified group such as HPA, EO and PO, the monomer having an excessively long modified group is employed alone is not preferable.

The content of the radical polymerizable monomer having three or more functionalities and no charge transporting structure used in the crosslinked charge transporting layer is preferably 20% by mass to 80% by mass, is more preferably 30% by mass to 70% by mass based on the total mass of the crosslinked charge transporting layer. When the content of the radical polymerizable monomer is less than 20% by mass, significant improvement of wear resistance may not be attained compared to the conventional thermoplastic binder resins, since the three-dimensional crosslink density is lower in the crosslinked charge transporting layer, and when the content of the radical polymerizable monomer is more than 80% by mass, the electrical properties are deteriorated since the charge transport property is insufficient. From the viewpoint of both of the wear resistance and electrical properties, the content of the radical polymerizable monomer is particularly preferably 30% by mass to 70% by mass, although the thickness of the crosslinked charge transporting layer of the photoconductor differs depending on the wear resistance and electrical properties required in processes.

The radical polymerizable compounds having one functionality and a charge transport structure used for the crosslinked charge transporting layer may be those having a hole transport structure such as triarylamine, hydrazone, pyrazoline, and carbazole, and those having an electron transport structure such as fused polycyclic quinone, diphenoquinone, and an electron pulling aromatic ring having a cyano group or nitro group, and also having one radical polymerizable functional group. Examples of the radical polymerizable functional groups may be those described in the radical polymerizable monomer mentioned above. Particularly, acryloyloxy group and methacryloyloxy group are useful.

The charge transport structure of a triarylamine structure shows high effect, in particular, the compounds expressed by General Formulas (1) and (2) from the viewpoints of appropriate electric properties such as higher sensitivity, residual potential and the like. 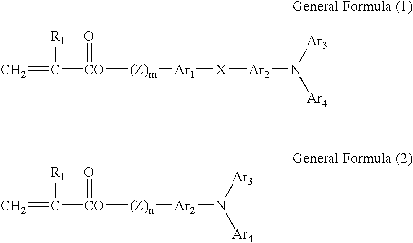
where R₁ represents a hydrogen atom, halogen atom, alkyl group which may be substituted, aralkyl group which may be substituted, aryl group which may be substituted, cyano group, nitro group, alkoxy group, —COOR₇ (R₇ represents a hydrogen atom, alkyl group which may be substituted, aralkyl group which may be substituted, or aryl group which may be substituted), halogenated carbonyl group, or CONR₈R₉ (R₈ and R₉ each represents a hydrogen atom, halogen atom, alkyl group which may be substituted, aralkyl group which may be substituted, or aryl group which may be substituted, R₈ and R₉ may be identical or different); Ar₁ and Ar₂ each represents a substituted or unsubstituted arylene group which may be identical or different; Ar₃ and Ar₄ each represents a substituted or unsubstituted aryl group which may be identical or different; X represents a single bond, substituted or unsubstituted alkylene group, substituted or unsubstituted cycloalkylene group, substituted or unsubstituted alkylene ether group, oxygen atom, sulfur atom, or vinylene group; Z represents a substituted or unsubstituted alkylene group, substituted or unsubstituted alkylene ether group, or alkyleneoxycarbonyl group; “m” and “n” each represents an integer of 0 to 3.

Specific examples of the formulas (1) and (2) are hereinafter described.

With respect to substituents of R₁ in the general formulas (1) and (2), examples of the alkyl group include methyl group, ethyl group, propyl group, butyl group etc., examples of the aryl group include phenyl group, naphthyl group etc., examples of the aralkyl group include benzyl group, phenethyl group, naphthylmethyl group etc., examples of the alkoxy group include methoxy group, ethoxy group, propoxy group etc.; these groups may be substituted further by a halogen atom, nitro group, cyano group, alkyl group such as methyl group, ethyl group etc., alkoxy group such as methoxy group, ethoxy group and the like, aryloxy group such as phenoxy group and the like, aryl group such as phenyl group, naphthyl group and the like, aralkyl group such as benzyl group, phenethyl group and the like.

Particularly preferable substituents of R₁ are a hydrogen atom and methyl group.

Ar₃ and Ar₄ are each a substituted or unsubstituted aryl group; examples of the aryl group include fused polycyclic hydrocarbon groups, non-fused cyclic hydrocarbon groups, and heterocyclic groups.

The fused polycyclic hydrocarbon group is preferably having 18 or less carbon atoms and may form a ring, examples thereof include pentanyl group, indenyl group, naphthyl group, azulenyl group, heptaprenyl group, biphenylenyl group, as-indacenyl group, s-indacenyl group, fluorenyl group, acenaphthylenyl group, pleiadenyl group, acenaphthenyl group, phenalenyl group, phenanthryl group, anthryl group, fluoranthenyl group, acephenanthrylenyl group, aceanthrylenyl group, triphenylenyl group, pyrenyl group, chrysenyl group, and naphthacenyl group, and the like.

Examples of the non-fused hydrocarbon group include a monovalent group of monocyclic hydrocarbon compounds such as benzene, diphenyl ether, polyethylenediphenyl ether, diphenylthioether and diphenylsulphone, a monovalent group of non-fused polycyclic hydrocarbon compounds such as biphenyl, polyphenyl, diphenylalkane, diphenylalkene, diphenylalkyne, triphenylmethane, distyrylbenzene, 1,1-diphenylcycloalkane, polyphenylalkane and polyphenylalkene, a monovalent group of cyclic hydrocarbon compounds such as 9,9-diphenylfluorene, and the like.

Examples of the heterocyclic group include a monovalent group of carbazole, dibenzofuran, dibenzothiphene, oxadiazole, and thiadiazole.

The aryl group represented by Ar₃ and Ar₄ may be substituted by the substituents described below.

(1) halogen atom, cyano group, nitro group and the like.

(2) alkyl group, preferably having a carbon number of 1 to 12, more preferably having a carbon number of 1 to 8, still more preferably having a carbon number of 1 to 4 straight-chained or branched alkyl group, the alkyl group may be further substituted by a fluorine atom, hydroxy group, cyano group, alkoxy group having a carbon number of 1 to 4, phenyl group, or phenyl group substituted by a halogen atom, alkyl group having a carbon number of 1 to 4 or alkoxy group having a carbon number of 1 to 4. Specific examples thereof include methyl group, ethyl group, n-butyl group, i-propyl group, t-butyl group, s-butyl group, n-propyl group, tri-fluoromethyl group, 2-hydroxyethyl group, 2-ethoxyethyl group, 2-cyanoethyl group, 2-methoxyethyl group, benzyl group, 4-chlorobenzyl group, 4-methylbenzyl group, 4-phenylbenzyl group and the like.

(3) alkoxy group (—OR₂), wherein R₂ represents an alkyl group as described in (2). Specific examples thereof include methoxy group, ethoxy group, n-propoxy group, i-propoxy group, t-butoxy group, n-butoxy group, s-butoxy group, i-butoxy group, 2-hydroxyethoxy group, benzyloxy group, tri-fluoromethoxy group and the like.

(4) aryloxy group, wherein the aryl group may be phenyl group and naphthyl group, which may be substituted by alkoxy group having a carbon number of 1 to 4, alkyl group having a carbon number of 1 to 4, or halogen atom. Specific examples thereof include phenoxy group, 1-naphthyloxy group, 2-naphthyloxy group, 4-methoxyphenoxy group, 4-methylphenoxy group and the like.

(5) alkylmercapto group or arylmercapto group. Specific examples thereof include methylthio group, ethylthio group, phenylthio group, p-methylphenylthio group and the like.

(6) the group expressed by the following formula. 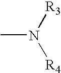
where R₃ and R₄ each represents independently a hydrogen atom, alkyl group as described in (2), or aryl group. Examples of the aryl group include phenyl group, biphenyl group, or naphthyl group which may be substituted by alkoxy group having a carbon number of 1 to 4, alkyl group having a carbon number of 1 to 4, or halogen atom, or R₃ and R₄ may form a ring together with.

Specific examples thereof include amino group, diethylamino group, N-methyl-N-phenylamino group, N,N-diphenylamino group, N,N-di(tolyl)amino group, dibenzylamino group, piperidino group, morpholino group, pyrrolidino group, and the like.

(7) alkylenedioxy group or alkylenedithio group such as methylenedioxy group or methylenedithio group.

(8) substituted or unsubstituted styryl group, substituted or unsubstituted β-phenylstyryl group, diphenylaminophenyl group, ditolylaminophenyl group, and the like.

The arylene groups represented by Ar₁ and Ar₂ include divalent groups derived from aryl groups represented by Ar₃ and Ar₄.

X represents a single bond, substituted or unsubstituted alkylene group, substituted or unsubstituted cycloalkylene group, substituted or unsubstituted alkylene ether group, oxygen atom, sulfur atom, or vinylene group.

Examples of the substituted or unsubstituted alkylene groups are having a carbon number 1 to 12, preferably a carbon number 1 to 8, more preferably a carbon number of 1 to 4 straight chained or branched alkylene groups, the alkylene groups may be further substituted by a fluorine atom, hydroxy group, cyano group, alkoxy groups having a carbon number of 1 to 4, phenyl group, or phenyl group substituted by a halogen atom, alkyl group having a carbon number of 1 to 4, or alkoxy group having a carbon number of 1 to 4. Specific examples thereof include methylene group, ethylene group, n-butylene group, i-propylene group, t-butylene group, s-butylene group, n-propylene group, trifluoromethylene group, 2-hydroxyethylene group, 2-ethoxyethylene group, 2-cyanoethylene group, 2-methoxyethylene group, benzylidene group, phenylethylene group, 4-chlorophenylethylene group, 4-methylphenylethylene group, 4-biphenylethylene group and the like.

Examples of the substituted or unsubstituted cycloalkylene groups include cyclic alkylene groups having a carbon number 5 to 7, which may be substituted by a fluorine atom, hydroxide group, alkyl group having a carbon number of 1 to 4, or alkoxy group having a carbon number of 1 to 4. Specific examples thereof include cyclohexylidene group, cyclohexylene group, 3,3-dimethylcyclohexylidene group and the like.

Examples of the substituted or unsubstituted alkylene ether group include ethyleneoxy, propylenoxy, ethyleneglycol, propylenglycol, diethylenegycol, tetraethyleneglycol, tripropyleneglycol. The alkylene ether group and alkylene group may be substituted by a hydroxyl group, methyl group, ethyl group and the like.

The vinylene group may be represented by the following formula. 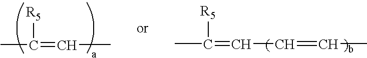
where R₅ represents a hydrogen atom, alkyl group which is the same as defined in (2), or aryl group which is the same as the aryl group represented by Ar₃ and Ar₄; “a” represents 1 or 2, and “b” represents 1 to 3.

Z represents a substituted or unsubstituted alkylene group, a substituted or unsubstituted alkylene ether group, or alkyleneoxycarbonyl group.

The substituted or unsubstituted alkylene group includes the alkylene groups similar to X described above.

The substituted or unsubstituted alkylene ether group includes the alkylene ether groups as defined for X. The alkyleneoxycarbonyl group includes caprolactone-modified groups.

Preferable examples of the radical polymerizable compounds having one functionality and a charge transport structure are those expressed by General Formula (3). 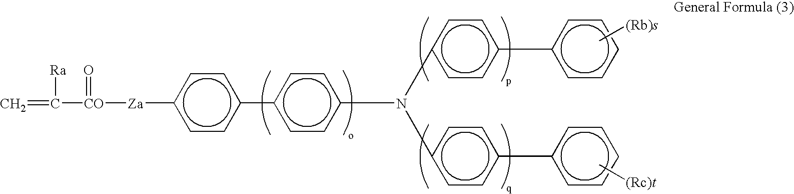
where “o,” “p”, and “q” each represents an integer of 0 or 1, Ra represents a hydrogen atom or methyl group, Rb and Rc each represents a substituent other than a hydrogen atom which is a alkyl group having carbon number of 1 to 6 and may be different when they are two or more, “s” and “t” each represents an integer of 0 to 3, and Za represents a single bond, methylene group, ethylene group, or group expressed by the following formulas:

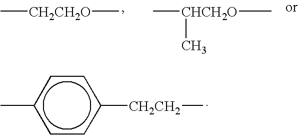

The compounds represented by the above formula (3) are preferably those in which Rb and Rc are each methyl group or ethyl group.

The radical polymerizable compounds having one functionality and a charge transport structure expressed by General Formulas (1), (2), and (3) do not attach to terminal sites of crosslinked structure since the polymerization is accomplished by opening of the carbon-carbon double bond at both sides, but are possibly incorporated into a continuous polymer chain. The radical polymerizable compound having one functionality exists, within the crosslinked polymer formed with the radical polymerizable monomer having three or more functionalities, at the main chain of the polymer and the cross linking chain between main chains (Crosslinking chains can be classified into intermolecular crosslinking chains between polymers, and intramolecular crosslinking chains that connect a certain site and another site derived from monomer in the main chain within a molecule). In both cases of existence at the main chain and at the crosslinking chain of the radical polymerizable compound having one functionality, the triarylamine structure attached to the chain is bulky due to at least three aryl groups attached radially to the nitrogen atom. However, since the three aryl groups are not directly attached to the chains but are indirectly attached to the chains through carbonyl group or the like, the triarylamine structure is fixed flexibly in terms of spatial site, and the triarylamine structure can be disposed at appropriate distances therebetween, therefore, structural stress is not significant in the molecules and the passages for charge transport can be maintained in the molecular structure within the surface layer of photoconductors.

Specific examples of the radical polymerizable compounds having one functionality and a charge transport structure available in the present invention are listed below, but are not limited to these structures and compounds.

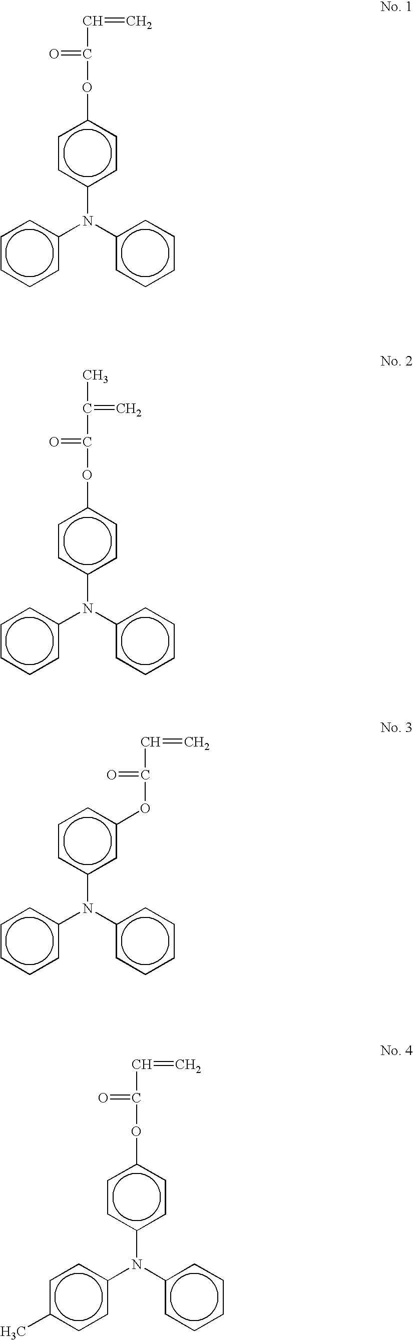

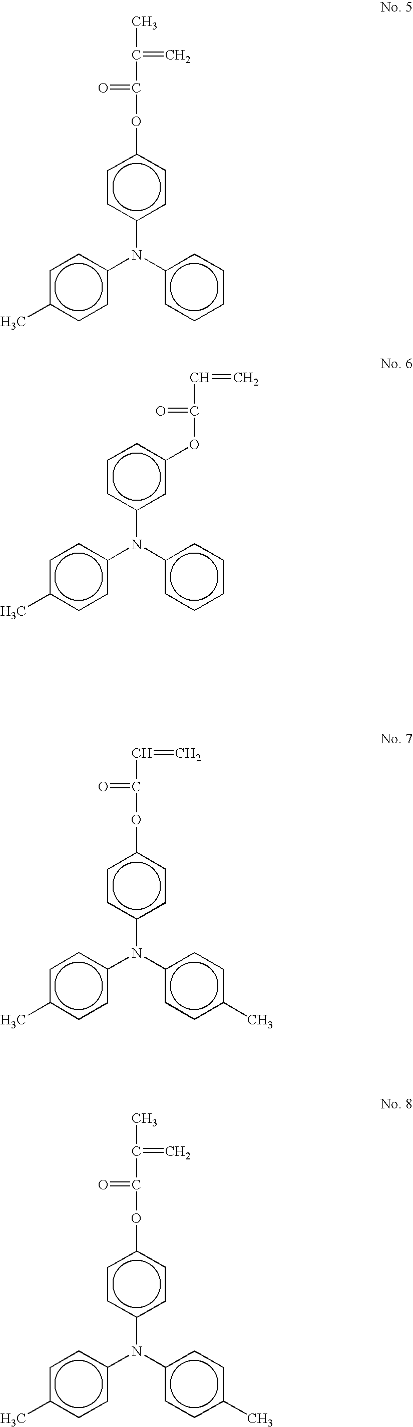

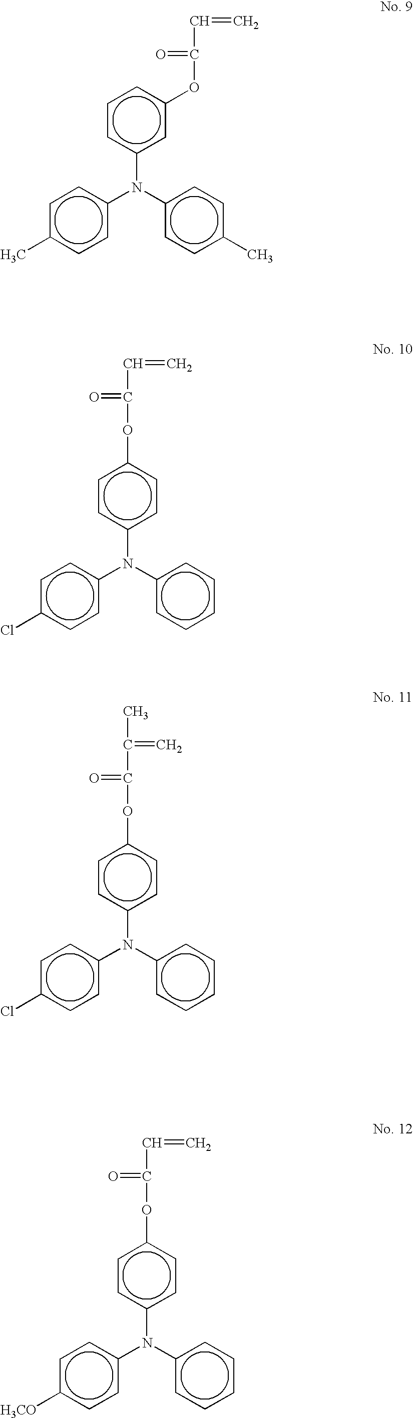

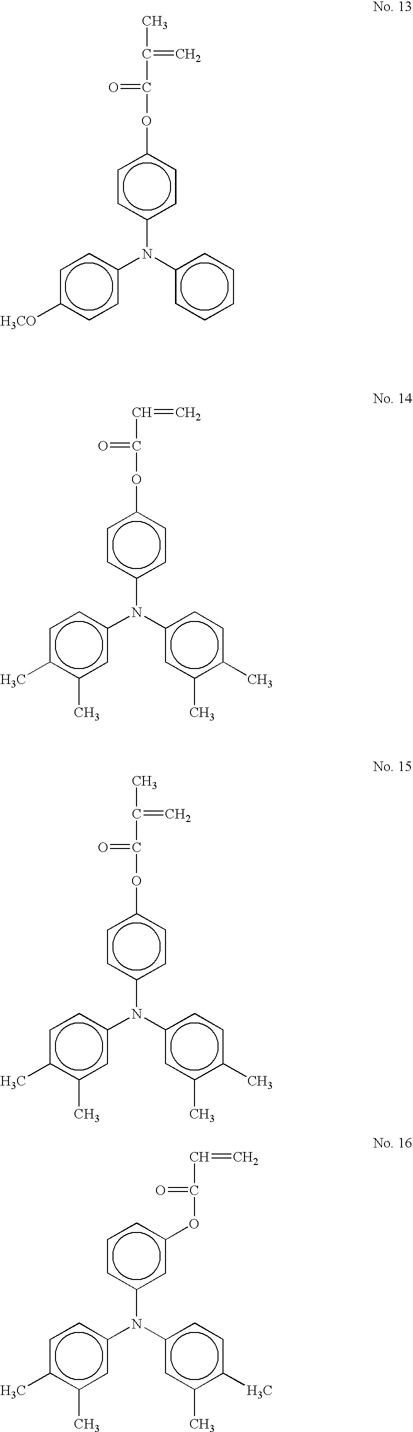

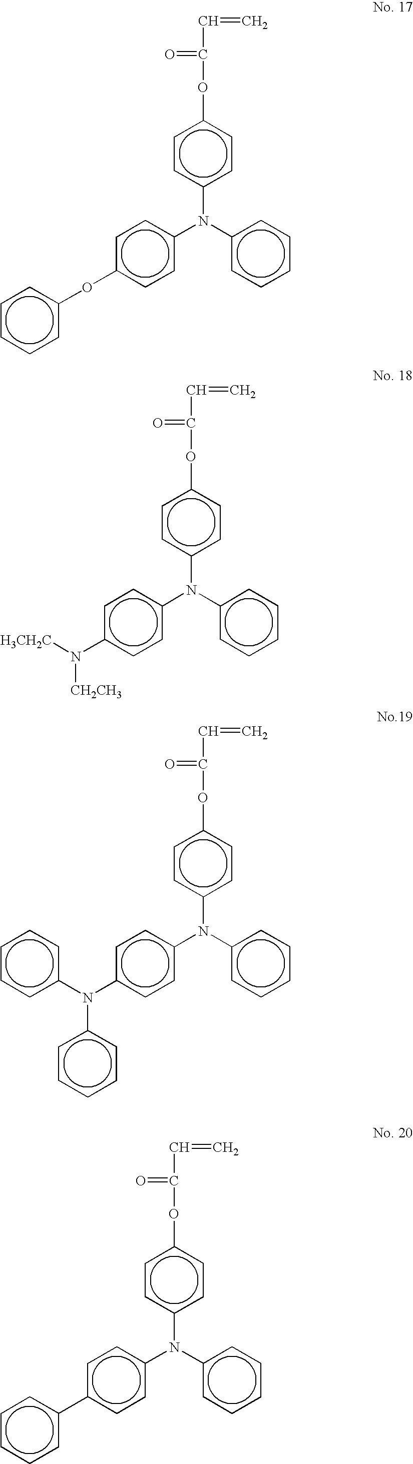

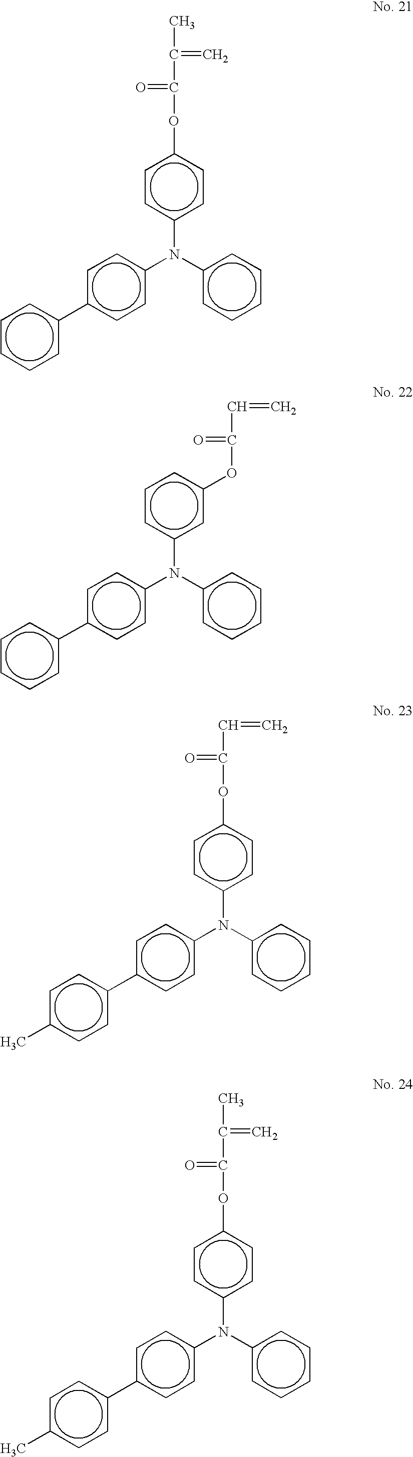

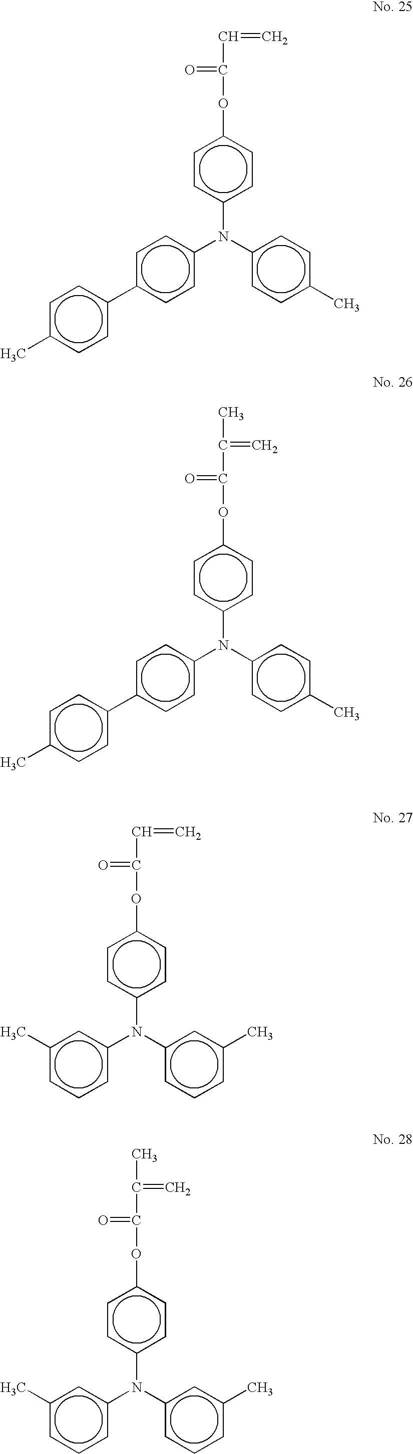

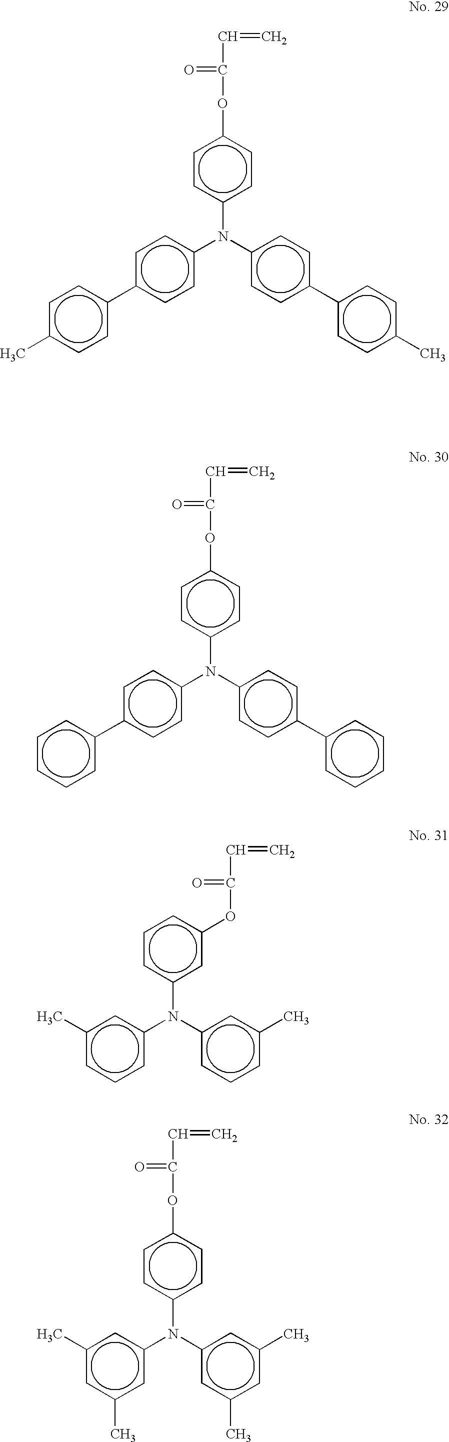

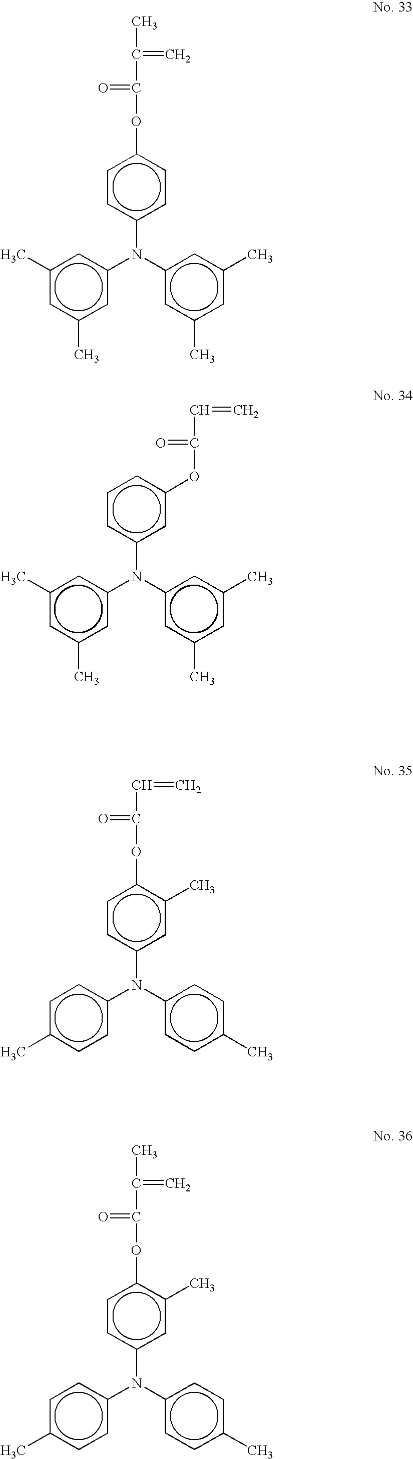

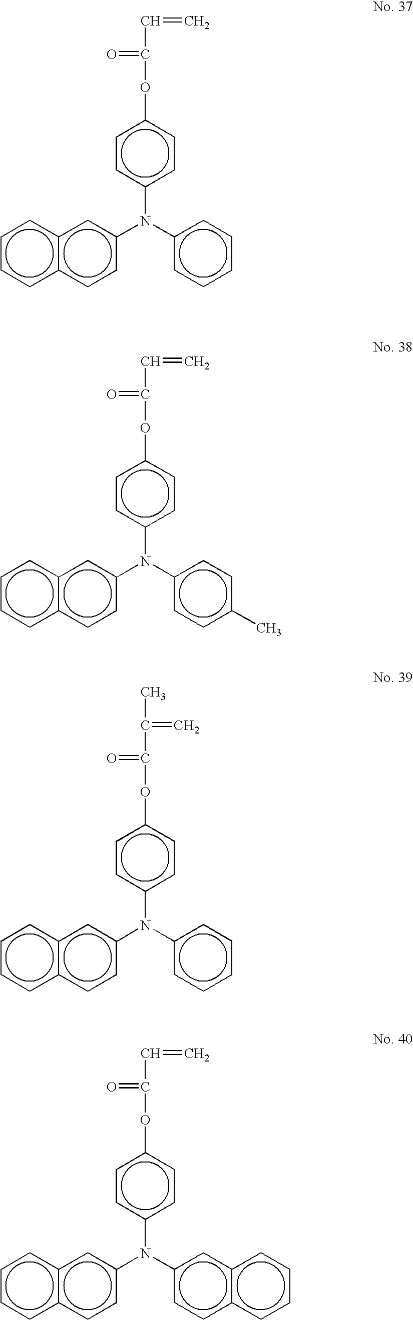

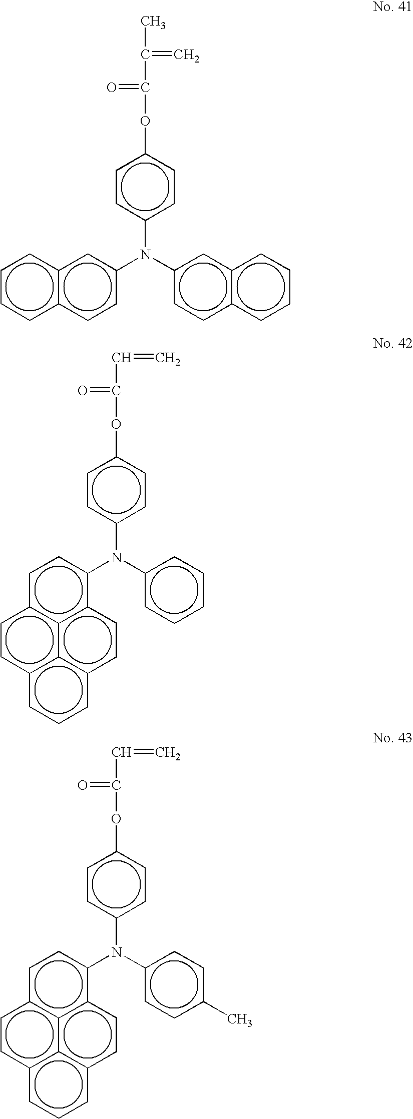

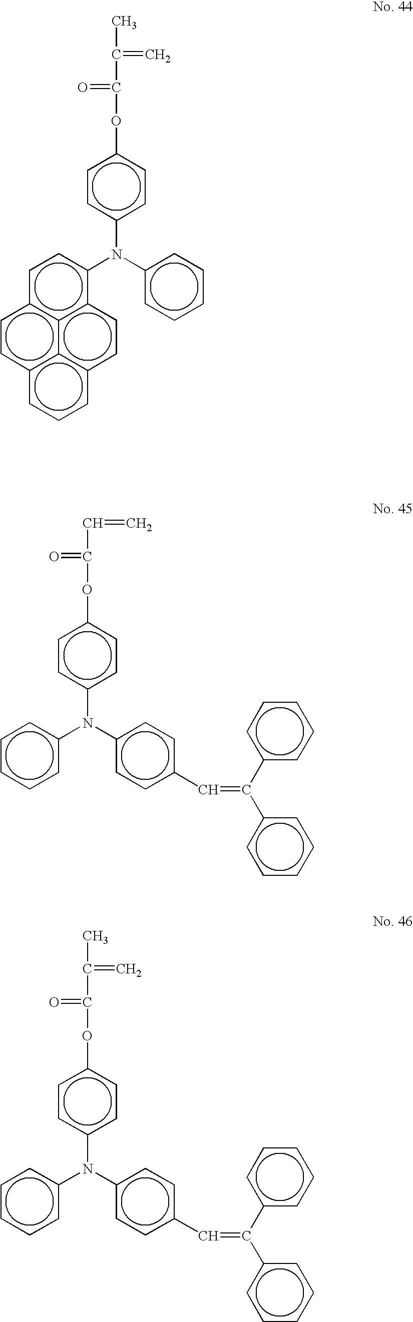

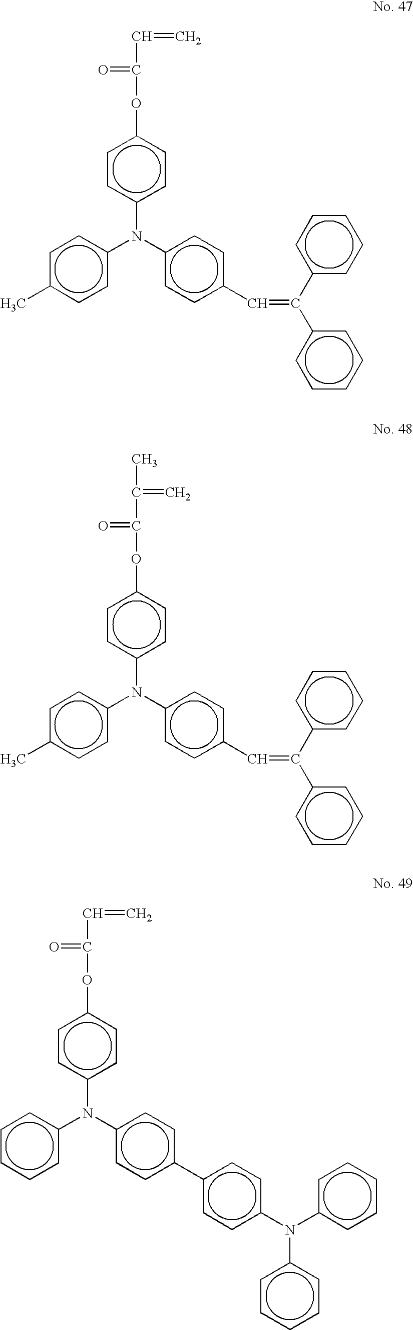

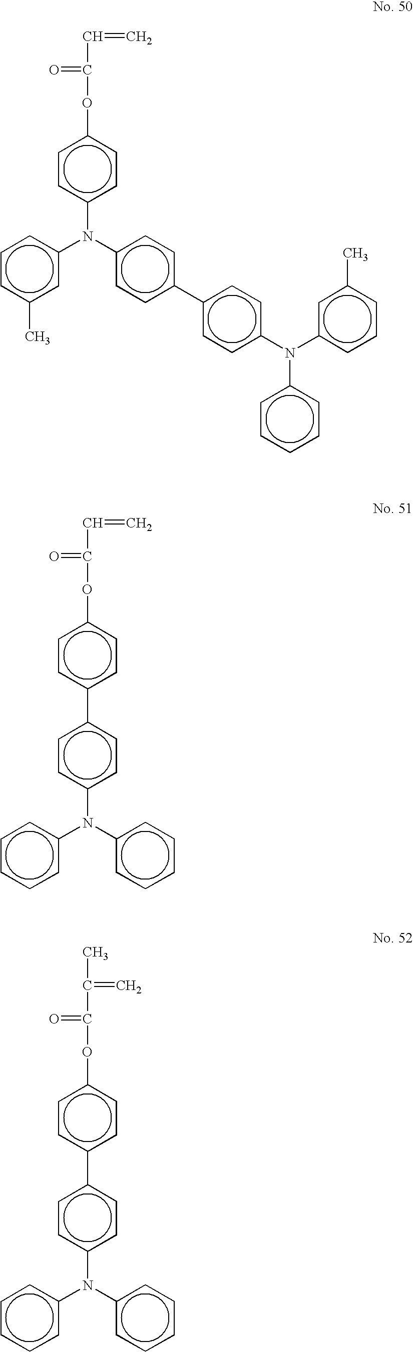

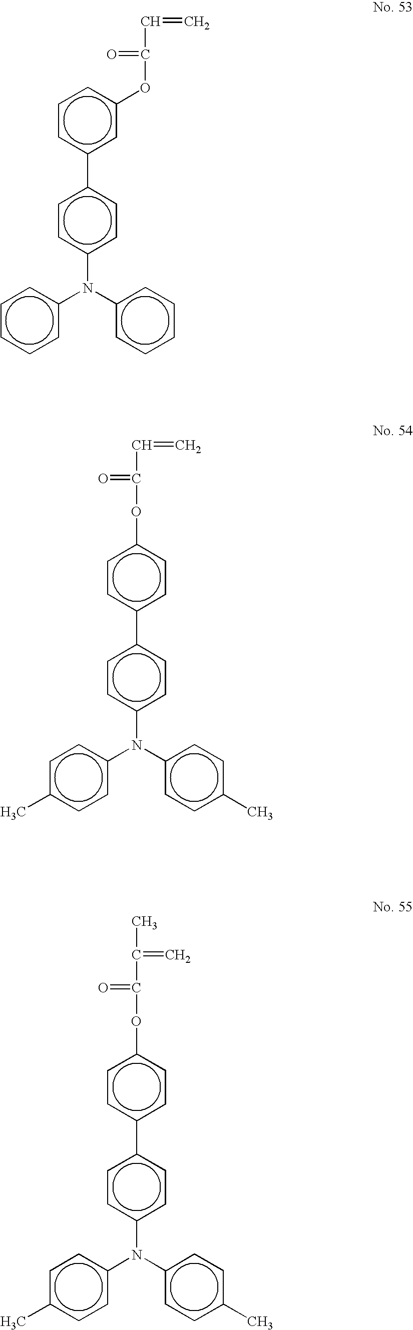

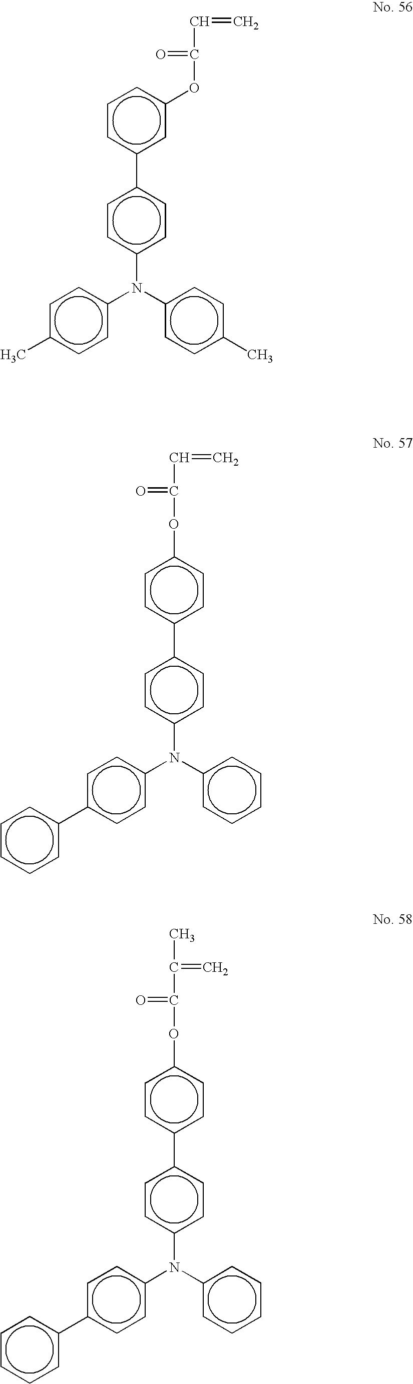

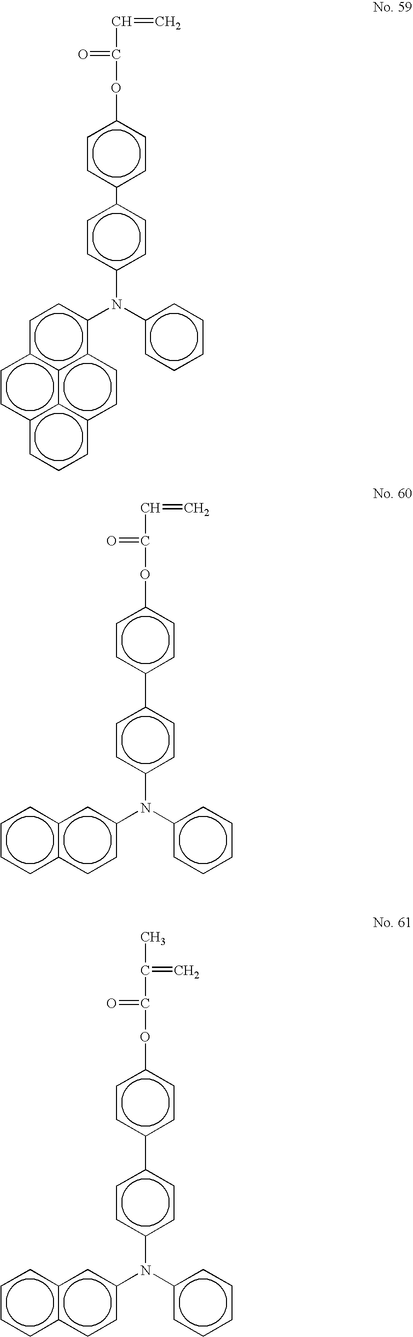

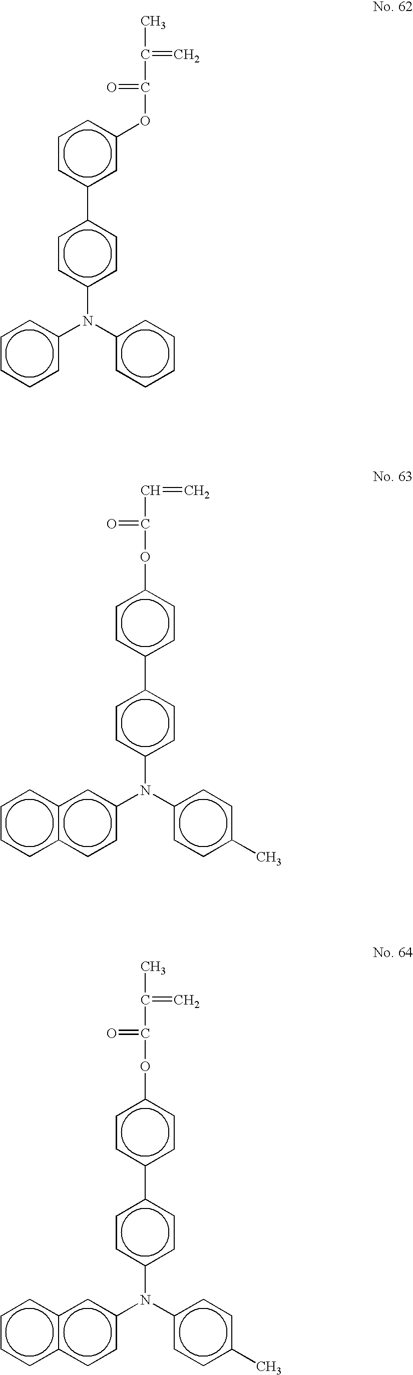

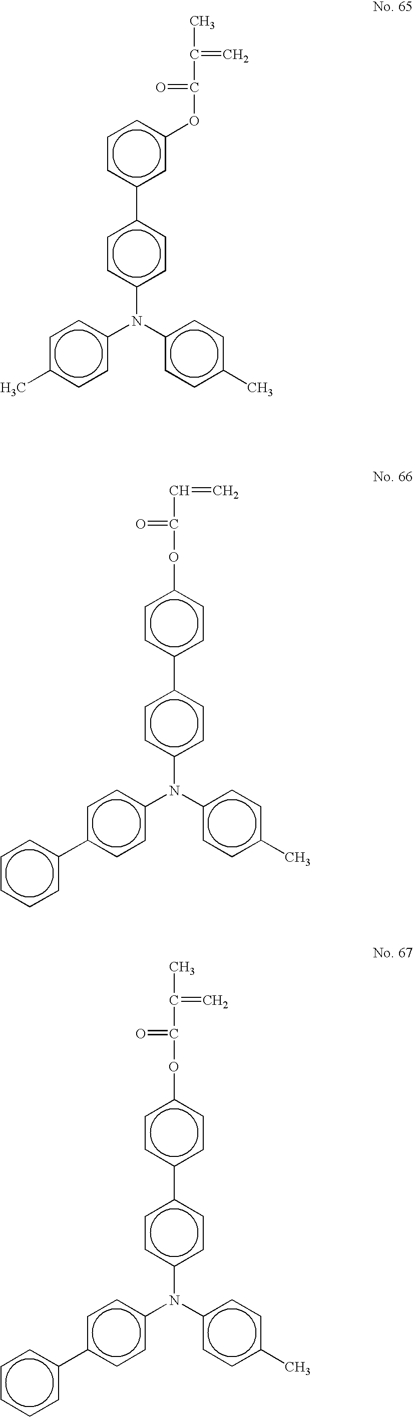

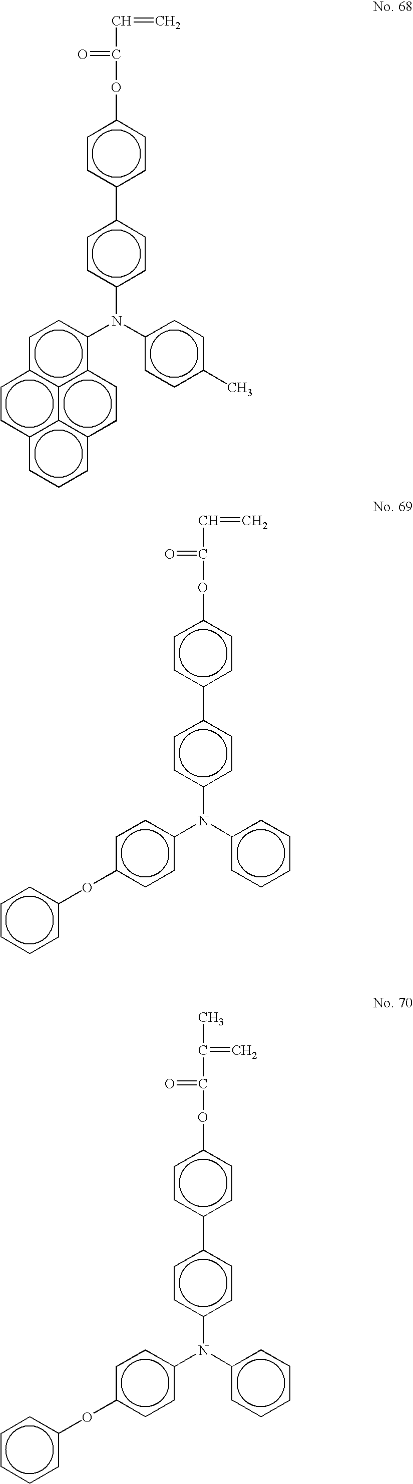

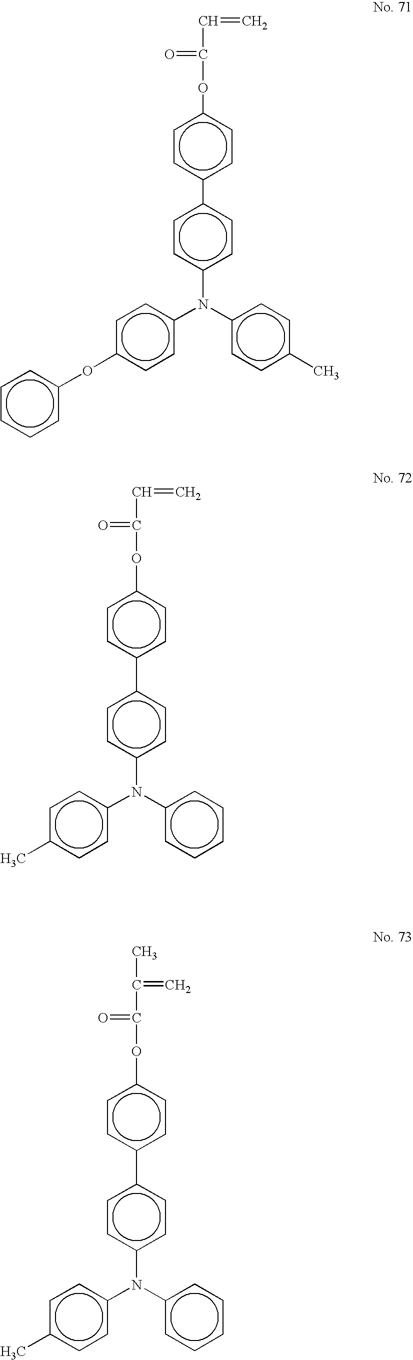

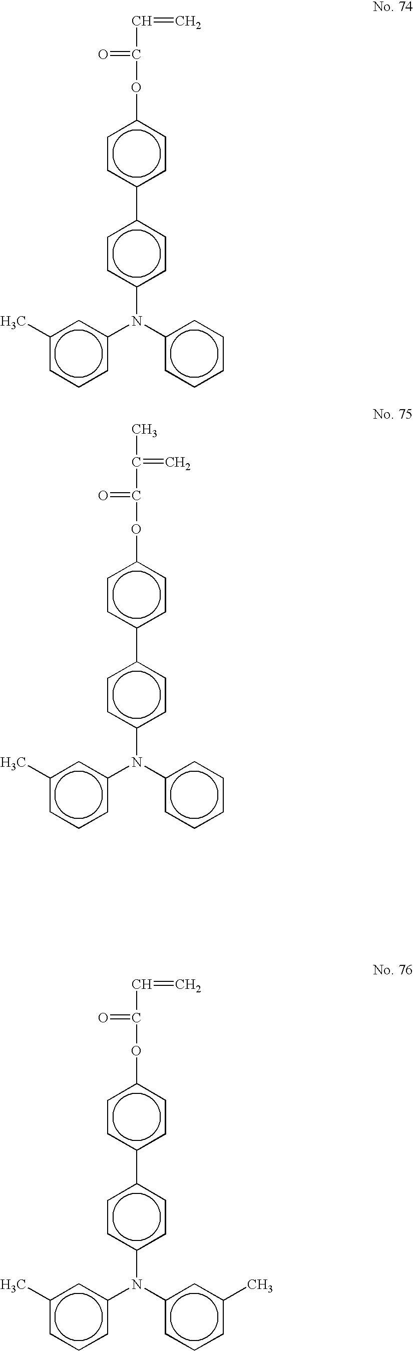

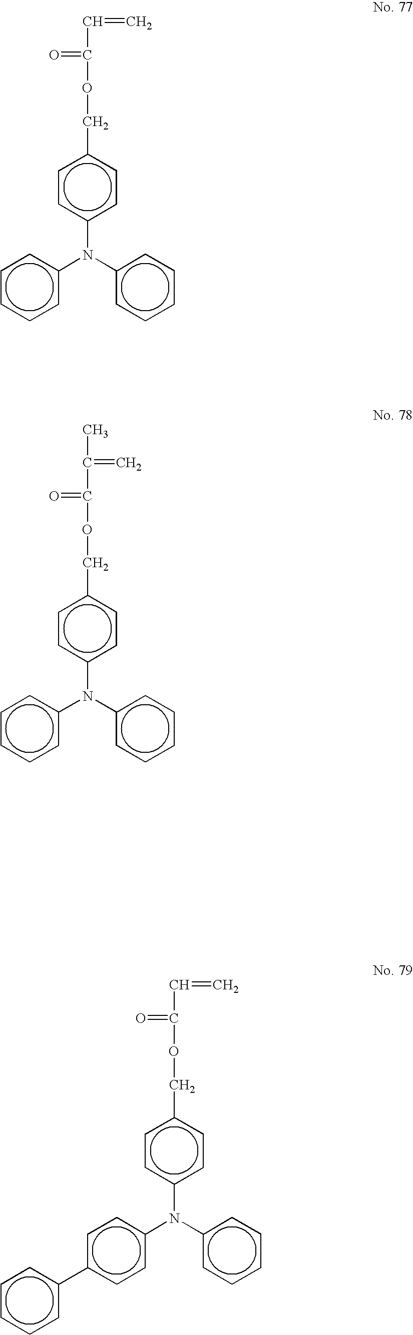

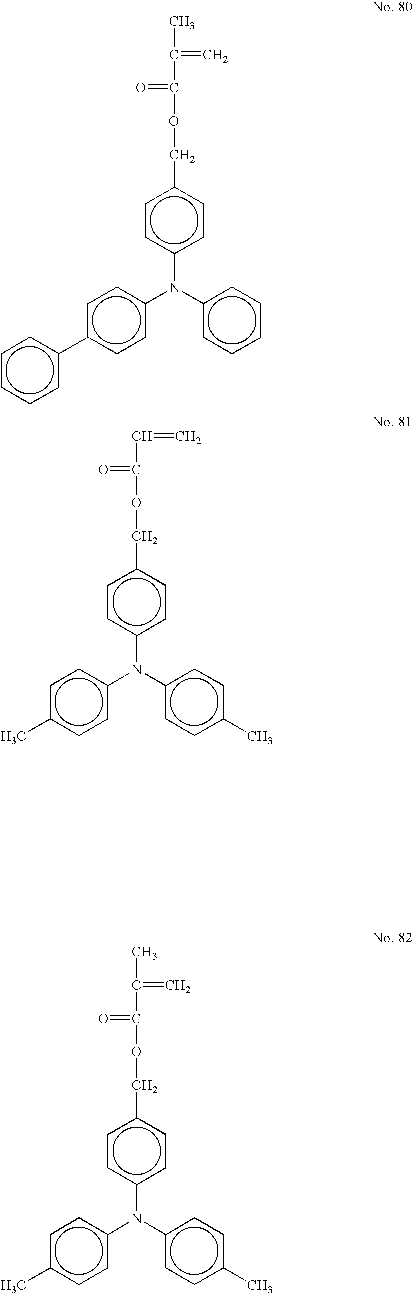

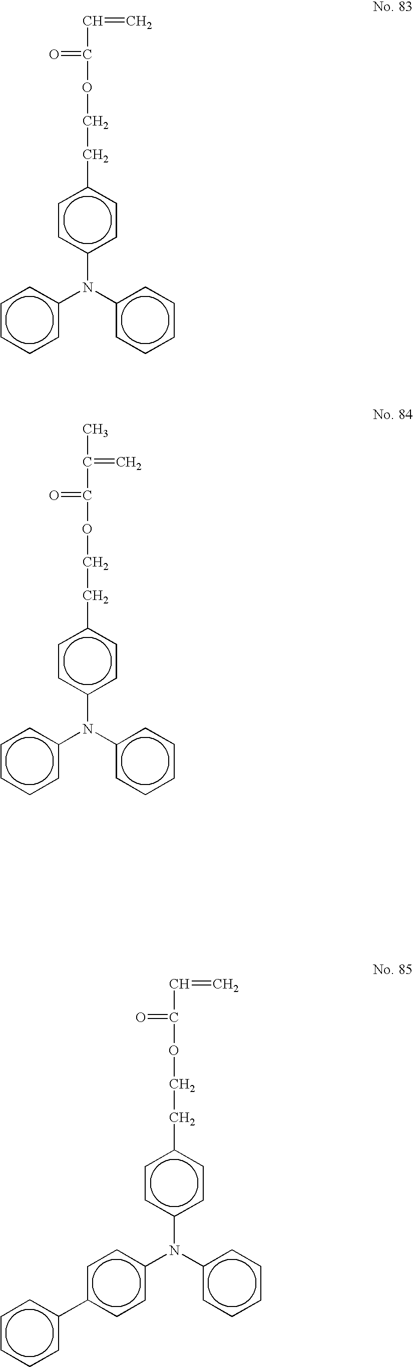

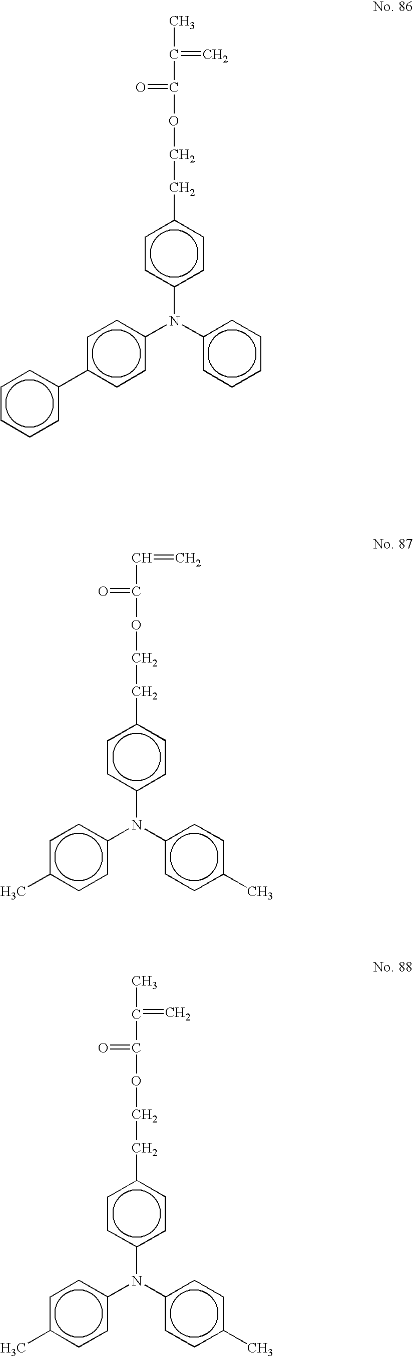

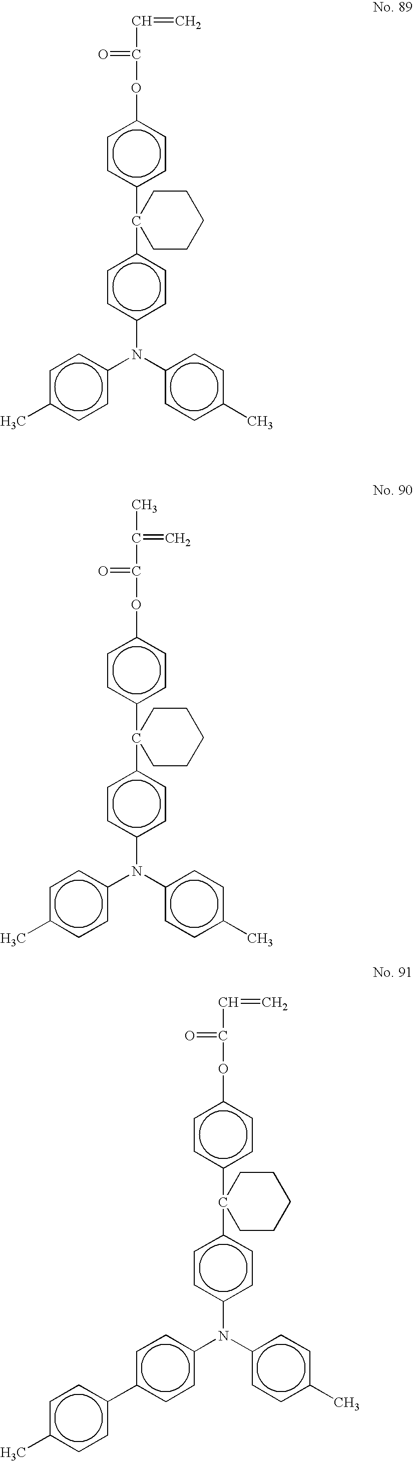

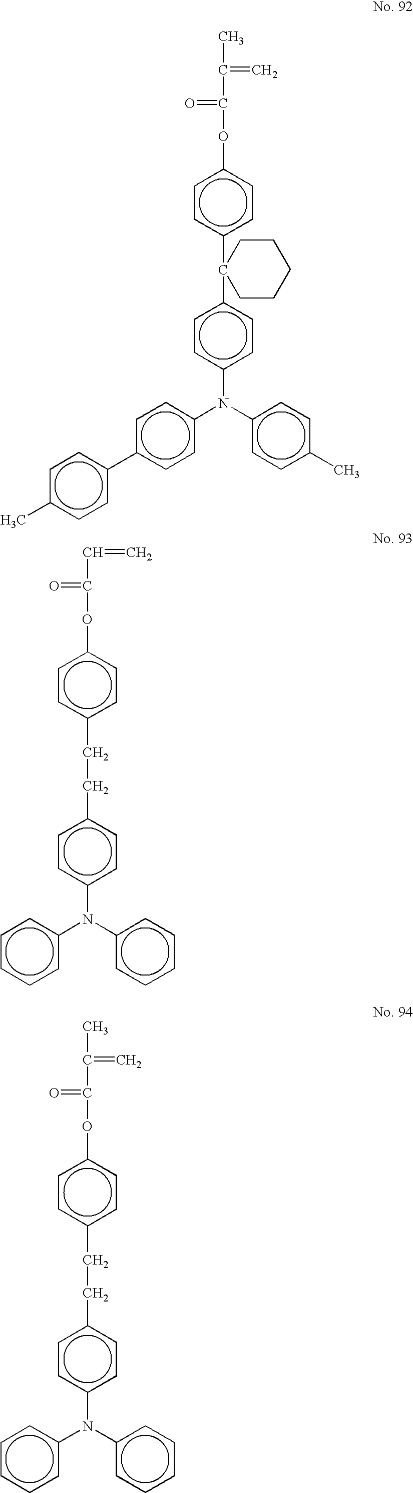

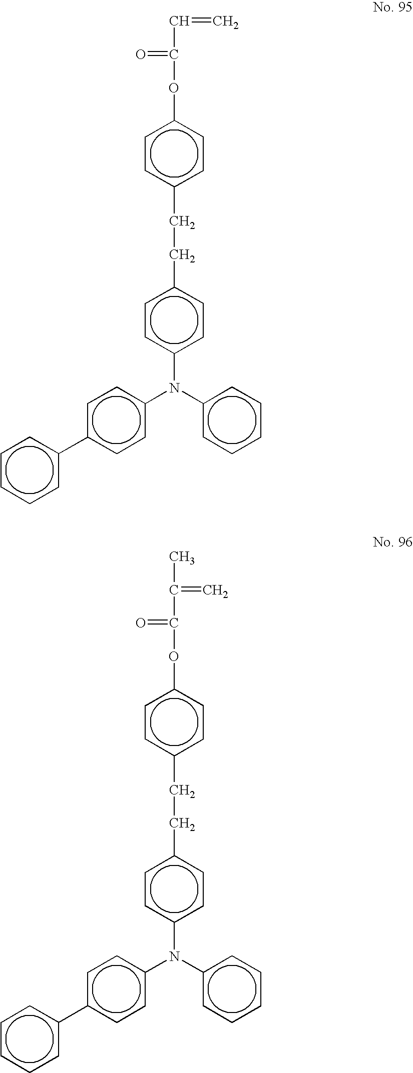

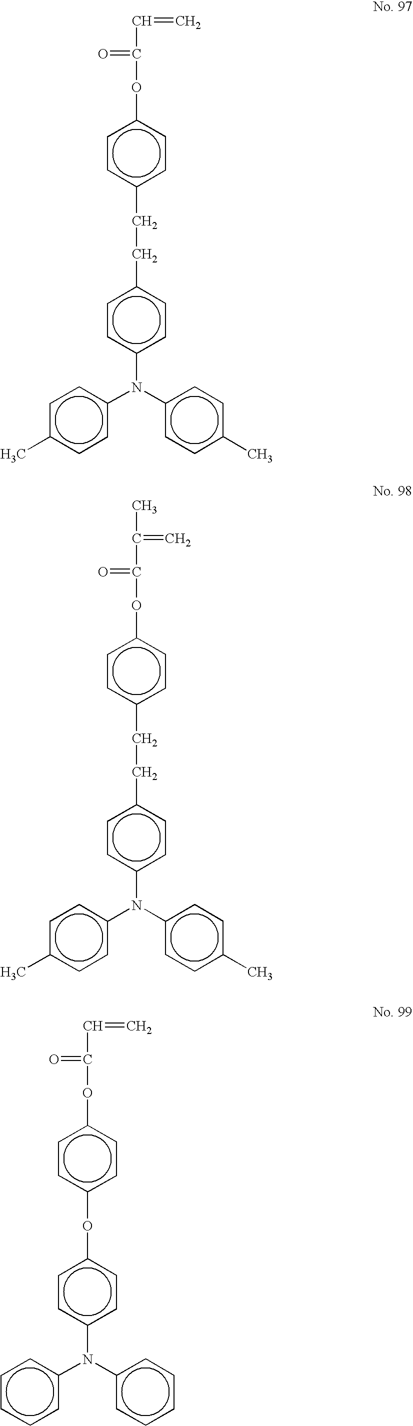

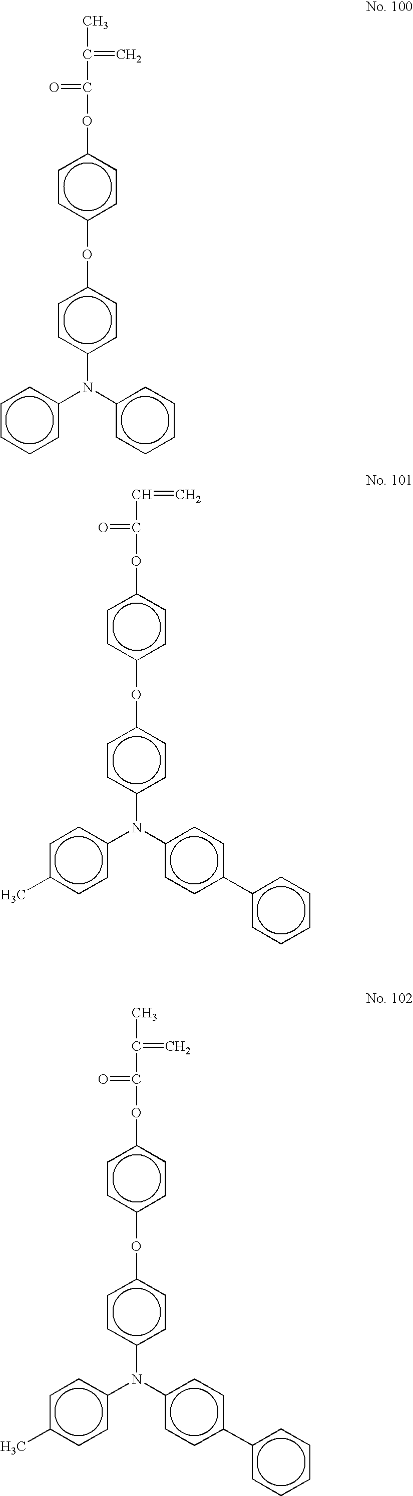

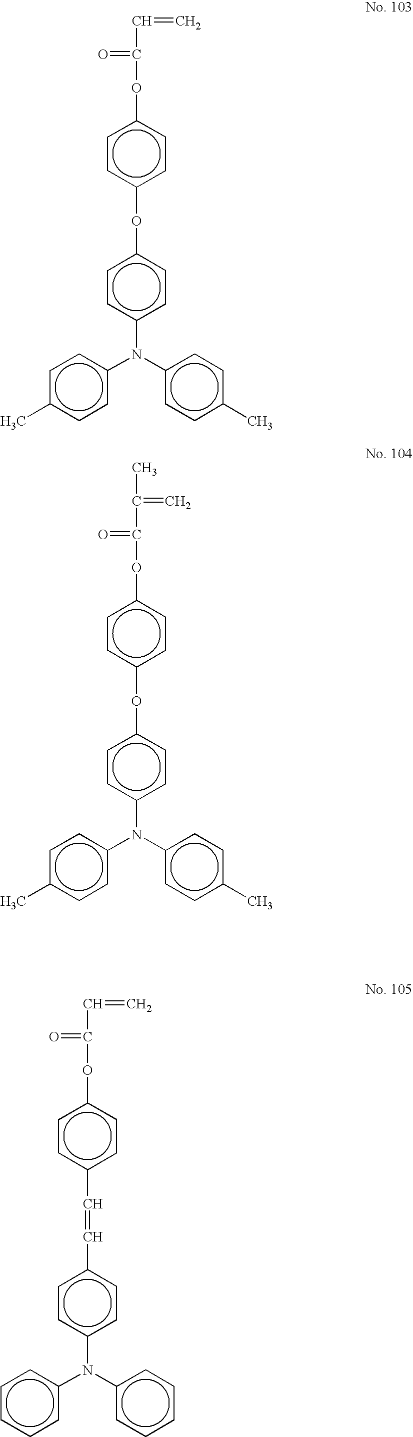

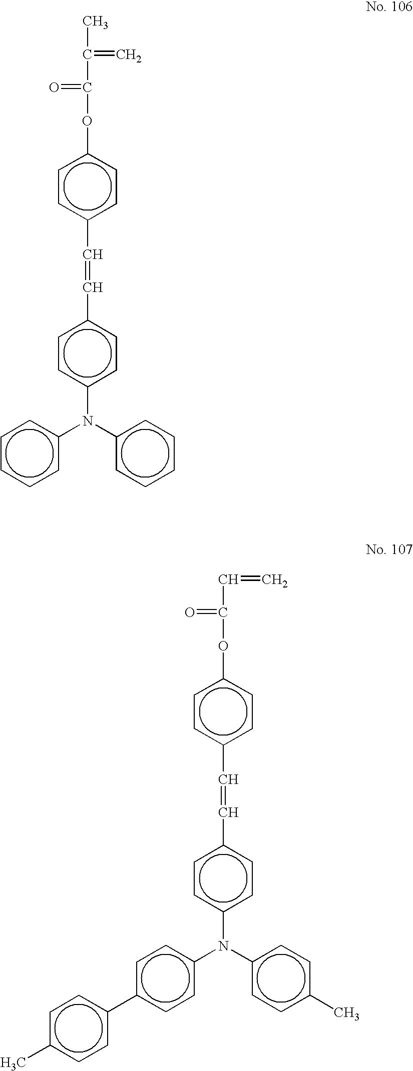

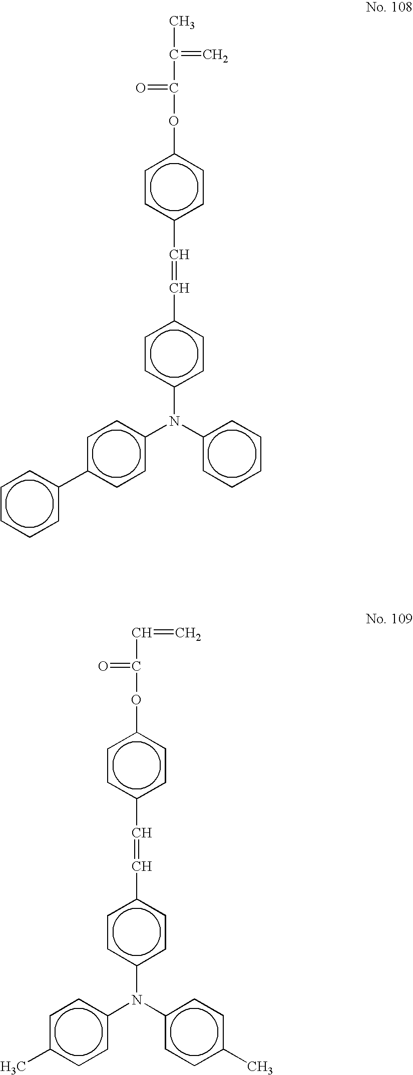

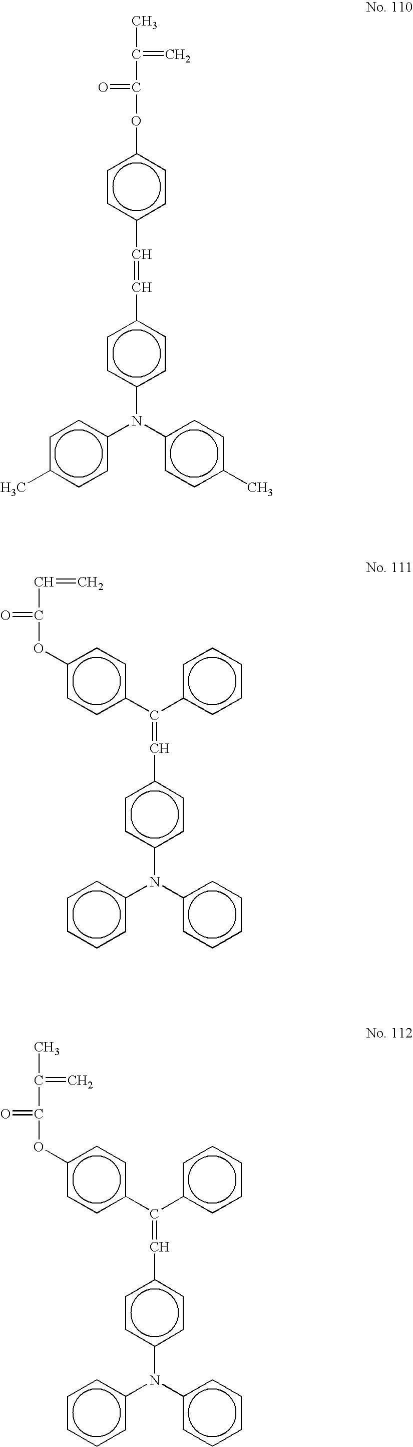

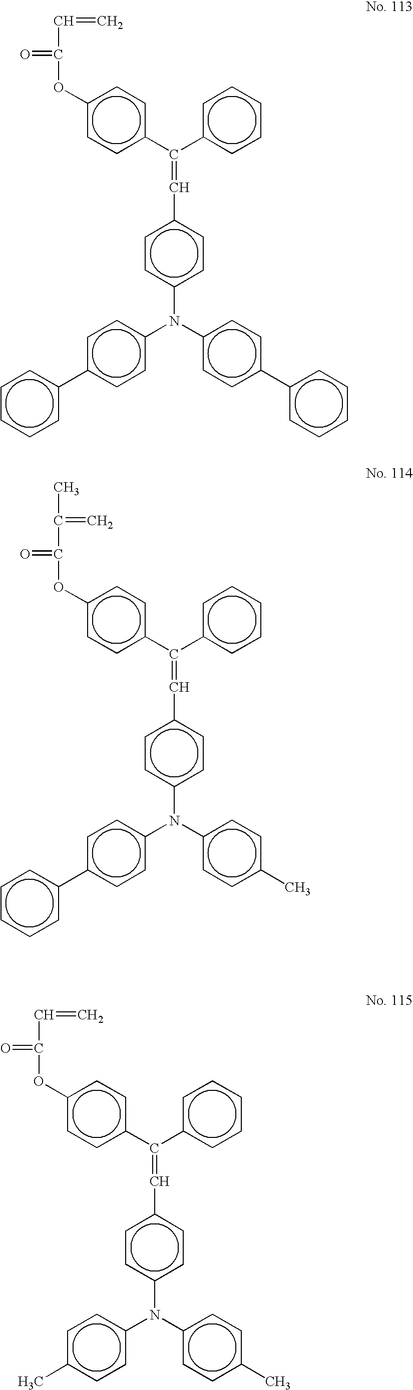

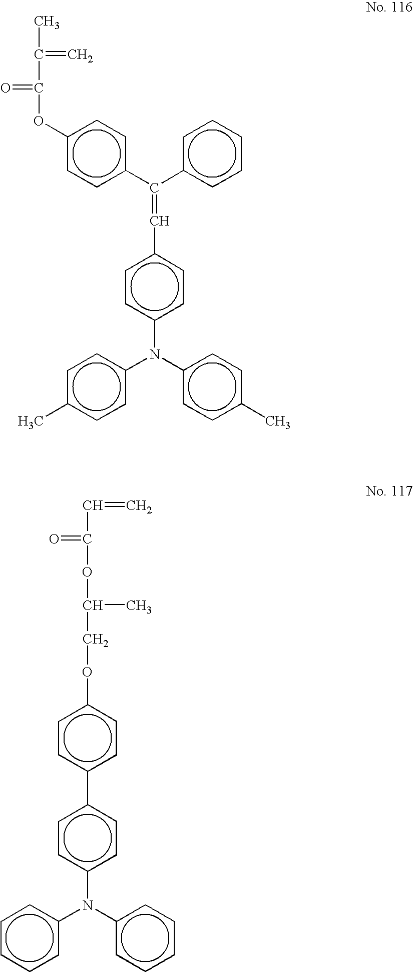

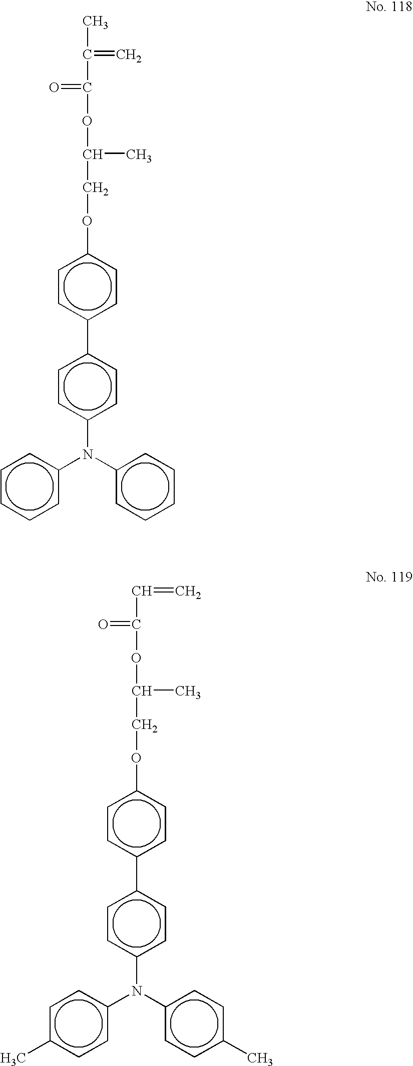

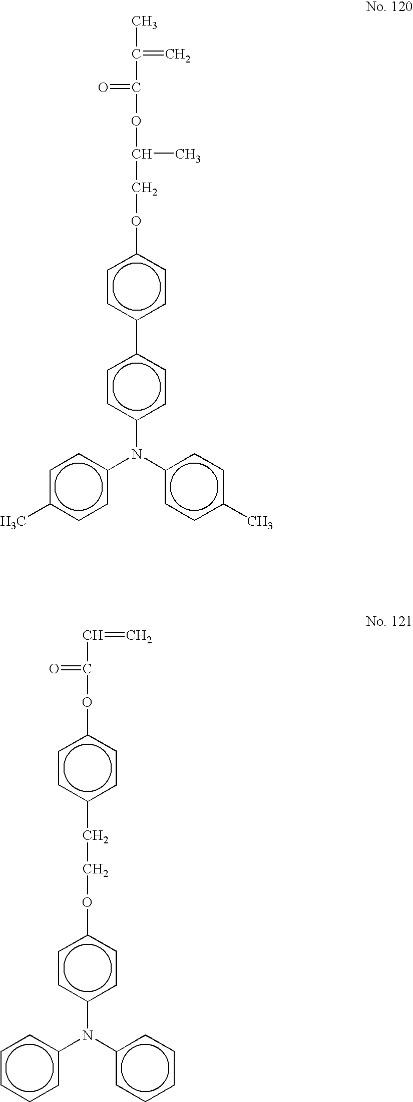

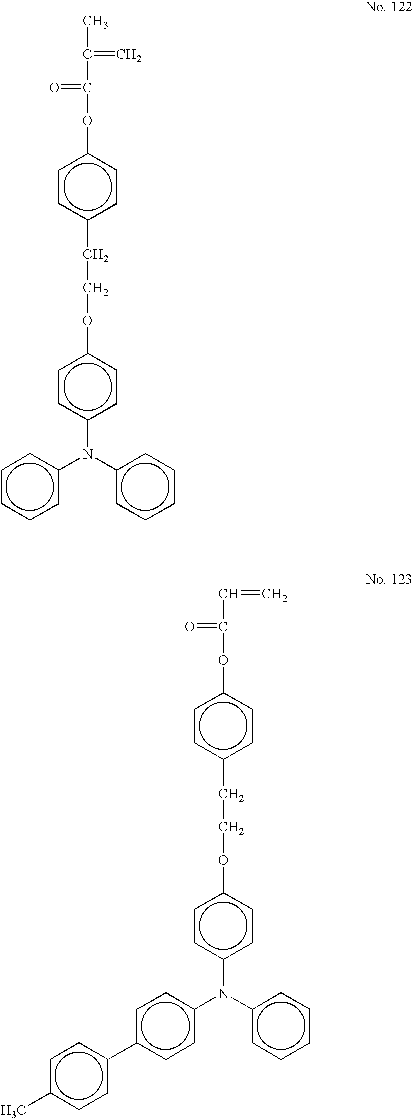

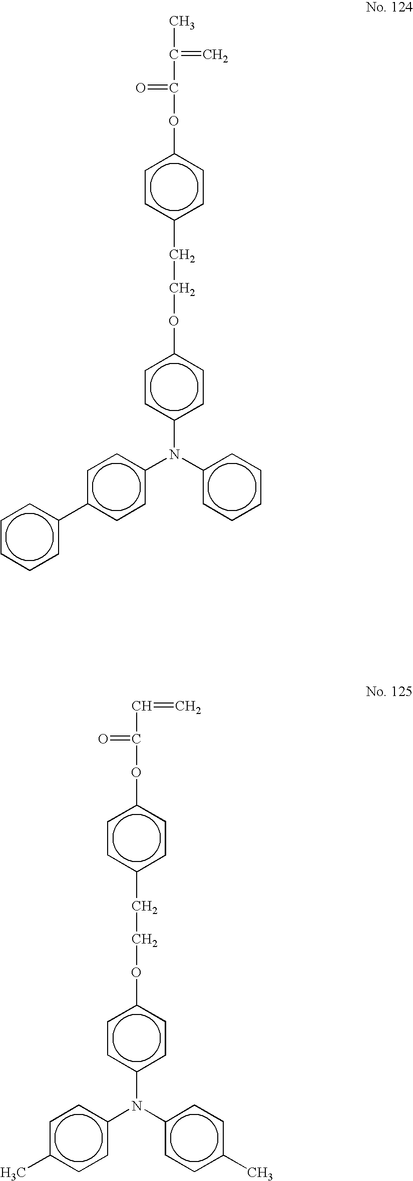

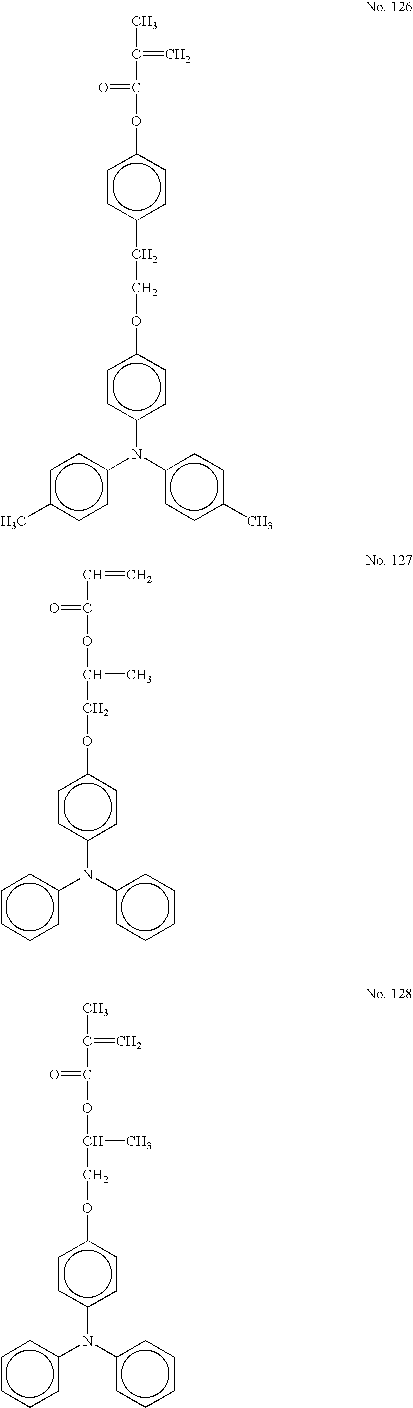

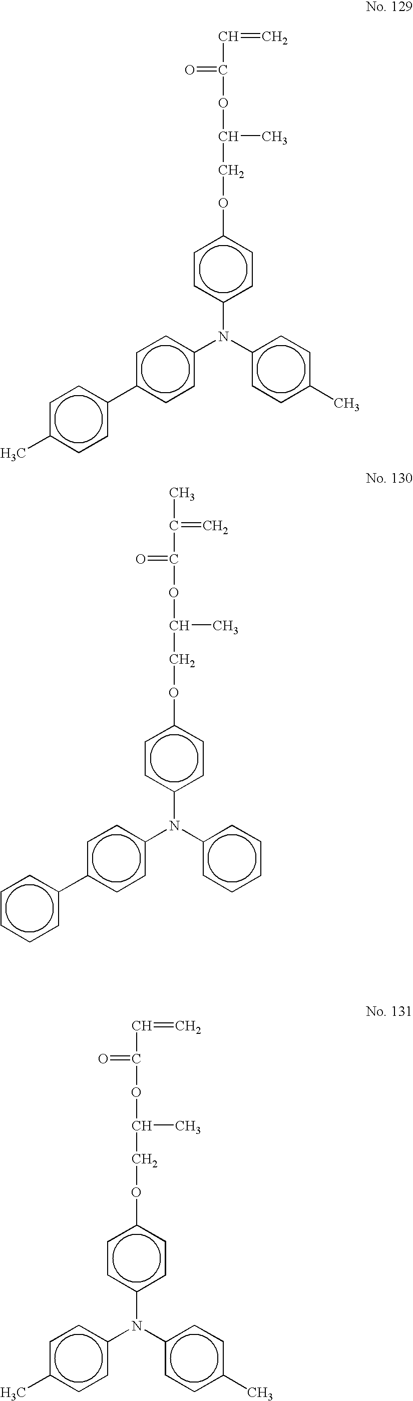

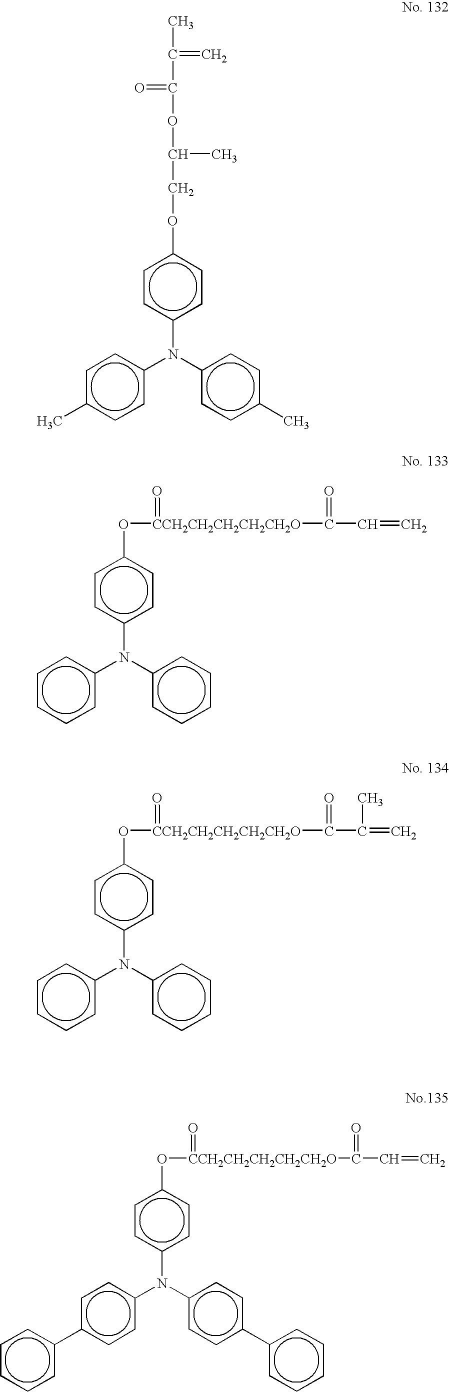

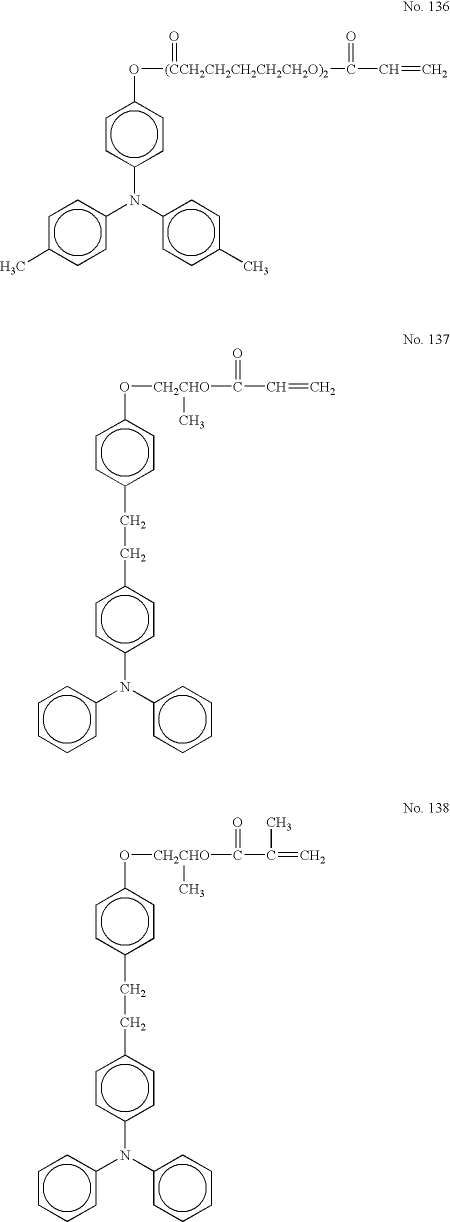

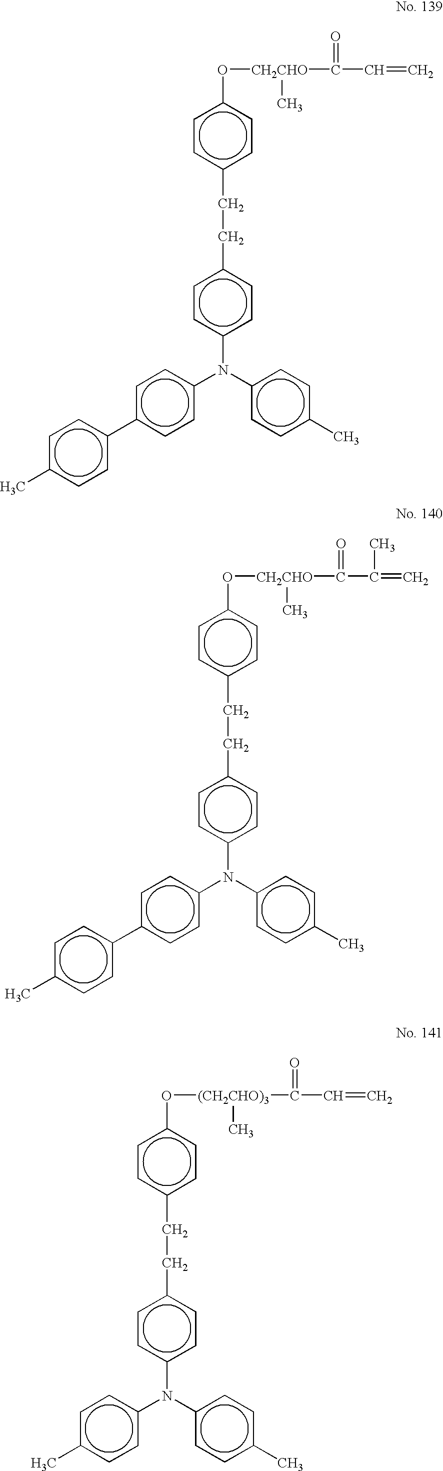

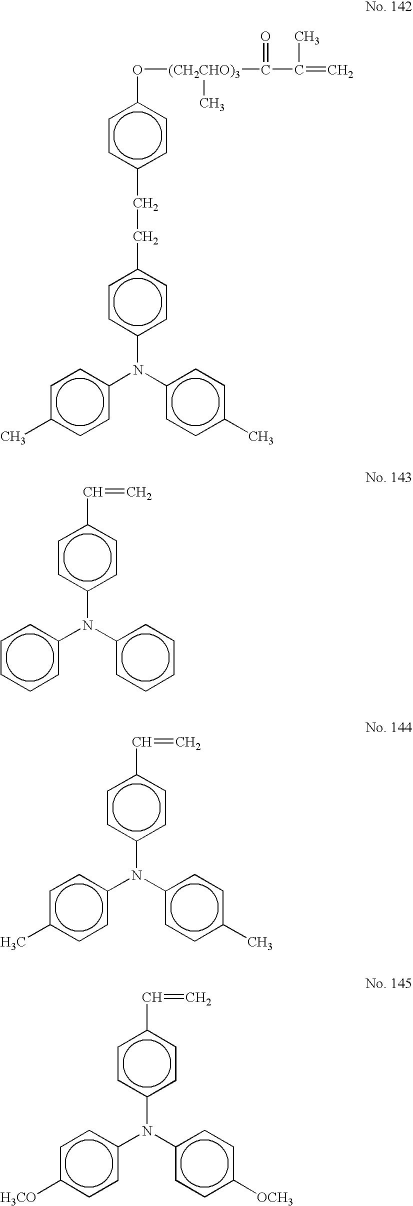

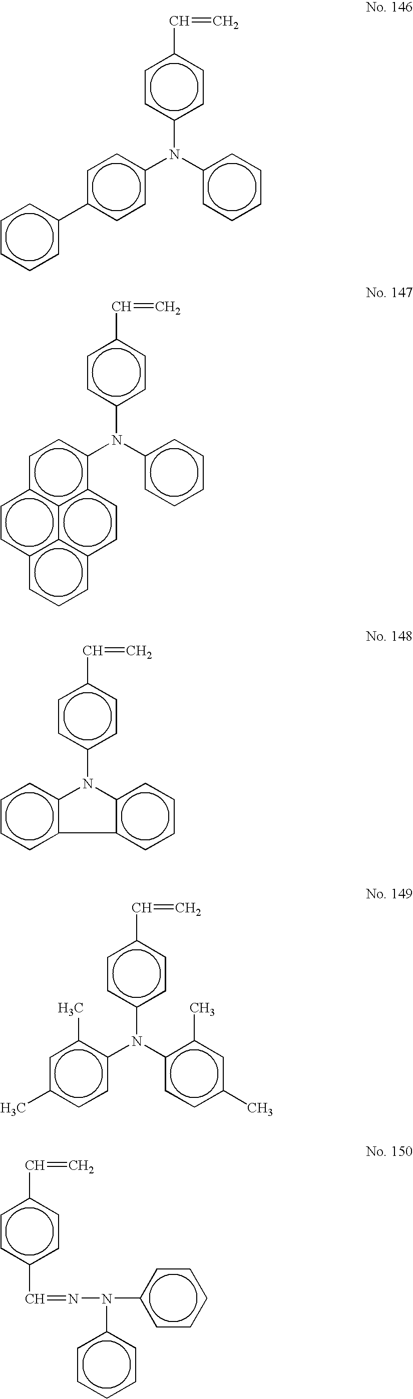

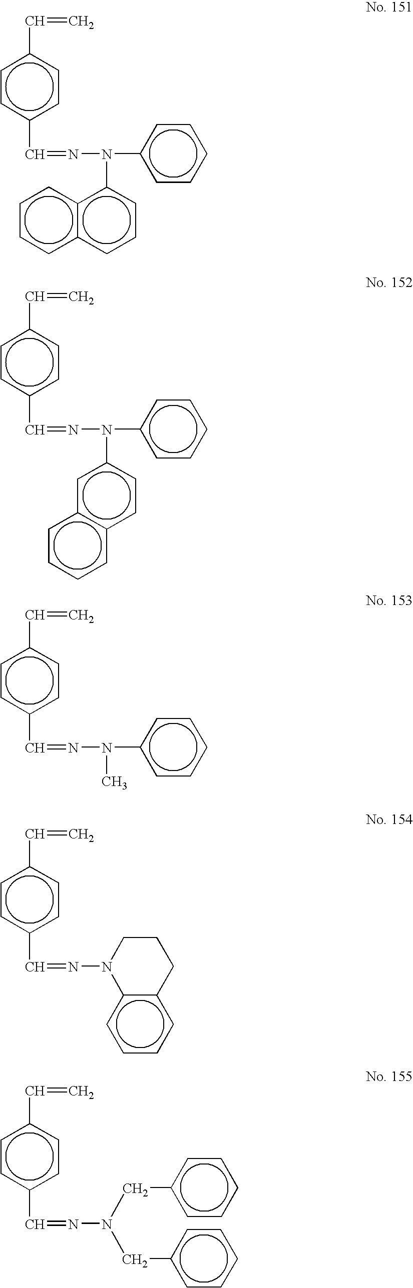

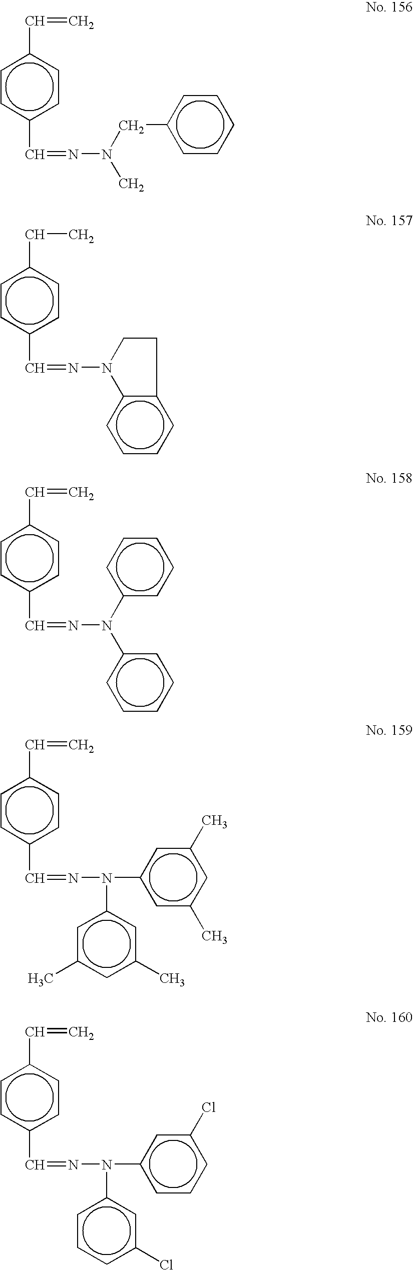

The radical polymerizable compound having one functionality and a charge transport structure employed in the present invention is essential for providing the crosslinked charge transporting layer with charge transport property. The content of the radical polymerizable compound having one functionality and a charge transport structure is preferably 20% by mass to 80% by mass, and is more preferably 30% by mass to 70% by mass, based on the total mass of the crosslinked charge transporting layer. When the content is less than 20% by mass, the charge transport property of the crosslinked charge transporting layer may not be sufficiently maintained, thus causing deterioration of electrical properties such as reduction of sensitivity and increase of residual potential under repeated usages. When the content of radical polymerizable compound having one functionality and a charge transport structure is more than 80% by mass, the content of the radical polymerizable monomer having three or more functionalities and no charge transporting structure is inevitably deficient, thereby the crosslinked density is reduced and higher wear resistance may not be attained. Depending on the processes used, requirements of electric properties and wear resistance differ. With such requirements, a thickness of the crosslinked charge transporting layer of the photoconductor also differs. However, the content of the radical polymerizable compound having one functionality is more preferably 30% by mass to 70% by mass from the viewpoint of wear resistance and electric properties.

The crosslinked charge transporting layer is formed by curing at least a radical polymerizable monomer having three or more functionalities and no charge transport structure and a radical polymerizable compound having one functionality and a charge transport structure. Additionally, in order to control viscosity during coating, to relieve stress of the crosslinked charge transporting layer, to lower the surface energy, and to reduce the friction coefficient, a radical polymerizable monomer, functional monomer, and/or radical polymerizable oligomer having one or two functionalities may be combined together with, which are available from conventional substances.

Examples of the radical polymerizable monomars having one functionality include 2-ethylhexyl acrylate, 2-hydroxyethyl acrylate, 2-hydroxypropyl acrylate, tetrahydrofurfuryl acrylate, 2-ethylhexylcarbitol acrylate, 3-methoxybutyl acrylate, benzyl acrylate, cyclohexyl acrylate, isoamyl acrylate, isobutyl acrylate, methoxytriethylene glycol acrylate, phenoxytetraethyleneglycol acrylate, cetyl acrylate, isotearyl acrylate, stearyl acrylate, styrene monomer and the like.

Examples of the radical polymerizable monomer having two functionalities include 1,3-butanediol diacrylate, 1,4-butanediol diacrylate, 1,4-butanediol dimethacrylate, 1,6-hexanediol diacrylate, 1,6-hexanediol dimethacrylate, diethylene glycol diacrylate, neopentylglycol diacrylate, EO-modified bisphenol A diacrylate, EO-modified bisphenol F diacrylate, and the like.

Examples of the functional monomer include fluorinated monomers such as octafluoropentylacrylate, 2-perfluorooctylethyl acrylate, 2-perfluorooctylethyl methacrylate, 2-perfluoroisononylethyl acrylate and the like; vinyl monomers, acrylate and methacrylate having a polysiloxane group such as acryloylpolydimethylsiloxaneethyl, methacryloylpolydimethylsiloxaneethyl, acryloylpolydimethylsiloxanepropyl, acryloylpolydimethylsiloxanebutyl, diacryloylpolydimethylsiloxanediethyl and the like, which have 20 to 70 siloxane repeating units, as described in Japanese Patent Application Publication (JP-B) Nos. 5-60503 and 6-45770.

Examples of the radical polymerizable oligomer include epoxy acrylates, urethane acrylates, and polyester acrylate oligomers. When the radical polymerizable monomer and/or radical polymerizable oligomer having one or two functionalities is added in an excessively large amount, three dimensional crosslink density of the crosslinked charge transporting layer is likely to be lower, causing reduction of wear resistance. Preferably, the content of these monomers or oligomer is 50 parts by mass or less, preferably 30 parts by mass or less, based on 100 parts by mass of the radical polymerizable monomer having three or more functionalities.

The crosslinked charge transporting layer is formed by curing at least a radical polymerizable monomer having three or more functionalities and no charge transport structure and a radical polymerizable compound having one functionality and a charge transport structure. To effectively initiating the curing reaction in response to necessity, a polymerization initiator may be contained in the coating liquid for the crosslinked charge transporting layer. The polymerization initiators include a thermal polymerization initiator and a photopolymerization initiator.

Examples of the thermal polymerization initiator include peroxides such as 2,5-dimethylehexane-2,5-dihydroperoxide, dicumyl peroxide, benzoyl peroxide, t-butylcumyl peroxide, 2,5-dimethyl-2,5-di(peroxybenzoyl)hexyne-3, di-t-butylperoxide, t-butylhydroperoxide, cumene hydroperoxide, lauroyl peroxide 2,2-bis(4,4-di-t-butylperoxycyclohexy)propane, and azo initiators such as azobis isobutyronitrile, azobis cyclohexanecarbonitrile, azobisisobutyric ester, azobisisobutylamidine hydrochloride, 4,4′-azobis-4-cyanovaleric acid, and the like.

Examples of the photopolymerization initiator include acetophenone or ketal compounds such as diethoxyacetophenone, 2,2-dimethoxy-1,2-diphenylethan-1-one, 1-hydroxy-cyclohexyl-phenyl-ketone, 4-(2-hydroxyethoxy)phenyl-(2-hydroxy-2-propyl)ketone, 2-benzyl-2-dimethylamino-1-(4-morpholinophenyl)butanone-1,2-hydroxy-2-methyl-1-phenylpropane-1-one, 2-methyl-2-morpholino(4-methylthiophenyl)propane-1-one, and 1-phenyl-1,2-propanedione-2-(o-ethoxycarbonyl)oxime; benzoinether compounds such as benzoin, benzoinmethyl ether, benzoinethylether, benzoinisobutylether, and benzoinisopropyl ether; benzophenone compounds such as benzophenone, 4-hydroxybenzophenone, methyl o-benzoylbenzoate, 2-benzoylnaphthalene, 4-benzoylbiphenyl, 4-benzoylphenylether, acrylated benzophenone, and 1,4-benzoylbenzene; thioxanthone compounds such as 2-isopropylthioxanthone, 2-chlorothioxanthone, 2,4-dimethylthioxanthone, 2,4-diethylthioxanthone, and 2,4-dichlorothioxanthone; and other photopolymerization initiators such as ethylanthraquinone, 2,4,6-trimethylbenzoyldiphenylphosphine oxide, 2,4,6-trimethylbenzoylphenylethoxyphosphine oxide, bis(2,4,6-trimethylbenzoyl)phenylphosphine oxide, bis(2,4-dimethoxybenzoyl)-2,4,4-trimethylpentylphosphine oxide, methylphenylglyoxyester, 9,10-phenanthrene compounds, acridine compounds, triazine compounds, imidazole compounds and the like.

Also, it is possible to employ a photopolymerization promoter alone or together with the photopolymerization initiator described above; examples of the photopolymerization promoter include triethanolamine, methyldiethanolamine, ethyl 4-dimethylaminobenzoate, isoamyl 4-dimethylaminobenzoate, (2-dimethylamino)ethylbenzoate, 4,4′-dimethylaminobenzop henone and the like.

The polymerization initiators may be used alone or in combination.

The content of the polymerization initiator is preferably 0.5 parts by mass to 40 parts by mass, is more preferably 1 part by mass to 20 parts by mass based on 100 parts by mass of the total amount of the entire compounds capable of radically polymerizing.

The coating liquid for the crosslinked charge transporting layer in the present invention may contain various additives such as plasticizers (for the purpose of relieving stress and improving adhesion), leveling agents, non-reactive charge transport substances with a low molecular and the like, depending on requirements. These additives may be selected from conventional substances. Plasticizers available in the present invention include those commonly used in conventional resins such as dibutylphthalate, dioctylphthalate and the like; the additive amount is preferably 20% by mass or less, is more preferably 10% by mass or less based on the total solid content of the coating liquid.

Further, leveling agents available in the present invention include silicone oils such as dimethyl silicone oil, methylphenyl silicone oil and the like, and polymers or oligomers having a perfluoroalkyl group in a side chain.

The additive amount of the leveling agent is preferably 3% by mass or less based on the total solid content of the coating liquid.

The crosslinked charge transporting layer in the present invention may be formed by applying a coating liquid comprising a radical polymerizable monomer having three or more functionalities and no charge transport structure and a radical polymerizable compound having one functionality and a charge transport structure, followed by curing the coating liquid. When the radical polymerizable monomer or compound is liquid, the coating liquid may be prepared by way of dissolving or dispersing the other ingredients into the liquid of the radical polymerizable monomer or compound; alternatively, a solvent may be utilized for dissolving or dispersing the ingredients. Examples of the solvent include alcohols such as methanol, ethanol, propanol, and butanol; ketones such as acetone, methylethylketone, methyl isobutylketone, and cyclohexanone; esters such as ethyl acetate and butyl acetate; ethers such as tetrahydrofuran, dioxane, and propylether; halogenated compounds such as dichloromethane, dichloroethane, trichloroethane, and chlorobenzene; aromatics such as benzene, toluene, and xylene; cellosolves such as methylcellosolve, ethylcellosolve, and cellosolve acetate, and the like. These solvents may be used alone or in combination. The dilution rate by the solvent depends on solubility of the composition, coating process, desired membrane thickness, and the like, and may be properly selected depending on the application. The coating may be applied by dipping, spraying, bead coating, ring coating, or the like.

After the coating liquid for the crosslinked charge transporting layer is applied, the coating is cured by an external energy thereby to form a crosslinked charge transporting layer. The external energy may be thermal, optical, or radiation energy. The thermal energy may be applied by heating the coating surface or the support by use of air, gas such as nitrogen, vapor, or various heating media, infrared ray, or electronic wave. The heating temperature is preferably 100° C. to 170° C. When the temperature is less than 100° C., the reaction rate is slower and the curing reaction may not progress sufficiently. When the temperature is higher than 170° C., the reaction may progress nonuniformly, possibly causing significant distortion, many unreacted resides and reaction stopped terminals in the crosslinked charge transporting layer. To uniformly progress the curing reaction, a process is useful that initial heating is carried out at a lower temperature of less than 100° C., then further heating is carried out at a temperature of 100° C. or higher to complete the reaction.

The source of optical energy may be selected from high pressure mercury lamps and metal halide lamps having a main emitting wavelength at UV region, and also visible light sources in accordance with the absorption wave length of the radical polymerizable components or photopolymerization initiators. The irradiated energy is preferably 50 mW/cm² to 1,000 mW/cm². When the irradiated energy is less than 50 mW/cm², the curing period is often excessively long, and when it is more than 1,000 mW/cm², the reaction progresses nonuniformly. Thus, the surface of the crosslinked charge transporting layer has wrinkles in a local area and many unreacted residues and reaction stopped terminals occur. Further, inner stress becomes large due to drastic crosslinking, thereby to cause cracks or film peeling.

Example of radiation energy may be of electron beam. Among the energies, thermal and optical energy may be effective and useful by virtue of easiness of controlling the reaction rate and convenience of the apparatus.

Preferably, the thickness of the crosslinked charge transporting layer is 1 μm to 10 μm, and is more preferably 2 μm to 8 μm. When the thickness is more than 10 μm, the cracks or film peeling easily occur as mentioned above. When the thickness is 8 μm or less, the crosslinking intensity can become higher and further substances for increasing wear resistance can be selected and curing conditions can be set. On the other hand, the radical polymerization reaction tends to undergo oxygen inhibition, and the crosslink does not progress on the surface contacting to atmosphere due to radical trap by oxygen or tends to become nonuniform. These influences are significantly seen on the surface layer of thickness 1 μm or less. When the crosslinked charge transporting layer having thickness 1 μm or less easily generates low wear resistance or nonuniform wear. Further, the under layer components of the charge transporting layer are included in the coating step of the crosslinked charge transporting layer. When the coating thickness of the crosslinked charge transporting layer is thin, the inclusion spread the entire layer, resulting in the inhibition of the curing reaction and the lowering of the crosslink density. For these reasons, the crosslinked charge transporting layer of the present invention has the thickness of 1 μm or more and has excellent wear resistance and superior scratch resistance. But when a shaved portion is made locally to the under layer of the charge transporting layer by repeated uses, the wear in this portion increases. Due to charging ability and sensitivity change, the density in the intermediate images becomes easily nonuniform. Thus, to attain prolong life time and high quality images, it is preferable that the thickness of the crosslinked charge transporting layer is 2 μm or more.

In the coating liquid for the crosslinked charge transporting layer, when the coating liquid for the crosslinked charge transporting layer contains a great many amount of additives such as a binder resin not having a radial polymerizable functionality group, an antioxidant, plasticizer, and the like, other than the radical polymerizable monomer having three or more functionalities and no charge transport structure and the radical polymerizable compound having one functionality and charge transport structure, the crosslink density becomes low and a phase separation between the cured product produced by the reaction and the additives occurs and becomes soluble to the organic solvent. Specifically, it is important to control the total additive amount being 20% by mass or less based on the total solid content of the coating liquid. Further, in order not to crosslinked density lower, in the radical polymerization monomer having one functionality or two functionalities, reactive oligomer and reactive polymer, the total additive amount is preferably 20% by mass or less to the radical polymerization monomer having three functionalities. Furthermore, when a great many amount of the radical polymerizable compounds having two or more functionalities and a charge transporting structure are contained, bulky structures are attached in the crosslink structure by plural sites, resulting to generate distortion and to tend an aggregation of small cured products. This may be a cause of solubility to the organic solvent.

Depending on the chemical structures, the content of the radical polymerizable compound having two or more functionalities and the charge transporting structure is preferably 10% by mass or less to the radical polymerizable compound having one functionality and a charge transporting structure. Further, the charge generating layer, the charge transporting layer, and the crosslinked charge transporting layer are laminated in this order, an uppermost surface of the crosslinked charge transporting layer is insoluble to the organic solvent is preferable to attein wear resistance and scratch resistance. In the constitution of the present invention, in order to make the crosslinked charge transporting layer insoluble to the organic solvent is; (1) adjustment of compositions of the coating liquid for the crosslinked charge transporting layer and proportion thereof, (2) adjustment of a diluent solvent for coating liquid for the crosslinked charge transporting layer and density of solid content, (3) choice of a coating process of the crosslinked charge transporting layer, (4) control of the curing conditions of the crosslinked charge transporting layer, and (5) lowering solubility of a under layer to the charge transporting layer. It is important to control them but this will not be always achieved with one factor.

When the diluent solvent for the coating liquid for the crosslinked charge transporting layer uses a solvent with slow evaporation rate, the residual solvent becomes impeditive to the curing; increasing an inclusion amount of the components of the under layer; thereby causing nonuniform curing and lowering curing density. Thus, the organic solvent tends to soluble. Specifically, tetrahydrofuran, mixed solvent of tetrahydrofuran and methanol, ethyl acetate, methylethylketon, ethylcellosolve are useful but is selected together with a coating process. When the density of the solid content is too low as in the same reason, it tends to soluble to the organic solvent. Contrary, from the limitations of thickness and viscosity of the coating liquid, an upper limit of the density is restricted. Specifically, it is preferable 10% by mass to 50% by mass. A coating process of the crosslinked charge transporting layer is preferable, as in the same reason, that decreases the solvent content and a contacting time with the solvent when forming the coating film. Specific examples are a spray coating process, a ring coat process restricting an amount of the coating liquid. Further, to suppress the inclusion of the components of the under layer, it is effective to use the charge transport polymers as a charge transporting layer and to provide an intermediate layer which is insoluble to the coating solvent of the crosslinked charge transporting layer.

Regarding the curing condition of the crosslinked charge transporting layer, when heat or optical energy is low, the curing does not sufficiently complete. Conversely, when very high energy is applied for curing, the curing reaction becomes nonuniform and it is likely that uncompleted crosslinking portion and radical stopped portion increase, or minute cured products easily form an aggregation. Thus, it becomes soluble to the organic solvents. For making insoluble to the organic solvents, the heat curing conditions are preferably at 100° C. to 170° C., and for 10 minutes to 3 hours. The curing conditions of the UV irradiations are preferable; 50 mW/cm² to 1000 mW/cm², 5 seconds to 5 minutes, a rise of temperature is controlled to 50° C. or lower, and suppressing the nonuniform curing reaction.

A process for insolublizing the crosslinked charge transporting layer to the organic solvent is exemplified. As a coating liquid, when an acrylate monomer having three acryloyloxy groups and a triaryl amine compound having one acryloyloxy group are utilized, a ratio is 7:3 to 3:7. A photopolymerization initiator is added in an amount of 3% by mass to 20% by mass based on the total amount of the acrylate compound, and further a solvent is added to prepare a coating liquid. For example, when triaryl amine donor is utilized as the charge transport substance and polycarbonate is utilized as the binder resin, and the surface layer is coated by spraying process, the solvent of the coating liquid is preferably tetrahydrofuran, 2-butane, or ethyl acetate, and the amount of the solvent is 3 to 10 times based on the entire acrylate compound.

Then, for example, the photoconductor on which an undercoat layer, the charge generating layer, and the charge transporting layer are laminated sequentially on the support of aluminum cylinder, and the like, then the coating liquid prepared as mentioned above is coated by spraying, and the like. Then, the coating is subjected to drying naturally or drying at comparatively lower temperatures for short period of time (25° C. to 85° C. for 1 minute to 10 minutes), thereafter is cured by UV irradiation or heating.

In the UV irradiation, a metal halide lamp etc. is preferably used preferably at an irradiated energy of 50 mW/cm² or more and 1,000 mW/cm² or less. For example, when the UV irradiation is applied at 200 mW/cm², the irradiation is preferably performed uniformly on the drum in circumferential direction from many lamps for about 30 seconds in case of curing. The temperature of the drum is to be controlled so as not to exceed 50° C.

When cured through thermal polymerization, the heating temperature is preferably 100° C. to 170° C. For example, when an air type oven is used as the heater and the heating temperature is set to 150° C., the heating time is preferably about 20 minutes to 3 hours.

After completing the curing, it is heated further at 100° C. to 150° C. for 10 minutes to 30 minutes for decreasing the residual solvents to obtain the electrophotographic photoconductor.

The objects can be achieved by using the electrophotographic photoconductor. The following factors are exemplified as the grounds thereof.

The electrophotographic photoconductor is used in an environment in which successive processes of the charging unit, the developing unit, the transferring unit, the cleaning unit and the charge eliminating unit are repeated. During the processes, the photoconductor wears and scratches occur, thereby image deterioration is induced to finish its life. The wear and scratches may caused by the following factors. Examples include:
(1) Decomposition of the surface compositions of the photoconductor by discharging when charging and charge-eliminating, and chemical deterioration by oxidizing gas,
(2) Carrier adhesion to the photoconductor when developing,
(3) Friction between the photoconductor and a paper when transferring,
(4) Friction between the photoconductor and a cleaning brush or a cleaning blade when cleaning and the toner or the carrier adhesion therebetween.

To design the photoconductor which is strong in these factors, it is important that the surface layer has higher hardness, higher elasticity and uniformity. A forming process of a thee-dimensional network structure with density and homogeneity is effective for a film structure. A surface of the crosslinked charge transporting layer develops the three network structure because of having the crosslinked structure by cured the radical polymerizable monomer having three or more functionalities, the crosslink density is remarkably high, and the surface layer has high elasticity, thereby to attain high wear resistance and high scratch resistance.

It is important to increase the crosslink density, i.e., a crosslinking number per volume unit of the photoconductor surface of the photoconductor. However, the internal stress occurs by volume shrinkage because plural crosslinkings are formed instantaneously in the curing reaction. The thicker the crosslinked layer is, the internal stress increases, and when the entire charge transporting layer is cured, the cracks and film peeling tends to occur. When this phenomenon does not appear at the earlier stage, but repeated uses in the electrophotographic processes, factors such as charging, developing, transferring, cleaning and under the influences of thermal changes, this phenomenon may easily appear over time.

Processes to solve these problems include, (1) polymer components are introduced in a crosslinked layer and a crosslinked structure, (2) use a plenty amount of radical polymerizable monomer with one functionality and two functionalities, (3) use a multi-functional monomer having a flexibility group, to soften the curing resin layer. However, in each of the above processes, there are problems that the crosslinked density in the crosslinked layer becomes low and the significant wear resistance can not be attained.

Contrary, by providing the crosslinked charge transporting layer with a thickness of 1 μm to 10 μm on the charge transporting layer which has developed the three-dimensional network structure and has high crosslink density, the photoconductor in which the cracks or film peeling do not occur but significantly high wear resistance is attained. By providing the thickness of 2 μm to 8 μm to the crosslinked charge transporting layer, material selections for high crosslink density which are related to improvement of the wear resistance can be made in addition to improving allowability to the problems.

The grounds that the photoconductor can suppress the cracks and film peeling are that the crosslinked charge transporting layer can be made into a membrane, thereby the internal stress does not increase; the internal stress of the surface of the crosslinked charge transporting layer can be eased for having the charge transporting layer to the under layer, and the like. Therefore, a plenty amount of polymer materials are not necessary to incorporate into the crosslinked charge transporting layer, and the scratches and toner filming are not likely occurred due to imcompatibility to the cured product produced by the reaction of the polymer materials and the radical polymerizable compositions (a radical polymerizable monomer or a radical polymerizable compound having a charge transporting structure). Further, when the thickness of the whole charge transporting layer is cured by irradiation of the optical energy, light transmission to the interior is restricted due to the absorption in the charge transporting layer, and there may be a phenomenon that the curing reaction does not sufficiently progress.

In the crosslinked charge transporting layer, the curing reaction progresses uniformly in the interior of the thin film of 10 μm or less and the high wear resistance is maintained in the interior as well as in the surface. Further, in the preparation of the uppermost surface layer, the radical polymerizable compound having one functionality and a charge transport structure and exists as well as the radical polymerizable monomer having three or more functionalities and no charge transport structure, the radical polymerizable compound having one functionality and a charge transport structure is incorporated into the crosslinked structure yield when the radical polymerizable monomer having three or more functionalities is cured and no charge transport structure. On the contrary, when charge transport substances having a lower molecular mass and no functionality are incorporated into the crosslinked charge transporting layer, the charge transport substances having a lower molecular mass typically undergo deposition, whiting, or opacity due to their lower compatibility within the crosslinked structure, and the mechanical strength of the resulting crosslinked charge transporting layer may be lowered. Further, when the crosslinked charge transporting layer contains mainly radical polymerizable compounds having two or more functionalities, the radical polymerizable compounds can attach to the crosslinked structure by plural bonds and thus the crosslink density becomes higher; however, the charge transport structure is typically very bulky, thus strain of the cured resin structure becomes very large, which causes internal stress are likely to be significant within the crosslinked charge transporting layer.

In accordance with the present invention, the photoconductors can maintain appropriate electric properties, thus higher image quality may be achieved for prolonged period. The reason is that the radical polymerizable compound having one functionality and a charge transport structure, bonds to the crosslinked structure in a condition of pendent groups.

On the contrary, charge transport substances having no functionality tend to bring about deposition, whiting, or opacity as described above, and resulting in significant drop of sensitivity and rise of residual potential under repeated uses. Further, radical polymerizable compounds having two or more functionalities and a charge transport structure can attach to the crosslinked structure by plural bonds respectively, therefore, the intermediate structure of (radical cation) is not stable during charge transportation, and drop of sensitivity and rise of residual potential may be induced due to charge trap. The degradation of electric properties may bring about image defects such as decrease of image density and thinning of letters. Further, in the photoconductor, the under layer of the charge transporting layer can be applied a high mobility design with less charge trap, thereby to suppress mechanical side-effects of the crosslinked charge transporting layer.

The crosslinked charge transporting layer is formed by curing the radical polymerizable monomer having three or more functionalities and no charge transport structure and the radical polymerizable compound having one functionality and a charge transport structure, and the entire layer has a high crosslink density developed the three-dimensional network structure. However, other components other than the components mentioned above (for example, a monomer with one or two functionalities, a polymer binder, an anti-oxidants, a leveling agent, a plasticizer such as additive and dissolved inclusion components from the under layer) and the curing conditions, the crosslink density locally is lowered and highly-densed crosslinked small cured products may be formed as an aggregation. Such crosslinked charge transporting layer has low bonding force between the cured products, exhibits solubility to the organic solvent. And local wear and detachment of a small cured product easily occur during repeated uses in the electrophotographic processes. According to the present invention, since the crosslinked charge transporting layer is insoluble to the organic solvent, the significant wear resistance is attained, due to the chain reaction progresses in a wide rage and the cured product is polymerized, in addition to the three-dimensional network structure is developed and high crosslinking is attained.

<Example of Synthesizing Compound Having One Functionality and a Charge Transporting Structure>

The compounds having one functionality and a charge transporting structure may be synthesized, for example, by the process described in Japanese Patent No. 3164426. An example is as follows:

(1) Synthesis of Hydroxy Group-Substituted Triarylamine Compound (in the Following Formula B)

To 240 ml of sulfolane, 113.85 g (0.3 mol) of methoxy group-substituted triarylamine compound (in the following Formula A) and 138 g (0.92 mol) of sodium iodide are added and heated to 60° C. while flowing nitrogen gas. In the solution, 99 g (0.91 mol) of trimethylchlorosilane is dropwisely added for 1 hour and stirred at about 60° C. for 4.5 hours, and the reaction was completed. About 1.5 L of toluene was added to the reactant, then the reaction product was cooled to room temperature and repeatedly rinsed with water and an aqueous sodium carbonate solution. Then, the solvent was removed from the solution and the residue was purified by means of a column chromatography (adsorption medium: silica gel, developing solvent: toluene/ethyl acetate=20:1). The obtained light yellow oil was crystallized with adding cyclohexane. Consequently, 88.1 grams of white crystal expressed by Formula B having a melting point of 64.0° C. to 66.0° C. was obtained in the yield of 80.4%.

TABLE 1

| | C | H | N |
|---|---|---|---|
| Measured (%) | 85.06 | 6.41 | 3.73 |
| Calculated (%) | 85.44 | 6.34 | 3.83 |

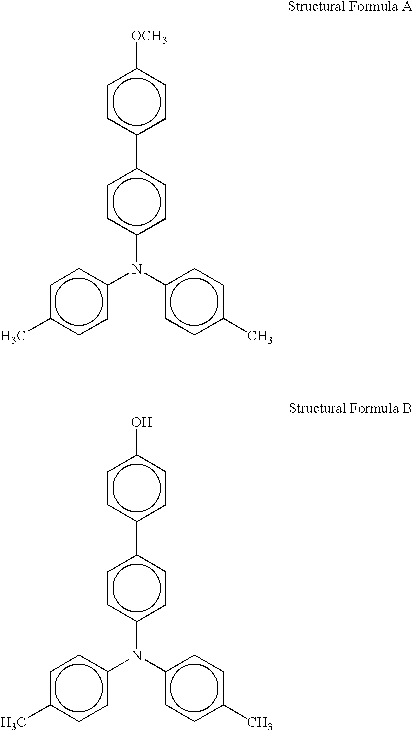 (2) Synthesize of Triarylamino Group-Substituted Acrylate Compound (Compound No. 54)

The hydroxy group-substituted triarylamine compound expresses by Formula B of 82.9 g (0.227 mol) obtained in above (1) was dissolved in 400 g of tetrahydrofuran, and an aqueous sodium hydroxide solution, containing 12.4 g of NaOH and 100 g of water, was dropwisely added thereto. The resulting solution was cooled to 5° C. and 25.2 g (0.272 mol) of acrylic acid chloride was added thereto over 40 minutes. Then, the reactant was stirred at 5° C. for 3 hours and the reaction was completed. The reaction product was poured into water and was extracted with toluene. The extract was repeatedly rinsed with an aqueous sodium bicarbonate solution and water. The solvent was removed from the solution and the residue was purified by means of a column chromatography (adsorption medium: silica gel, developing solvent: toluene). The resulting colorless oil was crystallized within n-hexane. Consequently, 80.73 g of white crystal of the compound No. 54 having a melting point of 117.5° C. to 119.0° C. was obtained with the yield of 84.8%.

TABLE 2

| | C | H | N |
|---|---|---|---|
| Measured (%) | 83.13 | 6.01 | 3.16 |
| Calculated (%) | 83.02 | 6 | 3.33 |

<Example of Synthesizing Compound Having Two Functionalities and a Charge Transporting Structure>

The compound, dihydroxymethyltriphenilamine, having two functionalities and a charge transporting structure according to the present invention can be produced in a known manner. 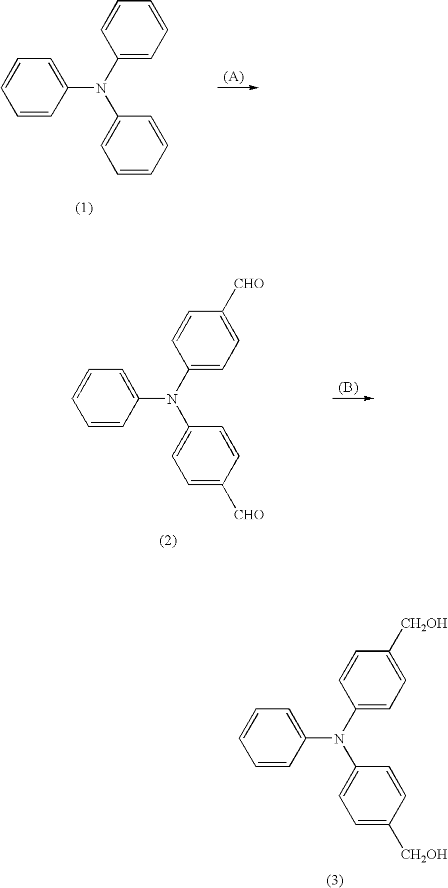
Step A

In a flask equipped with a thermometer, a cooling tube, and a stirrer, a dropping funnel, 49 g of the compound (1) and 184 g of a phosphorous oxychloride were placed, and dissolved by heating. 117 g of dimethylformamide was gradually dropped by the dropping funnel to maintain the reaction liquid at 85° C. to 95° C. and stirred about 15 hours. Then, after the reaction liquid was poured gradually to an excessive warm water, and was slowly cooled while stirring. After the deposited crystal was filtered and dried, the compound (2) was obtained by purified by means of impurities absorption by a silica gel and recrystallization by an acetonitrile. The yield was 30 g.

Step B

30 g of the compound (2) and 100 ml of ethanol were placed in a flask to stir. After 1.9 g of a sodium borohydride was added gradually, the liquid temperature was maintained at 40° C. to 60° C. and stirred for about two hours. The reaction liquid was poured gradually into 300 ml of water and stirred to deposit a crystal. After filtered, the compound (3) was obtained by washed sufficiently and dried. The yield was 30 g.

<Intermediate layer>

In the photoconductor according to the present invention, an intermediate layer between the charge transporting layer and the crosslinked charge transporting layer may be provided to inhibit inclusion of the under layer components into the crosslinked charge transporting layer or to improve the adhesion with the under layer. Thus, the intermediate layer is suitable to have insolubility or poor solubility to the coating liquid for the crosslinked charge transporting layer. Generally, a binder resin is typically employed as the main component of the intermediate layer. Examples of these resins are polyamides, alcohol-soluble nylon, water-soluble polyvinyl butyral, polyvinyl butyral, polyvinyl alcohol, and the like.

Conventional coating processes may be carried out in order to form the intermediate layer, as described above. The thickness of the intermediate layer is preferably 0.05 μm to 2 μm.

<Undercoat Layer>

In the photoconductor of the present invention, an undercoat layer may be provided between a support and the photoconductive layer. The undercoat layer is typically formed of resins. The resins are preferably high solvent-resistant against common organic solvents since the photoconductive layer containing an organic solvent is usually coated on the undercoat layer.

Examples of the resin include water-soluble resins such as polyvinyl alcohol, casein, sodium polyacrylate, alcohol-soluble resins such as copolymer nylon and methoxymethylated nylon, and curing resins which form a three-dimensional network such as polyurethane, melamine resins, phenol resins, alkyd-melamine resins, and epoxy resins. Also, metal oxide fine powder pigments such as titanium oxide, silica, alumina, zirconium oxide, tin oxide or indium oxide may be added to the undercoat layer to prevent Moire patterns, and to reduce residual potential.

These undercoat layer may be formed using a suitable solvent and by way of a coating process as described in terms of the charge transporting layer. A silane coupling agent, titanium coupling agent or chromium coupling agent, etc. can be used as the undercoat layer of the present invention. Also, Al₂O₃ prepared by anodic oxidation, organic substances such as polyparaxylylene (parylene) and inorganic substances such as SiO₂, SnO₂, TiO₂, ITO, CeO₂ prepared by the vacuum thin film-forming process, can be used for the undercoat layer. Other known substances may be used. The thickness of the undercoat layer is preferably 0 μm to 5 μm.

In the present invention, anti-oxidants may be incorporated into the respective layers of the crosslinked charge transporting layer, the charge transporting layer, the charge generating layer, the undercoat layer, and the intermediate layer etc. in order to improve the environmental resistance, in particular to prevent the sensitivity decrease and the residual potential increase.

The anti-oxidant may be exemplified as follows.

Phenol compounds such as 2,6-di-t-butyl-p-cresol, butylhydroxyanisole, 2,6-di-t-butyl-4-ethylphenol, stearyl-β-(3,5-di-t-butyl-4-hydroxyphenyl)propionate, 2,2′-methylene-bis-(4-methyl-6-t-butylphenol), 2,2′-methylene-bis-(4-ethyl-6-t-butylphenol), 4,4′-thiobis-(3-methyl-6-t)-butylphenol, 4,4′-butylydenebis-(3-methyl-6-t-butylphenol), 1,1,3-tris-(2-methyl-4-hydroxy 5-t-butylphenyl)butane, 1,3,5-trimethyl-2,4,6-tris-(3,5-di-t-butyl-4-hydroxybenzyl)benzene, tetrakis-[methylene 3-(3′,5′-di-t-butyl-4′-hydroxy-phenyl)propionate]methane, bis-[3,3′-bis-(4′-hydroxy-3′-t-butylphenyl)butylic acid]glycolester, tocopherols, and the like.

Paraphenylene diamine compounds such as N-phenyl-N′-isopropyl-p-phenylene diamine, N,N′-di-sec-butyl-p-phenylene diamine, N-phenyl-N-sec-butyl-p-phenylene diamine, N,N′-di-isopropyl-p-phenylene diamine, N,N′-dimethyl-N,N′-di-t-butyl-p-phenylene diamine, and the like.

Hydroquinone compounds such as 2,5-di-t-octyl hydroquinone, 2,6-di-dodecyl hydroquinone, 2-dodecyl hydroquinone, 2-dodecyl 5-chlorohydroquinone, 2-t-octyl 5-methyl hydroquinone, 2-(2-octadecenyl)-5-methyl hydroquinone, and the like.

Organosulfur compounds such as dilauril-3,3′-thiodipropionate, distearil-3,3′-thiodipropionate, tetradecyl-3,3′-thiodipropionate, and the like.

Organophosphorus compounds such as
triphenyl phosphine, tri(nonylphenyl)phosphine, tri(di-nonyl phenyl) phosphine, tri-cresil phosphine, tri(2,4-dibutyl phenoxy)phosphine, and the like.

These compounds are known as the anti-oxidants of rubber, plastic, fatty oil, and are commercially available.

The content of the anti-oxidant is preferably 0.01% by mass to 10% by mass based on the total mass of the layer to be incorporated.

The photoconductors (electrophotographic conductors) according to the present invention can be applied to electrophotographic devices such as copiers, laser printers, LED printer, and liquid crystal shutter printers and further can be widely applied to devices such as a display or a recording, near prints, engravings, facsimiles, and the like.

The latent electrostatic image may be formed, for example, by uniformly charging the surface of the photoconductor, and exposing it imagewise, which may be performed by the latent electrostatic image forming unit.

The latent electrostatic image forming unit, for example, comprises a charger which uniformly charges the surface of the photoconductor, and an exposing unit which exposes the surface of the latent image carrier imagewise.

The charging step may be performed, for example, by applying a voltage to the surface of the photoconductor using the charger.

The charger may be properly selected depending on the application, for example, contact chargers known in the art such as a conductive or semi-conductive roller, brush, film or rubber blade, and non-contact chargers using corona discharge such as corotron and scorotron are exemplified.

The exposing step may be performed by exposing the surface of the photoconductor imagewise, using the exposing unit, for example.

The exposing unit is may be properly selected depending on the application as long as capable of exposing imagewise to be formed on the surface of the photoconductor charged by the charger, for example, a various exposing unit such as copy optical system, rod lens array system, laser optical system, and liquid crystal shutter optical system may be exemplified.

In addition, in the present invention, a backlight system may be employed by which the photoconductor is exposed imagewise from its back surface.

Further, when an image forming apparatus is used as a facsimile or a copier, the image exposing is made by irradiating the reflected light or the transmitted light from manuscripts to the photoconductor, or the manuscripts are read by a sensor and converted into signals and in accordance with the signals, scanning by a laser beam, driving a LED array, or driving a crystal shutter array to irradiate the lights on the photoconductor, and the like.

Developing Step and Developing Unit

The developing step is one that develops a latent electrostatic image using the toner or the developer to form a visible image.

The visible image may be formed, for example, by developing the latent electrostatic image using the toner or developer, which may be performed by the developing unit.

The developing unit may be properly selected as long as capable of developing an image for example by using the toner or developer. Examples are those which comprise a developer housing wherein the toner or the developer is contained and which may supply the toner or the developer with contact or without contact to the latent electrostatic image.

<Toner>

The toner used in the present invention comprises a colorant, fine particles, a charge controlling agent, and a releasing agent are added in a binder resin in which a thermoplastic resin is a main component. Conventional toners may be used. The toner may be amorphous or spherical toner prepared by various toner processes such as a polymerization process or a granulation process. Any of a magnetic toner or a non-magnetic toner may be used.

Binder resins for the toner include such as, polymers of styrene and substituted styrenes such as polystyrene, polyvinyltoluenes, and the like; styrenic copolymers such as styrene-p-chlorostyrene copolymers, styrene-propylene copolymers, styrene-vinyltoluene copolymers, styrene-methyl acrylate copolymers, styrene-ethyl acrylate copolymers, styrene-butyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ether copolymers, styrene-vinyl methyl ketone copolymers, styrene-butadiene copolymers, styrene-isoprene copolymers, styrene-maleic acid copolymers, styrene-maleic ester copolymers, and the like; acrylic binders such as polymethyl methacrylate, polybutyl methacrylate; and others such as polyvinyl chloride, polyvinyl acetate, polyethylene, polypropylene, polyester, polyurethane, epoxy resin, polyvinyl butyral, polyacrylic acid resin, rosin, modified rosin, terpene resin, phenol resin, aliphatic or an alicyclic hydrocarbon resins, an aromatic petroleum resin, chlorinated paraffins, paraffin wax, and the like.

Each of these resins can be used either alone or in combination.

Further, the polyester resins, compared to the styrene or acrylic resins, can lower the melting viscosity while maintaining stability when the toner is stored. For example, such polyester resins can be obtained by polycondensation reaction with an alcohol and a carboxylic acid.

Such alcohols include polyethylene glycol, diethylene glycols, triethylene glycol, 1,2-propylene glycol, 1,3-propylene glycol, 1,4-propylene glycol, neopentyl glycol, diols such as 1-4 butendiol, etherified bisphenols such as 1,4-bis(hydroxymethyl) cyclohexane, bisphenol A, hydrogenated bisphenol A, polyoxyethylenated bisphenol A, polyoxypropylenated bisphenol A, dihydric alcohol substituted with a saturated or unsaturated hydrocarbon group having a carbon number of 3 to 22, other dihydric alcohol, trihydric or more alcohol such as sorbitol, 1,2,3,6-hexanetetrol, 1,4-sorbitan, pentaerysritol dipentaerythritol, tripentaerythritol, sucrose, 1,2,4-butanetriol, 1,2,5-pentanetriol, glycerol, 2-methyl propanetriol, 2-methyl-1,2,4-butanetriol, trimethylol ethane, trimethylol propane, 1,3,5-trihydroxymethylbenzene, and the like.

Further, the carboxylic acid used to obtain the polyester resins are, for example, monocarboxylic acid such as palmitic acid, stearic acid, oleic acid, etc., maleic acid, fumaric acid, mesaconic acid, citraconic acid, terephthalic acid, cyclohexanedicarboxylic acid, succinic acid, adipic acid, sebacic acid, malonic acid, dihydric organic acid monomer substituted by saturated or unsaturated carbonhydride group having a carbon number of 3 to 22, acid anhydrides thereof, a dimer from lower alkyl ester and linolenic acid, 1,2,4-benzenetricarboxylic acid, 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, tetra(methylenecarboxyl)methane, 1,2,7,8-octanetetracarboxylic acid empol trimer acid, and polycarboxylic acid monomer with trivalent or more such as anhydrides thereof.

The epoxy resins include a polycondensation product of bisphenol A and epochlorohydrin, and the like. Examples of the commercially available products include Epomix R362, R364, R365, R366, R367, R369 (manufactured by Mitsui Petrochemical Industries, Ltd.), Epotot YD-011, YD-012, YD-014, YD-904, YD-017 (manufactured by Toto Kasei K. K.), Epocoat 1002, 1004, 1007 (manufactured by Shell Chemicals, Inc.), and the like.

Any conventional dyes and pigments can be used as the colorant. Examples of dyes and pigments include carbon black, lamp black, black iron oxide, Ultramarine Blue, nigrosine dyes, Aniline Blue, Phthalocyanine Blue, Hansa Yellow G, Rhodamine 6G, lake, chalco oil blue, Chrome Yellow, quinacridone, Benzidine Yellow, Rose Bengal, triarylmethane dyes, monoazo and disazo dyes and pigments, and the like.

Further, it is possible that a magnetic material may be contained in the toner to form a magnetic toner. Examples of magnetic materials include ferromagnetic metals such as iron, cobalt, and the like, and fine particles of magnetite, hematite, Li ferrite, Mn—Zn ferrite, Cu—Zn ferrite, Ni—Zn ferrite and Ba ferrite, and the like.

In order to control the frictional charge of the toner, i.e., a charge control agent such as monoazo dyes of metal complex salt, nitrohumic acid and its salt, salicylic acid, naphthoic acid, metal complex amino compounds such as Co, Cr, Fe of dicarboxylic acid, quaternary ammonium compound and organic dyes can be contained. Further, the toner of the present invention may be added a releasing agent upon necessity. Examples of the releasing agent materials include low molecular mass polypropylene, low molecular mass polyethylene, carnauba wax, microcrystalline wax, jojoba wax, rice wax, montanic acid wax, etc., which can be used alone or in combination but are not limited thereto.

The additives can be added in the toner. It is important that a sufficient fluidity is given to the toner so as to obtain the good images. For this purpose, such as fine particles of hydrophobized metallic oxide as a fluidity improving material, or fine particles such as a lubricant are externally added, and metallic oxides, organic resin fine particles, metal soaps can be used as additives. Specific examples of the additives include Teflon™, a lubricant such as zinc sterate, abrasives such as ceric oxide, silicon carbide; the fluidity giving agent such as inorganic oxides of SiO₂, TiO₂ on which surfaces are hydrophobized; know caking inhibitor, and such surface treating products. To improve the toner fluidity, hydrophobic silica is preferably used.

A mass average particle diameter (Dt) of the toner is preferably 4.0 μm to 9.0 μm and is more preferably 4.5 μm to 7.5 μm.

An average circularity is a value obtained by dividing a circumference length of an equivalent circle which equals a project area of the toner shape with a circumference length of an actual particle. For example, it is preferably 0.900 to 0.98 and is more preferably 0.940 to 0.98.

The average circularity is, for example, can be measured by an optical detecting belt process that a suspension including the toner is transmitted onto a plate-like imaging detecting belt, the particle images were detected and analyzed optically with a CCD camera. For example, it is measured by a particle image analyzing device of flow type FPIA-2100 (manufactured by Sysmecs, Co.)

<Carrier>

The carrier comprises core particles having magnetism and a coating layer to coat the surface thereof.

The mass average particle diameter Dw of the carrier is within 25 μm to 45 μm and is preferably 30 μm to 45 μm. When the mass average particle diameter Dw exceeds the above range, the carrier adhesion is not easily occurred. But, the toner density is made higher in order to obtain the higher image density, the background smear increases rapidly. In addition, when the dot diameter of the latent image is small, variations of the dot reproducibility is large and bristle marks easily occur. The carrier adhesion shows that the carrier is adhered to the image unit or the background unit of the latent electrostatic image. When the each electric field is stronger, the carrier tends to be adhered easily. For the field of the image portion is weakened by developing the toner, the carrier adhesion does not easily occur compared to the background portion. The carrier adhesion is not preferable because it brings inconveniences such as scratches to the photoconductor drum or the fixing rollers.

In the carrier, the content of particles having a particle diameter of smaller than 44 μm is 70% by mass or more and is more preferably 75% by mass or more. The content of particles having a particle diameter of smaller than 22 μm is 7% by mass or less, and is more preferably 3% by mass or less. A ratio Dw/Dp of the mass average particle diameter Dw to the number average particle diameter Dp is 1 to 1.30 and is preferably 1 to 1.25. In the carrier having a small particle diameter, the majority of the carriers in the carrier adhesion are fine particles having a diameter of less than 22 μm.

In the mass average particle diameter Dw of the carrier having a small particle diameter of 25 μm to 45 μm, the carrier adhesion is evaluated by changing a mass ratio of the particle diameter of 22 μm or less. It is found that when the content of particles having the particle diameter of less than 22 μm is 7% by mass or less, there is no problem. Further, when the content of the particles having the particle diameter of less than 44 μm is 70% by mass or more and the ratio of Dw/Dp is 1 to 1.30. In other words, it is found that when the carrier distribution is sharp, the dot variation is small and the carrier with good reproducibility in highlight can be obtained. In such case, it is also found that there are problems relating to the carrier adhesion and high image density can be obtained. The reason that the dot variation becomes large when the particle distribution is wide is considered that the carrier having a big particle diameter inhibits the dot reproducibility. When the content of the particles having the particle diameter of less than 22 μm is 3% by mass or less, the carrier adhesion does not easily occur further.

In the present application, the mass average particle diameter Dw with respect to the carrier, the carrier core and the toner is calculated based on the particle distribution of the particle measured base on a number. The mass average particle diameter Dw is expressed by the following equation.
Dw={1/Σ(nD³)}×{Σ(nD⁴)}

In the above equation, D indicates a representative particle diameter (μm) of a particle existing in each channel, and “n” indicates a total number of particles existing in each channel. The “channel” refers to a length for dividing the range of the particle diameter equally in the particle diameter distribution map. In the present invention, 2 μm is employed. The lower limit value of the particle diameter of the particles stored in the channel is employed as the representative particle diameter of a particle existing in each channel.

In the present application, the number average particle diameter Dp with respect to the carrier and the carrier core particle is calculated based on the particle diameter distribution of the particles measured based on a number. The number average particle diameter Dp is expressed by the following equation.
Dp=(1/N)×{ΣnD}

In the above equation, N indicates entire particle numbers measured, “n” indicates a total number of particles existing in the each channel and D indicates a lower limit value of the particle diameter of the particles existing in each channel (2 μm).

As to a particle analyzer for measuring a particle diameter distribution, Microtrack particle analyzer (Model HRA9320-X100, manufactured by Honeywell) was used. The measuring conditions are as follows:
(1) Range of particle diameter range: 100 μm to 8 μm
(2) Channel length (channel width): 2 μm
(3) Number of channels: 46

The carrier can be obtained such that the magnetic materials are grounded, the grounded particles were classified in order to obtain a predetermined particle diameter, and a resin coating film is formed on the surface of the core particles obtained by the classification. The classification includes air classification, sieve classification (sieving), and the like. In producing carrier core particles, a vibration sieve device is preferably used but when the particles having a small particle diameter are classified with the conventional generally used vibration sieve device, there is inconvenience in that a small mesh of the sieve device (a wire mesh) is clogged. Thus, the workability of classification is very bad.

Various considerations have been made to develop processes for effectively and sharply cut the particles having a small diameter, and found that the particles having a small particle diameter of less than 22 μm can be effectively and shapely cut, when the particles are classified by the sieving device, by giving an ultrasonic vibration to the wire mesh.

The ultrasonic vibration for vibrating the wire mesh can be made by supplying high frequency electric current to a converter thereby to convert it to the ultrasonic vibration. The converter is constituted of PZT oscillators. To vibrate the wire mesh by the ultrasonic vibration, the ultrasonic vibration generated from the converter is transmitted to resonance members fixed to the wire mesh. The resonance members received the ultrasonic vibration resonate by the ultrasonic vibration and the wire mesh fixed by the resonance members are vibrated. The frequency to vibrate the wire mesh is preferably 20 kHz to 50 kHz and is more preferably 30 kHz to 40 kHz. The configuration of the resonance members may be suitable for vibrating the wire mesh and is generally a ring. A vibrating direction to vibrate the wire mesh is preferably in a vertical direction.

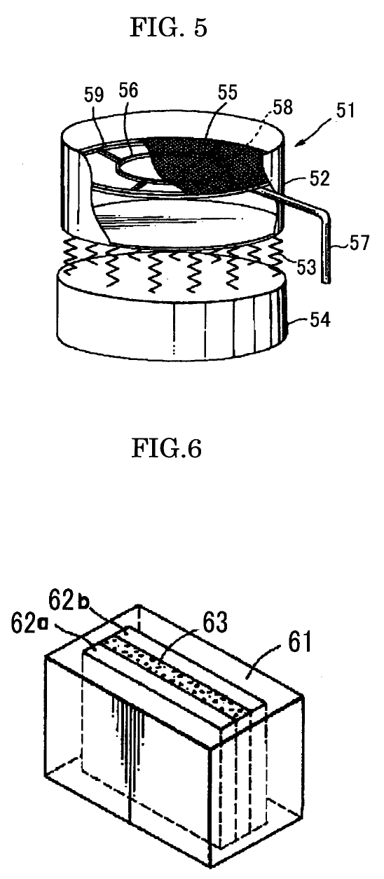

FIG. 5 shows an explanatory structure of a vibration sieve device with an ultrasonic oscillator.

In FIG. 5, 51 denotes a vibration sieve device, 52 denotes a cylindrical container, 53 denotes a spring, 54 denotes a base (support base), 55 denotes a wire mesh, 56 denotes a resonance ring, 57 denotes a high frequency electric current cable, 58 denotes a converter, and 59 denotes a ring shaped flame. To operate the vibration sieve device with an ultrasonic oscillator (a circular sieve device) shown in FIG. 5, the high frequency current is supplied to the converter 58 through the cable 57. The high frequency current supplied to the converter 58 is converted to the ultrasonic-vibration. The ultrasonic vibration generated by the converter 58 makes vibrate vertically the resonance ring 56 in which the converter 58 is fixed and the ring-shaped flame 59 connected therewith. By the vibration of the resonance ring 56, the wire mesh 55 fixed to the resonance ring 56 and the flame 59 vibrates vertically. Such vibration sieve device with an ultrasonic oscillator is sold and, for example, a product name “Ultrasonic” manufactured by Koei Sangyo K.K. is commercially available.

The carrier is also produced by forming a resin coating film on the surface of grind particles of the magnetic materials and then the resin coating particles are classified. In this case, the classification of the resin coating particles is preferably made with the vibration sieve device with an ultrasonic oscillator.

For the core particle materials constituting the carrier, conventional various magnetic materials are used. In the carrier core particle used in the present invention, when a magnetic field of 1,000 oersted (Oe) is applied, the magnetic moment is preferably 60 emu/g or more and is more preferably 75 emu/g or more. The upper limit is not limited, but generally, it is approximately 150 emu/g. When the magnetic moment of the carrier core particle is smaller than the above range, it is not preferable because the carrier adhesion easily occurs.

Here, the magnetic moment can be measured as follows. A B-H tracer (BHU-60, manufactured by Riken Denshi K.K.) is used in which carrier core particles 1.0 g is filled in a cylinder cell and set to the device. The magnetic field is gradually changed larger to 3,000 oersted and then gradually changed lower to 0. Then, the magnetic field in an opposite orientation is gradually changed to 3,000 oersted. Further, after gradually changed lower to 0, the magnetic field is applied to the same direction as that of the beginning. Thus, a B=H curve is illustrated and the magnetic moment of 1,000 oersted is calculated in accordance with the illustration.

Examples of the core particles in which the magnetic moment is 60 emu/g or more when the magnetic filed of 1,000 oersted is applied are ferromagnetic materials such as iron, cobalt, etc. and magnetite, hematite, Li ferrite, Mn—Zn ferrite, Cu—Zn ferrite, Ni—Zn ferrite and Ba ferrite, Mn ferrite, etc. In this case, the ferrite is a sintered body expressed by the following formula.
(MO)x(NO)y(Fe₂O₃)z

In the formula, x+y+z=100 mol %, each M, N is a metallic atom such as Ni, Cu, Zn, Li, Mg, Mn, Sr, Ca, etc. and is composed of a perfect mixture of a bivalent metallic oxide and a trivalent iron oxide. Examples of the core particle in which the magnetic moment is 75 emu/g or more when the magnetic filed of 1,000 oersted is applied are magnetic particles such as iron, magnetite, Mn—Mg ferrite, Mn-ferrite, and the like.

The carrier is produced by forming a coating layer on the surface of the core particles. Resins for forming the coating layer can be used various known resins as those used when producing the carrier. According to the present invention, the resin is preferably a silicone resin including the repeated unit which is expressed by the following formulas.

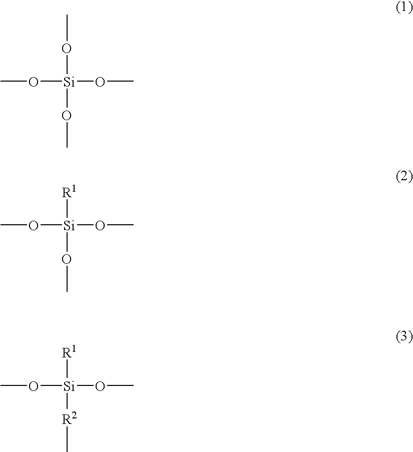

In the formulas, R₁ represents a hydrogen atom, a halogen atom, a hydroxyl group, an methoxy group, a lower alkyl group having a carbon number of 1 to 4, or an aryl group such as a phenyl group, a tolyl group, and the like, and R₂ represents an alkylene group having a carbon number of 1 to 4 or an arylene group such as a phenylen group, and the like.

In the present invention, straight silicone resins can be used. Examples thereof include KR271, KR272, KR282, KR252, KR255, KR152 (manufactured by Shin-Etsu Chemical Co., Ltd.), SR2400, SR2406 (manufactured by Toray Dow Corning Silicone Inc.), and the like.

Modified silicone resins can be used in the present invention. Examples thereof include an epoxy modified silicone, an acryl modified silicone, a phenol modified silicone, an urethane modified silicone, a polyester modified silicone, an alkyd modified silicone, and the like.

Specific examples of the modified silicones include an epoxy modified product: ES-1001N, an acryl modified silicone: KR-5208, a polyester modified product: KR-5203, an alkyd modified product: KR-206, an urethane modified product: KR-305 (all the above manufactured by Shin-Etsu Chemical Co., Ltd.), an epoxy modified product: SR2115, an alkyd modified product: SR2110 (manufactured by Toray Dow Corning Silicone Inc.), and the like.

The silicone resins which can be used in the present invention may contain an appropriate amount (0.001% by mass to 20% by mass) of an amino silane coupling agent and such examples thereof include:
H₂N(CH₂)₃Si(OCH₃)₃
a mass average molecular mass (Mw)=179.3
   H₂N(CH₂)₃Si(OC₂H₅)₃
a mass average molecular mass (Mw)=221.4
   H₂NCH₂CH₂CH₂Si(CH₃)₂—OC₂H₅
a mass average molecular mass (Mw)=161.3
   H₂NCH₂CH₂CH₂Si(CH₃)(OC₂H₅)₂
a mass average molecular mass (Mw)=191.3
   H₂NCH₂CH₂NHCH₂Si(OCH₃)₃
a mass average molecular mass (Mw)=194.3
   H₂NCH₂CH₂NHCH₂CH₂CH₂Si(CH₃)(OCH₃)₂
a mass average molecular mass (Mw)=206.4
   H₂NCH₂CH₂NHCH₂CH₂CH₂Si(OCH₃)₃
a mass average molecular mass (Mw)=224.4
   (CH₃)₂NCH₂CH₂CH₂Si(CH₃)(OC₂H₅)₂
a mass average molecular mass (Mw)=219.4
   (C₄H₉)₂NC₃H₆Si(OCH₃)₃
a mass average molecular mass (Mw)=291.6

Further, the resins coating on the surface of the carrier core particles are exemplified, and can be used alone or in combination with the silicone resin, styrene resins such as polystyrene, chloropolystyrene, poly-alpha-methylstyrene, styrene-chlorostylene copolymer, styrene propylene copolymer, styrene butadiene copolymer, styrene vinyl chloride copolymer, styrene vinyl acetate copolymer, styrene maleic acid copolymer, styrene-acrylic acid ester copolymer such as, styrene-methyl acrylate copolymer, styrene-ethyl acrylate copolymer, styrene-butyl acrylate copolymer, styrene-octyl acrylate copolymer, styrene-phenyl acrylate copolymer, and the like, styrene-methacrylate copolymer such as styrene-methyl methacrylate copolymer, styrene-ethyl methacrylate copolymer, styrene-butyl methacrylate copolymer, styrene-phenyl methacrylate copolymer, and the like, styrene-alpha-chloromethyl acrylate copolymer, styrene-acrylonitrile-acrylic ester copolymer, and the like, epoxy resin, polyester resin, polyethylene resin, polypropylene resin, ionomer resin, polyurethane resin, ketone resin, ethylene-ethyl acrylate copolymer, xylene resin, polyamid resin, phenol resin, polycarbonate resin, melamine resin, and the like.

Processes for forming coating layer on the surface of the carrier core particles can be used known processes such as a spray dry process, a dipping process, or a powder coating, and the like. Particularly, a process using a coating device of a fluidized bed type is effective in forming a uniform coating layer.

A thickness of the coating layer of the surface of the carrier core particles is preferably 0.02 μm to 1 μm and is more preferably 0.03 μm to 0.8 μm. Since the thickness of the coating layer is extremely small, a particle distribution between the carrier consisting of the core particles in which the coating layer is coated and the carrier core particles is substantially the same.

The carrier may be a resin dispersing carrier having a form in which a magnetic powder is dispersed in conventional resins such as phenol resin, acrylic resin and polyester resin, and the like.

In the carrier, the resistivity (Log R) (R: carrier resistance) is preferably 15.0 Ωcm or less and is more preferably 14.0 Ωcm or less. The lower limit is not limited but is usually approximately 10.0 Ωcm. When the resistivity becomes higher than the above range, the carrier adhesion easily occurs but when the carrier resistivity is maintained within the above range, the carrier adhesion not easily occurs and the developing ability increases so that the sufficient image density is obtained.

Here, the carrier resistivity can be measured by the following processes. As shown in FIG. 6, cell 11 is consisted of a fluorine resin container containing electrodes 12a, 12b with the distance therebetween 2 mm and its surface area of 2 cm×4 cm, is filled with carrier 13. A direct current of 100V is applied between the electrodes and a direct current resistivity was measured by High Resistance Meter 4329A (manufactured by Yokokawa Hewlett Packard K.K.) to calculate an electric resistivity, LogR(Ωcm).

The resistivity of the carrier is adjusted by the resistivity of the coating layer on the core particles and also by controlling the thickness thereof. Further, to adjust the carrier resistivity, the conductive fine powders can be added on the coating layer. The conductive fine powders include metals or metallic oxide particle such as conductive ZnO, Al, etc., SnO₂ prepared by various processes or SnO₂ on which various elements were doped, boride such as TiB₂, ZnB₂, MoB₂, conductive polymer such as silicon carbide, polyacetylene, polyparaphenylene, poly(para-phenylenesulfod) polypyrrole, polyethylene, carbon black such as farness black, acetylene black, channel black, and the like. These conductive fine powders are dispersed using the following processes, i.e., the conductive fine powders are poured into a solvent used for the coating or a coating resin solution and uniformly dispersed by means of a dispersing media such as a ball mill, a beads mill or a stirrer having blades for high-speed rotation.

The developer used in the present invention includes the toner and the carrier.

A ratio of the toner to the carrier is preferably 2 parts by mass to 25 parts by mass of the toner and is more preferably 4 parts by mass to 15 parts by mass, based on 100 parts by mass of the carrier.

In the developer constituted by the carrier and the toner, a coating rate of the toner to the carrier is preferably 0.1% to 0.8% and is more preferably 0.2% to 0.6%. When the coating rate of the toner to the carrier is 50%, the charging amount of the toner is preferably 50 μc/g or less and is more preferably 35 μc/g or less. The lower limit is not limited but usually it is approximately 15 μc/g.

Here, the coating rate is calculated by the following equation.
Coating rate(%)=(Wt/Wc)×(ρc/ρt)×(Dc/Dt)×(¼)×100

In the equation, Dc indicates a mass average particle diameter of the carrier (μm), Dt indicates a mass average particle diameter of the toner (μm), Wt indicates the toner mass (g), Wc indicates the carrier mass (g), ρt indicates a true density of the toner(g/cm³), ρc indicates a true density of the carrier (g/cm³). An absolute specific gravity of the toner is 1.25 g/cm³ (the carbon amount is 8.8% by mass).

The developing process according to the present invention is a process that uses the developer of the present invention. In this case, as a developing bias, an alternating voltage superposed is applied externally to the direct voltage, a sufficient image density can be obtained. Particularly, variations of dots reproducibility are small and reproducibility of the highlight is good. Further, when the toner having a small particle diameter is used, by using the carrier having a small diameter having a specific diameter distribution, high image quality can be obtained with excellent dots reproducibility, but without the background smear and without the carrier adhesion.

The developing unit is usually used a dry type developing system. Further, it may be a single color developing device or a multi-color developing device. For example, a developing unit equipped with a stirrer in which the toner and the developer are frictionally stirred to charge, and a rotatable magnet roller, and the like is preferable.

In the developing device, the toner and the carrier may, for example, be mixed and stirred together. The toner is thereby charged by friction, and forms a magnetic brush on the surface of the rotating magnet roller. Since the magnet roller is arranged near the photoconductor, a part of the toner which constituting the magnetic brush formed on the surface of the magnet roller moves toward the surface of the photoconductor due to the force of electrical attraction. As a result, the latent electrostatic image is developed by use of the toner, and a visible toner image is formed on the surface of the photoconductor.

The developer in the developing unit is a developer including the toner and may be a one-component developer or a two-component developer. A generally used toner can be used as the toner.

Transferring Step and Transferring Unit

The transferring step is one that transfers the visible image to a recording medium. In a preferable aspect, the first transferring is performed, wherein using an intermediate image-transfer member, the visible image is transferred to the intermediate image-transfer member, and the second transferring is then performed wherein the visible image is transferred to the recording medium. In a more preferable aspect, using toner of two or more colors and preferably full color toner, the primary transferring step transfers the visible image to the intermediate image-transfer member to form a compounded transfer image, and the second transferring step transfers the compounded transfer image onto the recording medium.

The transferring can be carried out, for example, by charging the photoconductor using a transferring charger, which can be performed by the transferring unit. In a preferable aspect, the transferring unit comprises a first transferring unit which transfers the visible image onto the intermediate image-transfer member to form a compound transfer image, and a second transferring unit which transfers the compounded transfer image onto the recording medium.

The intermediate image-transfer member may be properly selected from transfer substances or devices known in the art such as transfer belts.

The transferring unit of the first transferring unit and the second transferring unit preferably comprise a transferring device which charges by releasing the visible image formed on the photoconductor to the recording-medium side. There may be one, two or more of the transferring unit.

The transferring device may be a corona transferring device based on corona discharge, a transferring belt, a transferring roller, a pressure transferring roller, or an adhesion transferring device.

The recording medium may be properly selected from recording media or recording papers known in the art. The recording medium is typically plain paper, and also other substances such as PET sheets for OHP may be utilized.

Fixing Step and Fixing Unit

The fixing step is one that fixes the visible image transferred to the recording medium using a fixing unit. The fixing step may be carried out using developer of each color transferred to the recording medium, or in one operation when the developers of each color have been laminated.

The fixing unit are not particularly limited but may be properly selected from heat and pressure units known in the art. Examples of heat and pressure unit include a combination of a heat roller and pressure roller, and a combination of a heat roller, pressure roller, and endless belt.

The heating temperature in the heat-pressure unit is preferably 80° C. to 200° C. Further, an optical fixing unit known in the art may be used in addition to or instead of the fixing step and fixing unit, depending on the application.

Cleaning step and the Cleaning Unit

The cleaning step is one that removes electrophotographic toner remaining on the photoconductor, and may be performed by a cleaning unit.

The cleaning unit may be properly selected from cleaning units known in the art as long as capable of removing electrophotographic toner remaining on the photoconductor, and a cleaning blade, a magnetic brush cleaner, an electrostatic brush cleaner, a magnetic roller cleaner, a blade cleaner, a brush cleaner, and a web cleaner, and the like are exemplified.

The blade cleaning materials used for the blade cleaning system include such as urethane rubber, silicone rubber, fluoro rubber, chloropyrene rubber, butadiene rubber, and the like. Among them, the urethane rubber is particularly preferable.

A cleaning mechanism used in the present invention will be explained. In the present invention, known cleaning conditions and blade materials may be used. In such case, it is preferable to use it to counter-contact against the rotational direction of the photoconductor. FIG. 2 shows schematically a sectional view of the cleaning mechanism according to the present invention.

A contact load P is a normal vector of a pressure contact when the cleaning blade 202 is contacted to the photoconductor 201. Further, a contact angel θ is an angle of a contact line in the contacting point of the photoconductor 201 and the cleaning blade 202 before modified. A free length of the cleaning blade (L) is a length from an end portion of the support member 203 to the tip of the blade before modified.

In the present invention, preferable contact load P to the cleaning blade of the photoconductor and the contact angel θ are P=5 g/cm to 50 g/cm, and θ=5° to 35°. The free length L=3 mm to 15 mm is preferable. The thickness is preferably 0.5 mm to 10 mm.

The blade cleaning materials used for the blade cleaning system include such as urethane rubber, silicone rubber, fluoro rubber, chloropyrene rubber, butadiene rubber, and the like. Among them, the urethane rubber is particularly preferable.

It has been known that the blade reversal can be suppressed by controlling both a hardness and impact resilience of the rubber blade. When the JISA hardness of the blade at 25±5° C. is smaller than 65, the blade reversal occurs easily. When larger than 80, the cleaning ability decreases. Further, when the impact resilience exceed 75%, the blade reversal occurs easily and when 20% or less, the cleaning ability may be lowered.

The JISA hardness and the impact hardness both can be measured based on a vulcanized gum physical test method of JISK6301.

The charge-eliminating step is one that applies a discharge bias to the photoconductor to discharge it, which may be performed by a charge eliminating unit.

The charge eliminating unit may be properly selected from charge eliminating units known as long as capable of applying a discharge bias to the photoconductor such as discharge lamps.

The recycling step is one that recycles the electrophotographic toner removed in the cleaning step into the developing step, and may be performed by use of the recycling unit. The recycling unit may be properly selected from transport units known in the art.

The controlling step is one that controls the respective steps, and may be carried out by use of the controlling unit.

The controlling unit may be properly selected depending on the application as long as capable of controlling the entire units; the controlling unit may be equipped with devices such as sequencers and computers.

The electrophotographic image forming process according to the present invention can be applied to electrophotographic devices such as copiers, laser printers, LED printers, and liquid crystal shutter printers, and further can be generally applied to devices such as a display or a recording, near prints, engravings, and facsimiles, and the like.

Next, detailed explanations to the image forming apparatuses and image forming processes of the present invention will be made with accompanied drawings.

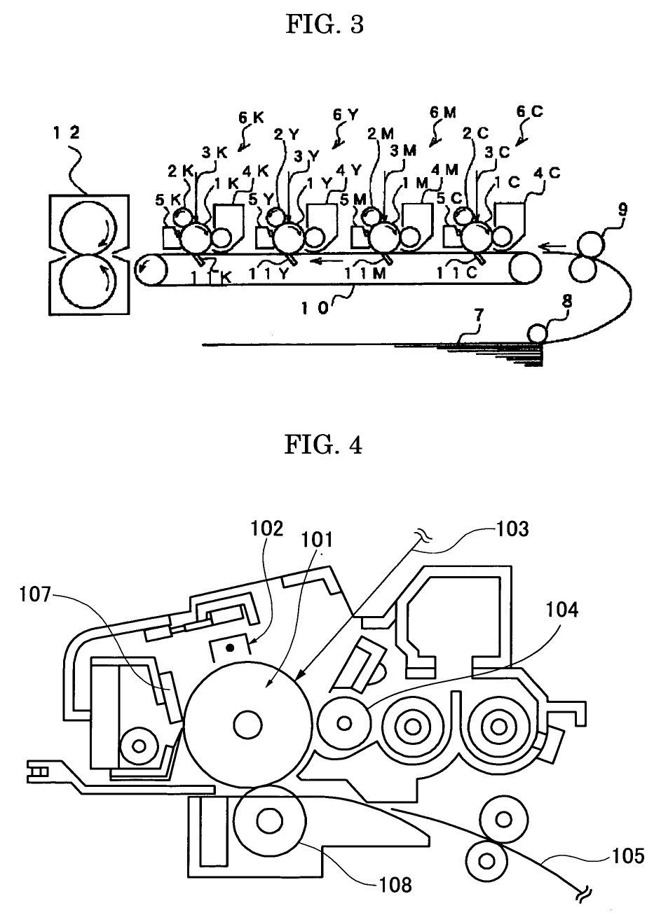

FIG. 3 shows a schematic view explaining a full-color image forming apparatus in tandem system in the image forming process according to the present invention and the following modification also belongs to the present invention.

In FIG. 3, reference numerals 1C, 1M, 1Y, 1K show drums of the photoconductor, in which the photoconductors 1C, 1M, 1Y, 1K rotate in a direction marked by an arrow in the figure and at least charging materials 2C, 2M, 2Y, 2K, developing members 4C, 4M, 4Y, 4K and cleaning members 5C, 5M, 5Y, 5K are disposed in a rotation order in the periphery thereof. The charging members 2C, 2M, 2Y, 2K are charging members consisting of a charging device for charging the surface of the photoconductor uniformly. The surface of the photoconductor between the charging members 2C, 2M, 2Y, 2K and the developing members 4C, 4M, 4Y, 4K are irradiated by laser lights 3C, 3M, 3Y, 3K to form a latent electrostatic image on the photoconductors 1C, 1M, 1Y, 1K. And, image forming elements 6C, 6M, 6Y, 6K centering the photoconductors 1C, 1M, 1Y, 1K are arranged along a transferring conveyer belt 10 which is a transferring conveyer unit. The transferring conveyer belt 10 is contacted to the photoconductors 1C, 1M, 1Y, 1K between the developing members 4C, 4M, 4Y, 4K of each image forming element 6C, 6M, 6Y, 6K and the cleaning members 5C, 5M, 5Y, 5K. The back surface of the photoconductor of the transfer conveyer belt 10 is arranged transferring brushes 11C, 11M, 11Y, 11K for applying a transferring bias. Each image forming element 6C, 6M, 6Y, 6K is different in a color of a toner in the developing device and other configurations are all the same.

In a color image forming apparatus shown in FIG. 3, the image forming operations are conducted as follows. First, in each image forming element 6C, 6M, 6Y, 6K, the photoconductors 1C, 1M, 1Y, 1K are charged by the charging members 2C, 2M, 2Y, 2K rotating to a direction marked by an arrow (an accompanying direction with the photoconductor) and then a corresponding latent electrostatic image is formed in response to each color image prepared by laser lights 3C, 3M, 3Y, 3K in the exposing unit. The developing members 4C, 4M, 4Y, 4K are respectively toners of C(cyanogen), M(magenta), Y(yellow), and K(black) to develop and each color toner image produced on the four photoconductors 1C, 1M, 1Y, 1K are superimposed on a transfer sheet 7.

The transfer sheet 7 is discharged from a tray by a paper roller 8 and stopped at moment by a pair of resist roller 9 and then forward to the transfer conveyer belt 10 in timing with the image forming on the photoconductor. The transfer sheet 7 held on the transfer conveyer belt 10 is conveyed and the each toner image is transferred at the contact position (transfer unit) with each photoconductor 1C, 1M, 1Y, 1K. Each toner image on the photoconductors is transferred on the transfer sheet 7 by charging a voltage difference between the transfer bias applied on the transfer brushes 11C, 11M, 11Y, 11K and the photoconductors 1C, 1M, 1Y, 1K. And, a recording sheet 7 overlaid the toner images of four colors passed through the four transfer units are conveyed to the fixing unit 12 to fix the toner, thereby to discharge to a discharge unit not shown. A residual toner left in each photoconductor 1C, 1M, 1Y, 1K which was not transferred in the transfer unit is collected by the cleaning units 5C, 5M, 5Y, 5K. In FIG. 3, the image forming elements are arranged from an upstream direction of the transfer sheet conveying direction toward a downstream in this color order such as C(cyanogen), M(magenta), Y(yellow), and K(black) but it is not limited in this order. A color order may appropriately set.

(Process Cartridge)

The process cartridge according to the present invention comprises a photoconductor, and at least one of charging unit, a developing unit, a transferring unit, a cleaning unit, and charge eliminating unit, and is detachably mounted to a main body of the image forming apparatus.

In this case, the photoconductor comprises a support, and a charge generating layer, a charge transporting layer and a crosslinked charge transporting layer disposed on the support in this order, in which the crosslinked charge transporting layer comprising a cured product formed from a radical polymerizable compound having three or more functionalities and no charge transport structure and a radical polymerizable compound having one functionality and one charge transport structure, and the developer used in the process cartridge includes a toner and a carrier, the carrier has core particles and a coating layer to coat the core particles. The content of the core particles having a particle diameter of smaller than 44 μm in the carrier is 70% by mass or more and the content of the core particles having a particle diameter of smaller than 22 μm is 7% by mass or less. A mass average particle diameter (Dw) is 25 μm to 45 μm, and a ratio (Dw/Dp) of Dw to a number average particle diameter (Dp) of the carrier is 1 to 1.30.

The process cartridge, for example as shown in FIG. 4, builds in the photoconductor 101, includes a charging unit 102, a developing unit 104, a cleaning unit 107 and further includes other members upon necessity. In FIG. 1, 103 denotes an exposing unit and a light source which can write with high resolution is used. 105 denotes a recording medium and 108 denotes a conveyer roller.

As to the photoconductor 101, a same apparatus as those of the image forming apparatuses mentioned below can be used. As to the charge unit 102, appropriate charge members are used.

With respect to the image forming process by using the process cartridge shown in FIG. 4, a latent electrostatic image is formed on the photoconductor 101 by charging by means of charge unit 102 and exposing by means of exposing unit 103 while rotating in the direction marked by the arrow. The latent electrostatic image is developed by means of developing unit 104 using a toner, the developed image is transferred by means of transferring unit 106 on recording medium 105, and printed. Then, the surface of the photoconductor after image transferred is cleaned by cleaning unit 107 and also is charge-eliminated by means of charge eliminating unit (not shown). These procedures are repeated.

The image forming apparatuses according to the present invention, the latent electrostatic image bearing member, and the developing unit, and the cleaning unit may be configured integrally as a process cartridges and these units may detachably configured to the body of the apparatus. Further, at least one unit selected from the group consisting of charging unit, developing unit, transferring or separating unit, and cleaning unit may be integrally supported to the photoconductor to form the process cartridge and may also be configured as one unit which mounted detachably to the apparatus body by means of a guide unit such as a rail of the apparatus body.

The present invention will be illustrated in more detailed with reference to examples given below, but these are not to be construed as limiting the present invention. All percentages and parts are by mass unless indicated otherwise.

(Production Example 1 of Photoconductor)

Production of Electrophotographic Conductor I-1

On an aluminum cylinder of 30 mm in diameter, the coating liquid for undercoat layer, the coating liquid for charge generating layer, and the coating liquid for charge transporting layer, each having the composition described below, were sequentially applied and dried to form an undercoat layer of 3.5 μm thick, a charge generating layer of 0.2 μm thick, and a charge transporting layer of 20 μm thick.

Then, the coating liquid for the uppermost surface layer having the following composition was coated over the obtained charge transporting layer by spray coating, and the coating was subjected to optical irradiation using a metal halide lamp of 160 W/cm under the conditions of 120 mm from the light source, 200 mW/cm² of irradiation energy, and 60 seconds of irradiating period, and then was dried at 130° C. for 30 minutes to obtain a surface crosslink layer of 1 μm thick, thereby the electrophotographic photoconductor I-1 was produced.

| | |
|---|---|
| Coating Liquid for Undercoat Layer | |
| Alkyd resin | 6 parts |
| (Beckosol 1307-60-EL, by Dainippon Ink and Chemicals, | |
| Inc.) | |
| Melamine resin | 4 parts |
| (Super Bekamine G-821-60, by Dainippon Ink and Chemicals, | |
| Inc.) | |
| Titanium oxide | 40 parts |
| Methylethylketone | 50 parts |

<Composition of Coating Liquid for Charge Generating Layer>

| | |
|---|---|
| Bisazo pigment of the following Structural Formula (a) | 2.5 parts |
| Polyvinylbutyral (XYHL, by Union Carbide Co.) | 0.5 part |
| Cyclohexanone | 200 parts |
| Methylethylketone | 80 parts |

| | |
|---|---|
| | Structural Formula (a) |
| 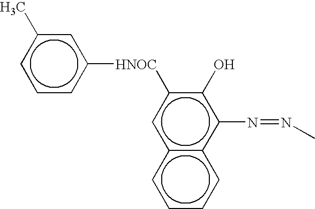 | |
| 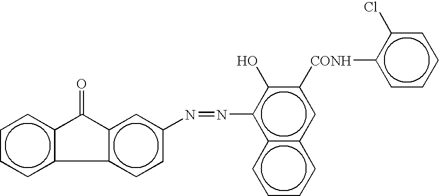 | |

<Composition of Coating Liquid for Charge Transporting Layer>

| | |
|---|---|
| Bisphenol Z polycarbonate | 10 parts |
| (Panlite TS-2050, by Teijin Chemicals Ltd.) | |
| Charge transport substance having a lower molecular mass of | 7 parts |
| the following Structural Formula (h) | |
| Tetrahydrofuran | 100 parts |
| 1% by mass solution of silicone oil in tetrahydrofuran | |
| (KF50-100CS, by Shin-Etsu Chemical Co.) | 0.2 part |
| Anti-oxidant (distearyl-3,3′-thiodipropionate) | 0.02 part |

| | |
|---|---|
| | Structural Formula (h) |
| 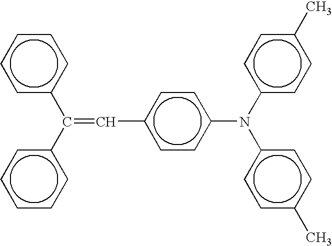 | |

| | |
|---|---|
| <Coating Liquid for Crosslinked Charge Transporting Layer> | |
| Radical polymerizable monomer having three or more | 10 parts |
| functionalities and no charge transport structure | |
| Trimethylolpropane triacrylate (KAYARAD TMPTA, by | |
| Nippon Kayaku Co.), molecular mass:296, number of | |
| functional group:three, molecular mass/number of functional | |
| group = 99 | |
| Radical polymerizable compound having one functionality and | 10 parts |
| a charge transport structure (exemplified compound No. 54) | |
| Photopolymerization initiator | 1 part |
| 1-hydroxy-cyclohexyl-phenyl-ketone | |
| (IRGACURE 184, by Ciba Specialty Chemicals, Inc.) | |
| Tetrahydrofuran | 100 parts |

(Production Examples of Photoconductors I-2 to I-10)

Photoconductors I-2, I-3, I-5, I-8 and I-10 were produced in the same manner as in the Production Example 1 of the photoconductor, except a thickness of the crosslinked charge transporting layer was changed as shown in Table 4, and the total thickness was changed to 21 μm.

(Production Example 2 of Photoconductor)

A photoconductor II-2 having a crosslinked charge transporting layer of 2 μm thick was produced in the same manner as in Production Example 1 of the Photoconductor, except the following coating liquid for crosslinked charge transporting layer was used.

<Composition of the Coating Liquid for the Crosslinked Charge Transporting Layer>

| | |
|---|---|
| Radical polymerizable monomer having three or more | 10 parts |
| functionalities and no charge transport structure | |
| Trimethylolpropane triacrylate (KAYARAD TMPTA, | |
| by Nippon Kayaku Co.), molecular mass: 296, | |
| number of functional group: three, molecular | |
| mass/number of functional group = 99 | |
| Radical polymerizable compound having one functionality | 10 parts |
| and a charge transport structure | |
| (exemplified compound No. 127) | |
| Photopolymerization initiator | 1 part |
| 1-hydroxy-cyclohexyl-phenyl-ketone | |
| (IRGACURE 184, by Ciba Specialty Chemicals, Inc.) | |
| Tetrahydrofuran | 100 parts |

(Production Example 3 of Photoconductor)

A photoconductor III-3 was produced in the same manner as in the Production Example 1 of the Photoconductor, except provided a surface protective layer containing the following filler instead of the crosslinked charge transporting layer.

<Composition of the Coating Liquid for the Surface Protective Layer>

| | |
|---|---|
| Bisphenol Z polycarbonate | 10 parts |
| (Panlite TS-2050, by Teijin Chemicals Ltd.) | |
| Charge transport substance having a lower molecular mass | 7 parts |
| expressed by the above formula (h) | |
| Titanium oxide(CR97, by Ishihara Sangyo K.K.) | 7 parts |
| Tetrahydrofuran | 100 parts |
| 1% by mass solution of silicone oil in tetrahydrofuran | 0.2 part |
| (KF50-100CS, by Shin-Etsu Chemical Co.) | |
| Anti-oxidant (distearyl-3,3′-thiodipropionate) | 0.02 part |

(Production Example 4 of Photoconductor)

A photoconductor IV-2 having a charge transporting polymer in a surface layer of 2.0 μm thick was produced in the same manner as in Production Example 1 of the Photoconductor, except the following surface coating liquid was used.

<Composition of the Coating Liquid for the Surface Layer>

| | |
|---|---|
| Charge Transport Polymer expressed by the Structural | 15 parts |
| Following formula | |
| 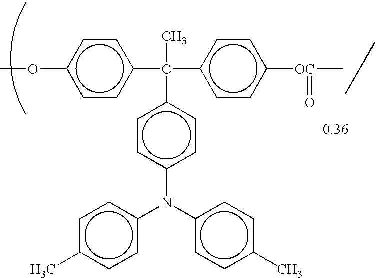 | |
| 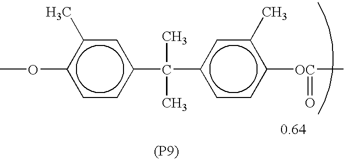 | |
| Tetrahydrofuran | 100 parts |
| 1% by mass solution of silicone oil in tetrahydrofuran | 0.3 part |
| (KF50-100CS, by Shin-Etsu Chemical Co.) | |

(Production Example 5 of Photoconductor)

A photoconductor was produced in the same manner as in Production Example 1 in which an under layer, a charge generating layercoat and the charge transferring layer were formed on the aluminum cylinder.

Then, a coating liquid for the protective layer consisting of 45 parts of a charge transporting material expressed by the following Structural Formula (f), 5 parts of a charge transporting material expressed by the following Structural Formula (g), 0.4 part of a thermal polymerization initiator expressed by the following Structural Formula (e), 30 parts of chloromethane and 70 parts of toluene was coated on the charge transporting layer, and was subjected to a thermal polymerization at 140° C. for 2 hours to form the protective layer of 2.0 μm thick. Thereby, produced the photoconductor V-2. 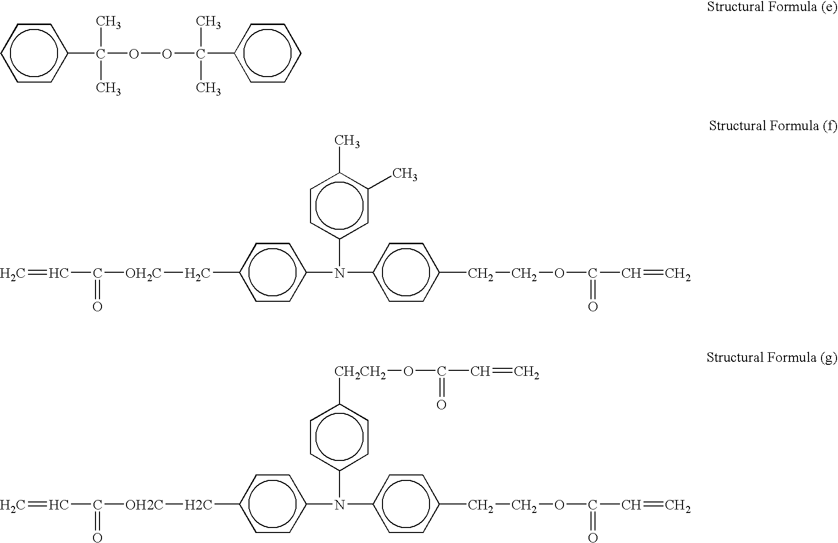
(Production Example 6 of the Photoconductor)

In the same manner as in Production Example 1, a photoconductor VI-2 was produced on the support on which the following undercoat layer, a charge generating layer, a charge transporting layer and a resin layer were provided.

<Preparation of the Undercoat Layer>

The following components were mixed and dissolved to prepare a coating liquid for an intermediate layer.

| | |
|---|---|
| Titaniumchelate compound (TC-750, | 30 parts |
| by Matsumoto Seiyaku K.K.) | |
| Silane coupling agent | 17 parts |
| 2-propanole | 150 parts |

Next, the coating liquid was coated on the support by an immersion coating process and dried at 120° C. for 1 hour to form the undercoat layer of 1.0 μm thick.

<Preparation of the Charge Generating Layer>

The following components were mixed and dispersed by a sand mill for 10 hours to prepare the coating liquid for the charge generating layer.

| | |
|---|---|
| Titanylphthalocyanine Y | 60 parts |
| Silicone resin solution (KR5240, | 700 parts |
| by Shinetsu Chemical Industry, | |
| Inc., 15% by mass of xylene-butanol liquid) | |
| 2-butanone | 2,000 parts |

The coating liquid was coated on the undercoat layer by the immersion coating process to form the charge generating layer of 0.2 μm thick.

<Charge Transporting Layer>

The following components were mixed to prepare a coating liquid for a charge transporting layer.

| | |
|---|---|
| 4-metoxy-4′-(4-methyl-alha-phenylstyryl)triphenylamine | 200 parts |
| Bisphenol Z polycarbonate | 300 parts |
| (YupilonZ300, by Mitsubishi Gas Chemical Inc.) | |
| 1,2-dichloroethane | 2,000 parts |

The coating liquid was coated on the charge generating layer by an immersion coating process to form a charge transporting layer of 20 μm thick after dried.

<Preparation of Surface Protective Layer>

The following components were stirred at 60° C. for 2 hours and further stirred after added 370 parts of 1-butanole for 48 hours.

| | |
|---|---|
| Trimethoxymethylsilane | 180 parts |
| 1-butanole | 280 parts |
| 1% by mass of acetic acid aqueous solution | 106 parts |

To the above solution, 67.5 parts of dihydroxymethyltriphenylamine (a compound having two functionalities and a charge transporting structure), 1.7 parts of anti-oxidant (Sanole LS2626, by Sankyo K.K.) and 4.5 parts of dibutyltinacetate were added to mix. The coating liquid was coated to thermal polymerization at 120° C. for 1 hour to provide a resin layer of 1 μm thick on the photoconductor VI-2.

(Production Example 1 of Toner)

| | |
|---|---|
| Polyester resin | 60 parts |
| Styrene acrylic copolymer resin | 25 parts |
| Carnauba wax | 5 parts |
| Carbon black (#44, by Mitsubishi Chemical Co.) | 9 parts |
| Chrome contained azo | 3 parts |
| compound(T-77, by Hodogaya Chemical Inc.) | |

After each of above components were mixed completely by a blender, melted and kneaded by a double screw extruder and roughly pulverized by a cutter mill after cooling. Next, this was pulverized to fine particles by a jet stream grinder and was classified by an air classifier to obtain a toner base particle having a mass average particle diameter of 8.3 μm, an average circularity of 0.97, a true specific gravity of 1.25 g/cm³.

Next, to the obtained 100 parts of toner base particle, 0.7 parts of hydrophobic silica fine particles (R972, by Nihon Aerogil Co.) was added and mixed by HENSCHEL MIXER to prepare the toner I.

(Production Example 2 of Toner)

A toner II was produced by the same manner as in Production Example 1 of the Toner, except that a toner base particle was obtained to have a mass average particle diameter of 4.8 μm, an average circularity of 0.97, and a true specific gravity of 1.25 g/cm³ by an air classifier.

(Production Example 1 of Carrier)

A silicone resin (SR2411, by Toray-Dow Corning Silicone Inc.) was diluted to obtain a silicone resin solution (solid content 5% by mass). By using a fluidized bed type coating device, the silicone resin solution under an atmosphere at 100° C. in a rate of 40 g/min was coated on the surface of particles of 5 kg of carrier core particles (Cu—Zn ferrite) (1) having properties shown in Table 3. Next, it was heated at 270° C. for two hours to obtain a carrier A of thickness 0.43 μm, and a true specific gravity of 5.0 g/cm³. A thickness of the coating layer was adjusted by an amount of the coating liquid.

(Production Example 2 of Carrier)

A carrier B with a thickness 0.43 μm, and a true specific gravity of 5.0 g/cm³ for comparison was produced in the same manner as in the production example 1 of carrier, except the carrier core particle (2) shown in Table 3 was used.

(Production Example 3 of Carrier)

A carrier C with a thickness 0.42 μm, and a true specific gravity of 5.0 g/cm³ for comparison was produced in the same manner as in the production example 1 of carrier, except the carrier core particle (3) shown in Table 3 was used.

(Production Example 4 of Carrier)

A carrier D with a thickness 0.43 μm, and a true specific gravity of 5.0 g/cm³ for comparison was produced in the same manner as in the production example 1 of carrier, except the carrier core particle (4) shown in Table 3 was used.

(Production Example 5 of Carrier)

A silicone resin (SR2411, by Toray-Dow Corning Silicone Inc.) was diluted to obtain a silicone resin solution having a solid content 5% by mass. By using a fluidized bed type coating device, the silicone resin solution under an atmosphere at 100° C. in a rate of 40 g/min was coated on the surface of particles of 5 kg of carrier core particles (Cu—Zn ferrite) (1) having properties shown in Table 3. Next, it was heated at 230° C. for two hours to obtain a carrier E with a thickness 0.41 μm, and a true specific gravity of 5.0 g/cm³. A thickness of the coating layer was adjusted by an amount of the coating liquid.

(Production Example 6 of Carrier)

In a silicone resin (SR2411, by Toray-Dow Corning Silicone Inc.), 7% by mass of carbon black (Ketchen black EC-DJ600 by Lion Akzo, Co., Ltd.) was dispersed by a ball mill for 60 minutes. The dispersion liquid was diluted to obtain a solid content of 5% by mass of the dispersion liquid. By using a fluidized bed type coating device, the dispersion liquid under an atmosphere at 100° C. in a rate of approximately 40 g/min. was coated on the surface of particles of 5 kg of carrier core particles (Cu—Zn ferrite) (1) having properties shown in Table 3. Next, this was heated at 350° C. for two hours to obtain a carrier F with a thickness 0.43 μm, and a true specific gravity of 5.1 g/cm³. A thickness of the coating layer was adjusted by an amount of the coating liquid.

(Production Example 7 of Carrier)

A carrier G with a thickness 0.44 μm, and a true specific gravity of 5.0 g/cm³ was produced in the same manner as in the Production Example 1 of carrier, except the carrier core particle (5) shown in Table 3 was used.

(Production Example 8 of Carrier)

In a silicone resin (SR2411, by Toray-Dow Corning Silicone Inc.), 7% by mass of carbon black (Ketchen black EC-DJ600 by Lion Akzo, Co. Ltd.) was dispersed by a ball mill for 60 minutes. The dispersion liquid was diluted to obtain a solid content of 5% by mass of the dispersion liquid, and further the silicone resin of an aminosilane coupling agent (NH₂(CH₂)₃ Si(OCH₃)₃) was added and mixed 3% by mass relative to the solid content to obtain the dispersing liquid. By using a fluidized bed type coating device, the dispersion liquid under an atmosphere at 100° C. in a rate of approximately 40 g/min. was coated on the surface of particles of 5 kg of carrier core particle (Cu—Zn ferrite) (1) shown in Table 3. Next, this was heated at 200° C. for two hours to obtain a carrier H with a thickness 0.44 μm, and a true specific gravity of 5.1 g/cm³. A thickness of the coating layer was adjusted by an amount of the coating liquid.

(Production Example 9 of Carrier)

A carrier I with a thickness 0.44 μm was produced in the same manner as in the Production Example 1 of carrier, except the carrier core particle (6) (Cu—Zn ferrite) shown in Table 3 was used.

(Production Example 10 of Carrier)

5 kg of the carrier core particles (4) shown in Table 3 was vibrated by a vibrating sieve device having an ultrasonic oscillation vibrator for five minutes to obtain a carrier core (7) having properties shown in Table 3. The vibration sieve device 51 has a structure shown in FIG. 5, wherein the sieve device comprising; a resonance ring 56 is attached directly and is contacted with a wire mesh 55(635 meshes) with the diameter of 70 cm supported by the flame 59, and the vibrator 58 for oscillating an ultrasonic wave of 36 kHz to the ring 56. The wire mesh 55 is arranged in the cylindrical container 52 supported by the base 54 through a spring 53. A vibrating motor (not shown) is provided in the base 54, thereby the high frequency current generated by the vibration is transmitted to the vibrator 58 mounted to the resonance ring 56 through the cable 57 and then the oscillation of the ultrasonic is made. The resonance ring 56 vibrates by the ultrasonic, thereby the vibration is generated in a vertical direction of the mesh surface 55 entirely.

After the carrier core particle (4) supplied on the wire mesh 55 in the cylindrical container 52 was sieved, it was collected to the lower portion of the cylindrical container 52 as a carrier core particle (7).

The mesh was not clogged at all. By using the vibrating sieve device having ultrasonic oscillation vibrator 51, it was possible that a ratio under 22 μm is maintained extremely small such as 6.3% by mass to 0.2% by mass. The yield was 92% by mass. A coat carrier J was produced using the carrier core by the same manner as in the Production Example 1 of Carrier.

(Production Example 11 of Carrier)

The carrier D for comparison obtained in the carrier core (4) in the production example 4 of carrier was processed to sieve by the sieve device 51 used in the production example 10 of carrier (cutting the fine particles) to obtain a carrier D′ having a particle diameter property shown in Table 3. The core (4) of the Carrier D contains 6.3% by mass of particles having a diameter of less than 22 μm but the content of carrier D′ was 0.4% by mass of particles having a diameter of less than 22 μm. The mesh was not clogged while the sieving process.

(Production Examples 12 and 13 of Carrier)

Carriers K and L having each thickness of 0.43 μm and 0.44 μm were produced in the same manner as in the production example 1 of carrier, except the carrier core particles (8) and (9) (Mn-ferrite) shown in Table 3 were substituted for the carrier core particle (1). The magnet moment when applied the magnetic field of 1 KOe of the core particle used in the carrier K and L was 76 emu/g and 85 emu/g, respectively.

TABLE 3

| | | | | | Particle | Particle | | | | | | |
|---|---|---|---|---|---|---|---|---|---|---|---|---|
| | | | Mass | Number | less | less | | Carrier | | Content of | | |
| Production | | | Average | Average | than | than | | Magnetic | | Aminosilane | | |
| Example | | | Particle | Particle | 44 μm | 22 μm | | Moment | Carrier | Coupling | Carbon | Film |
| of | | Core | Diameter | Diameter | (mass | (mass | | (emu/g- | Resistivity | Agent | Black | Thickness |
| Carrier | Carrier | material | (μm) | (μm) | %) | %) | Dv/Dp | 1kOe) | (LogR · Ωcm) | (mass %) | (mass %) | (μm) |
| 1 | A | (1) | 36.3 | 29.3 | 81.7 | 2.6 | 1.24 | 43 | 15.2 | 0 | 0 | 0.43 |
| 2* | B | (2) | 41.4 | 33.7 | 61.4 | 4.3 | 1.23 | 43 | 15.3 | 0 | 0 | 0.43 |
| 3* | C | (3) | 34.3 | 27.4 | 85.2 | 8.1 | 1.25 | 42 | 15.2 | 0 | 0 | 0.42 |
| 4* | D | (4) | 35.5 | 22.3 | 83.1 | 6.3 | 1.58 | 41 | 15.1 | 0 | 0 | 0.43 |
| 5 | E | (1) | 36.3 | 29.3 | 81.7 | 2.6 | 1.24 | 43 | 15.1 | 0 | 0 | 0.41 |
| 6 | F | (1) | 36.3 | 29.3 | 81.7 | 2.6 | 1.24 | 43 | 13.1 | 0 | 7 | 0.43 |
| 7 | G | (5) | 35.6 | 29.4 | 89.2 | 2 | 1.21 | 68 | 15.2 | 0 | 0 | 0.44 |
| 8 | H | (1) | 36.3 | 29.3 | 81.7 | 2.6 | 1.24 | 43 | 12.7 | 3 | 7 | 0.44 |
| 9 | I | (6) | 34.3 | 27.7 | 84 | 6.6 | 1.24 | 44 | 15.4 | 0 | 0 | 0.44 |
| 10 | J | (7) | 36.4 | 32.8 | 76.1 | 0.2 | 1.11 | 41 | 15.3 | 0 | 0 | 0.43 |
| 11 | D′ | (4) | 36.2 | 31.8 | 78 | 0.4 | 1.14 | 41 | 15.1 | 0 | 0 | 0.43 |
| 12 | K | (8) | 35.1 | 28.5 | 80.2 | 6.5 | 1.23 | 76 | 15.2 | 0 | 0 | 0.44 |
| 13 | L | (9) | 36.3 | 28.5 | 80.6 | 6.7 | 1.24 | 85 | 15.3 | 0 | 0 | 0.43 |

*Comparative Production Example

(Evaluation of the Photoconductor and the Developer)

As shown in Table 4, the photoconductors I to VI-2 obtained by the above photoconductor production examples were mounted to the image forming apparatuses. Various developers were produced by using the toners I and II obtained by the above production examples of toner and the carriers A to L obtained by the above production examples 1 to 13 of carrier. Images were formed using the obtained developer and property tests for confirming the image quality and reliability, etc. were performed. As an image forming apparatus, imagio MF250 (by Ricoh Company, Ltd., a digital copier and a printer combined machine) was used to test the following developing conditions.

[Developing Conditions]

Developing Gap (Photoconductor-Developing sleeve): 0.40 mm
Doctor Gap (Developing Sleeve-Doctor): 0.35 mm
Photoconductor Line Speed: 90 mm/sec.
(Developing Sleeve Line Velocity/Photoconductor Line Velocity)=2.5
Charge Potential (Vd): −700V
Potential (VL) after exposed in an area of an image portion (solid manuscript):−100V
Developing Bias: DC −450V
Quality evaluations were conducted on a transfer sheet.

Test methods employed in the examples of image forming are as follows.

<Image Density>

A center of a solid portion of 30 milimeters square formed in the above developing conditions was measured in five positions by Macbeth densitometer and an average value thereof was obtained. It was decided that the value 1.35 or more is acceptable in the present invention.

<Background Smear>

In the above developing conditions, the background smear of the background was evaluated by a rank from 1 to 10. The higher the rank is, the less background smear occurs. The rank 10 shows the least background smear. It is decided that the rank 8 or more is acceptable in the present invention.

<Average Dot Diameter and Variation Dispersion>

In the above developing conditions, a mesh image of 1 dot independent of 400 dpi (both a first scan and a slow scan) was prepared in a printer mode. 16 dots were measured at five positions to obtain an average diameter of a dot out of 80 dots in total and a variation of the average diameter of the dots (dispersion:σ). It was decided that σ≦0.15 is acceptable in the present invention.

<Bristle (Napping) Marks>

When the developing bias of 350V was applied, bristle marks in the black solid portion were evaluated by a rank from 1 to 10. The higher the rank is, the less the bristle mark exits and the rank 10 shows that the bristle mark is the least. It was decided that the rank 7 or more is acceptable in the present invention.

<Carrier Adhesion>

When the carrier is adhered, this will become causes of scratches of the photoconductor drums or the fixing rollers, thereby to lower the image quality. When the carrier is adhered, it is not transferred to the paper, thus it is difficult to evaluate. Therefore, the carrier adhesion was observed and evaluated directly on the photoconductor drum. Further, even the developing bias was the same, occurrences of the carrier adhesion differ depending on an image pattern. Therefore, the least occurrence of the carrier adhesion was evaluated by the following manner. Namely, provided that the whole image was the ground (i.e., it was non-image portion and the charge potential was −700 volt), the developing bias was changed from the standard of DC −450 V to obtain a voltage (Vc) where the carrier adhesion is occurring. The smaller the absolute value of the applied bias is, the less carrier adhesion of the carrier or the developer occurs.

<Background Smear After Running 100,000 Sheets>

A running test for a character image chart with 6% of image area ratio was conducted with 100,000 sheets while supplying the toner. The background smear of the background in the above developing conditions was evaluated by a rank from 1 to 10. The higher the rank is, the less background smear occurs and the rank 10 shows that the background smear is the least. It was decided that the rank 7 or more is acceptable in the present invention.

<Image Deletion>

Three characters with many strokes among the character image chart were selected to classify according to a degree of unclearness and to evaluate them in the following standards.

[Evaluation Standards]

A: legible equal to the initial image
B: three are legible
C: two are illegible
D: three are illegible

### EXAMPLE 1

As shown in Table 4, the toner, the carrier and the photoconductor were combined, the developer having the toner density of 10.0% was prepared by adding the toner I (11.0 parts) relative to the carrier A (100 parts) and stirred for 20 minutes by a ball mill. A coating rate of the toner relative to the carrier was 50% and the amount of the toner charge was −43 μc/g. Next, image quality was confirmed by the above measurement and evaluation method using an image forming apparatus of the above developing conditions (imagio MF250, by Ricoh Company, Ltd.), under normal temperature and normal humidity (25° C., 65% RH).

The dot of small diameter with less variation was formed in which the image density was 1.40, the background smear was the rank 8, and the dispersion was 0.12. Further, the carrier adhesion and the bristle mark were almost not occurred, and the obtained images were high quality.

Continuously, a running test for a character image chart with 6% of image area ratio was conducted with 100,000 sheets. After running 100,000 sheets, the background smear was confirmed. The background smear was rank 7 and in the image quality the high quality was maintained same as the initial image quality. Next, the image forming apparatus (imagio MF250, by Ricoh Company, Ltd.) was moved to an environment under high temperature and high humidity (30° C., 85% RH) and further 100,000 sheets were tested and left one day, then the image forming was conducted. As a result, it was confirmed that the image deletion was not found.

### COMPARATIVE EXAMPLE 1

As shown in Table 4, the toner, the carrier and the photoconductor were combined, the developer having the toner density of 10.0% was prepared by adding the toner I (11.0 parts) relative to the carrier A (100 parts) and stirred for 20 minutes by a ball mill. A coating rate of the toner relative to the carrier was 50% and the amount of the toner charge was −43 μc/g. Next, image quality was confirmed by the same manner as in Example 1 using the image forming apparatus (imagio MF250, by Ricoh Company, Ltd.). The carrier adhesion was not found but the dot variation was many and the bristle mark was occurred. Continuously, when 100,000 sheets running were tested, the background smear was increased and the toner was scattered at the periphery of dot.

### EXAMPLES 2 TO 12 AND COMPARATIVE EXAMPLES 2 TO 7

As shown in Table 4, the toner, the carrier and the photoconductor were combined to evaluate in the same manner as in Example 1, except that the developer with the coating rate of 50% was prepared. In Example 6, among the developing conditions of the image forming apparatus (imagio MF250, by Ricoh Company, Ltd.), a rectangular wave of 4 kHz was used instead of the developing bias of DC-450V and was adjusted a voltage shown by an integral average value of the AC voltage to −450V. The properties of the developer in the Examples and the Comparative Examples are shown in Table 4.

TABLE 4

| | | | | | | Carrier | | | | | |
|---|---|---|---|---|---|---|---|---|---|---|---|
| | | | | Toner | | | Toner | Evaluation Results of image quality | | | |
| | | | | | Toner | | Charge | Normal temperature and normal humidity | | | |
| | | | | | Mass | | Amount | Beginning to 100,000 | | | |
| | Photoconductor | | | | Average | | (μc/g, | | | Average | Variation |
| | Surface Layer | | | | Particle | | Coating | | Background | Dot | of Dot |
| | Compound | | Film | Toner | Diameter | Carrier | rate | Image | Smear | Diameter | Diameter |
| | No. | PhotoConductor | Thickness (μm) | Type | (μm) | Type | 50%) | Density | (rank) | (μm) | (dispersion) |
| Ex. 1 | 54 | I-1 | 1 | I | 8.5 | A | 43 | 1.4 | 8 | 48 | 0.12 |
| Comp. | 54 | I-2 | 2 | I | 8.5 | B | 43 | 1.36 | 7 | 54 | 0.19 |
| Ex. 1 | | | | | | | | | | | |
| Comp. | 54 | I-2 | 2 | I | 8.5 | C | 42 | 1.37 | 6 | 45 | 0.24 |
| Ex. 2 | | | | | | | | | | | |
| Comp. | 54 | I-2 | 2 | I | 8.5 | D | 43 | 1.38 | 7 | 44 | 0.21 |
| Ex. 3 | | | | | | | | | | | |
| Ex. 2 | 54 | I-2 | 2 | I | 8.5 | E | 32 | 1.41 | 8 | 52 | 0.1 |
| Ex. 3 | 54 | I-3 | 3 | I | 8.5 | F | 42 | 1.42 | 9 | 47 | 0.11 |
| Ex. 4 | 54 | I-5 | 5 | I | 8.5 | G | 43 | 1.38 | 9 | 51 | 0.13 |
| Ex. 5 | 54 | I-8 | 8 | I | 8.5 | H | 31 | 1.46 | 10 | 56 | 0.08 |
| Ex. 6 | 54 | I-10 | 10 | I | 8.5 | A | 43 | 1.45 | 8 | 58 | 0.12 |
| Ex. 7 | 54 | II-2 | 2 | II | 5.8 | A | 45 | 1.37 | 8 | 43 | 0.08 |
| Ex. 8 | 127 | II-2 | 2 | I | 8.5 | I | 41 | 1.37 | 8 | 46 | 0.18 |
| Ex. 9 | 127 | II-2 | 2 | I | 8.5 | J | 42 | 1.39 | 9 | 45 | 0.11 |
| Ex. 10 | 127 | II-2 | 2 | I | 8.5 | D′ | 43 | 1.38 | 9 | 45 | 0.13 |
| Ex. 11 | 127 | II-2 | 2 | I | 8.5 | K | 42 | 1.39 | 9 | 45 | 0.17 |
| Ex. 12 | 127 | II-2 | 2 | I | 8.5 | L | 42 | 1.4 | 9 | 46 | 0.18 |
| Comp. | CTM | III-3 | 4 | I | 8.5 | I | 41 | 1.37 | 8 | 46 | 0.18 |
| Ex. 4 | Filler | | | | | | | | | | |
| Comp. | Polymer | IV-2 | 2 | I | 8.5 | K | 42 | 1.39 | 9 | 45 | 0.17 |
| Ex. 5 | CTM | | | | | | | | | | |
| Comp. | 2 × 3 | V-2 | 2 | I | 8.5 | J | 42 | 1.39 | 9 | 45 | 0.11 |
| Ex. 6 | Functionalities | | | | | | | | | | |
| Comp. | Silicone | VI-2 | 1 | I | 8.5 | D′ | 43 | 1.38 | 9 | 45 | 0.13 |
| Ex. 7 | modified | | | | | | | | | | |

| | Evaluation Results of image quality | | | | | | |
|---|---|---|---|---|---|---|---|
| | Normal temperature and normal | | | High temperature and high humidity | | | |
| | humidity Beginning to 100,000 | | | 100,000 to 200,000 | | | |
| | | | Background | Deep | Background | | |
| | | | Smear | Scratch | Smear | Wear | Image |
| | | Carrier | after | on the | after | after | Deletion |
| | Bristle | Adhesion | 100,000 | Surface | 200,000 | 200,000 | after |
| | Marks | Occurrence | running | of the | running | running | 200,000 |
| | (rank) | Voltage (v) | (rank) | Photoconductor | (rank) | (μm) | running |
| Ex. 1 | 8 | 400 | 7 | Non | 7 | 0.41 | B |
| Comp. | 6 | 400 | 6 | Non | 5 | 0.42 | B |
| Ex. 1 | | | | | | | |
| Comp. | 7 | 550 | 6 | Non | 5 | 0.4 | B |
| Ex. 2 | | | | | | | |
| Comp. | 7 | 500 | 6 | Non | 5 | 0.42 | B |
| Ex. 3 | | | | | | | |
| Ex. 2 | 8 | 380 | 7 | Non | 7 | 0.43 | B |
| Ex. 3 | 8 | 380 | 7 | Non | 7 | 0.4 | A |
| Ex. 4 | 8 | 360 | 7 | Non | 7 | 0.46 | B |
| Ex. 5 | 9 | 360 | 8 | Non | 7 | 0.4 | A |
| Ex. 6 | 9 | 440 | 7 | Non | 7 | 0.38 | B |
| Ex. 7 | 9 | 400 | 7 | Non | 7 | 0.42 | B |
| Ex. 8 | 8 | 460 | 7 | Non | 7 | 0.41 | B |
| Ex. 9 | 8 | 360 | 8 | Non | 7 | 0.39 | B |
| Ex. 10 | 8 | 370 | 8 | Non | 8 | 0.45 | A |
| Ex. 11 | 8 | 400 | 8 | Non | 8 | 0.42 | A |
| Ex. 12 | 8 | 320 | 8 | Non | 8 | 0.41 | A |
| Comp. | 8 | 570 | 5 | Found in 6 | 4 | 3.63 | B |
| Ex. 4 | | | | | | | |
| Comp. | 8 | 400 | 8 | * | * | * | * |
| Ex. 5 | | | | | | | |
| Comp. | 8 | 360 | 8 | Non | 6 | 0.02 | D |
| Ex. 6 | | | | | | | |
| Comp. | 8 | 370 | 8 | Non | 5 | 0.01 | D |
| Ex. 7 | | | | | | | |

* stopped at 120,000 sheets due to occurrence of many abnormal images

From the results shown in Table 4, in the comparative example 4, when the preferable carrier having a small particle diameter according to the present invention was used, when the filler was contained in the surface protective layer, it was found that the voltage of the carrier adhesion became 570V and the carrier adhesion easily occurred. A deep scratch was observed in the surface of the photoconductor after running 100,000 sheets under the environment of the high temperature and high humidity. After observed by the microscope, it was judged that the scratch was produced by a manner that the carrier was adhered on the surface of the photoconductor and caught up by the cleaning blade, then the carrier was pushed onto the surface of the photoconductor by a suppressing strength.

Further, even when the preferable carrier having small particle diameter according to the present invention was used, in Comparative Example 5, the photoconductor in which the strength of the surface of the photoconductor was insufficient and wear occurred thereon due to the repetition of image forming for a long period of time was used. Thus, the conductive property of the photoconductor changed, resulting the stability of the toner developing was poor. While, in Comparative Examples 6 and 7, even the photoconductor in which the strength of the surface of the photoconductor was sufficient and wear was not occurred thereon was used, the conductive property did not change, but the image deletion occurred due to the wear was too low.

According to the image forming processes of the present invention, after the image forming was repeated for a long period of time, the present invention can provide the excellent images with high image density, less background smear, the reproducibility with dots of small diameter and less bristle marks, thereby the present invention can be applied to the image forming technologies for the copiers, the printers, the facsimiles, etc.

What is claimed is:

1. An image forming process comprising:
forming a latent electrostatic image on a photoconductor,
developing the latent electrostatic image by using a developer to form a visible image,
transferring the visible image on a recording medium, and
fixing the transferred image on the recording medium,
wherein the photoconductor comprises a support; a charge generating layer, a charge transporting layer and a crosslinked charge transporting layer disposed on the support in this order, and the crosslinked charge transporting layer comprises a cured product formed from at least a radical polymerizable compound having three or more functionalities and no charge transport structure, and a radical polymerizable compound having one functionality and a charge transport structure,
wherein the developer comprises a toner and a carrier, the carrier has core particles and a coating layer for coating the core particles, the content of the core particles having a particle diameter of smaller than 44 μm in the carrier is 70% by mass or more, and the content of the core particles having a particle diameter of smaller than 22 μm in the carrier is 7% by mass or less, a mass average particle diameter of the carrier (Dw) is 25 μm to 45 μm, and a ratio (Dw/Dp) of Dw to a number average particle diameter (Dp) of the carrier is 1 to 1.30.

2. The image forming process according to claim 1, wherein the content of the core particles having a particle diameter of smaller than 22 μm is 3% by mass or less.

3. The image forming process according to claim 1, wherein the core particles have a magnetic property.

4. The image forming process according to claim 1, wherein a thickness of the crosslinked charge transporting layer is 1 μm to 10 μm.

5. The image forming process according to claim 1, wherein a thickness of the charge transporting layer is 5 μm to 40 μm.

6. The image forming process according to claim 1, wherein the functional group of the radical polymerizable compound having three or more functionalities and no charge transporting structure and the radical polymerizable compound having one functionality and a charge transporting structure is at least one of acryloyloxy group and methacryloyloxy group.

7. The image forming process according to claim 1, wherein a carrier resistivity (LogR) is 14.0 Ω·cm or less.

8. The image forming process according to claim 1, wherein a magnetic moment of the core particles is 60 emu/g or more, when a magnetic field of 1,000 oersted is applied.

9. The image forming process according to claim 8, wherein a magnetic moment of the core particles is 75 emu/g or more, when a magnetic field of 1,000 oersted is applied.

10. The image forming process according to claim 1, wherein a thickness of the coating layer of the carrier is 0.02 μm to 1 μm.

11. The image forming process according to claim 1, wherein the charging amount of the toner is 35 μc/g or less, when the coating rate of the toner to the carrier is 50%.

12. The image forming process according to claim 1, wherein a mass average particle diameter of the toner is 4.0 μm to 9.0 μm.

13. The image forming process according to claim 1, wherein the toner is spherical.

14. An image forming apparatus comprising:
a photoconductor,
a latent electrostatic image forming unit configured to form a latent electrostatic image on the photoconductor,
a developing unit configured to develop the latent electrostatic image by using a developer to form a visible image,
a transferring unit configured to transfer the visible image on a recording medium, and
a fixing unit configured to fix the transferred image on the recording medium,
wherein the photoconductor comprises a support, and a charge generating layer, a charge transporting layer, and a crosslinked charge transporting layer disposed on the support in this order, the crosslinked charge transporting layer comprises a cured product formed from at least a radical polymerizable compound having three or more functionalities and no charge transport structure and a radical polymerizable compound having one functionality and a charge transport structure, and
wherein the developer comprises a toner and a carrier, the carrier has core particles and a coating layer for coating the core particles, the content of the core particles having a particle diameter of smaller than 44 μm in the carrier is 70% by mass or more, and the content of the core particles having a particle diameter of smaller than 22 μm in the carrier is 7% by mass or less, a mass average particle diameter of the carrier (Dw) is 25 μm to 45 μm, and a ratio (Dw/Dp) of Dw to a number average particle diameter (Dp) of the carrier is 1 to 1.30.

15. The image forming apparatus according to claim 14, wherein the developing unit uses an alternating voltage as a developing bias.

16. A process cartridge comprising:
a photoconductor, and at least one selected from the group consisting of a charging unit, an exposing unit, a developing unit, a transferring unit, and a cleaning unit are integrally configured and is mounted detachably to a body of an image forming apparatus,
wherein the photoconductor comprises a support, and a charge generating layer, a charge transporting layer, and a crosslinked charge transporting layer disposed on the support in this order, the crosslinked charge transporting layer comprises a cured product formed from at least a radical polymerizable compound having three or more functionalities and no charge transport structure and a radical polymerizable compound having one functionality and a charge transport structure, and
wherein the developer used in the process cartridge comprises a toner and a carrier, the carrier has core particles and a coating layer for coating the core particles, the content of the core particles having a particle diameter of smaller than 44 μm in the carrier is 70% by mass or more, and the content of the core particles having a particle diameter of smaller than 22 μm in the carrier is 7% by mass or less, a mass average particle diameter of the carrier (Dw) is 25 μm to 45 μm, and a ratio (Dw/Dp) of Dw to a number average particle diameter (Dp) of the carrier is 1 to 1.30.
